(19) United States
(12) Patent Application Publication
(10) Pub. No.: US 2013/0329068 A1
(43) Pub. Date: Dec. 12, 2013

(54) IMAGE PROCESSING APPARATUS AND IMAGE PROCESSING METHOD

(71) Applicant: Canon Kabushiki Kaisha, Tokyo (JP)

(72) Inventors: Akiyoshi Hamanaka, Hachioji-shi (JP); Junya Masaki, Kawasaki-shi (JP); Katsuhiko Nagasaki, Tokyo (JP); Masaaki Kobayashi, Kawasaki-shi (JP); Toshiyuki Fukui, Yokohama-shi (JP); Tohru Oyama, Kawasaki-shi (JP)

(21) Appl. No.: 13/908,101

(22) Filed: Jun. 3, 2013

(30) Foreign Application Priority Data
Jun. 8, 2012 (JP) 2012-130863
Jun. 8, 2012 (JP) 2012-130865
Jun. 8, 2012 (JP) 2012-130866
Jun. 8, 2012 (JP) 2012-130867
Jun. 8, 2012 (JP) 2012-130868
Apr. 1, 2013 (JP) 2013-076141

(51) Int. Cl. H04N 5/232

(52) U.S. Cl. CPC H04N 5/23293
USPC 348/218.1

(57) ABSTRACT

In the case of a conventional image apparatus that generates refocus image on the occasion of image display, there is a waiting time because the image apparatus generates the refocus image in response to an operation of a user and requires the time to generate the refocus image. To address this situation, an image apparatus determines ranks of targets to be in focus based on history information indicating operation history, and generates sequentially combined image data from multi-viewpoint image data obtained by capturing images from multiple viewpoints, by focusing on the targets in accordance with the determined ranks.

### BACKGROUND OF THE INVENTION

1. Field of the Invention

The present invention relates to an image processing apparatus and an image processing method for processing image data on the basis of information obtained from multiple viewpoints.

2. Description of the Related Art

Currently, a method of displaying and checking a captured image in a so-called reproduction mode is known as a method of checking the captured image in an image capturing apparatus after image capturing.

Moreover, an image capturing apparatus using a technique called “Light Field Photography” has been recently proposed (for example, R. Ng, M. Levoy, M. Brédif, G. Duval, M. Horowitz, P. Hanrahan: “Light Field Photography with a Hand-Held Plenoptic Camera”, Stanford Tech Report CTSR 2005-02 (2005), and Japanese Patent Laid-Open No. 2010-183316). The image capturing apparatus includes an image capturing lens, a microlens array, an image capturing element, and an image processing unit. Captured image data obtained from the image capturing element includes information on a traveling direction of light in addition to an intensity distribution of the light on a light receiving surface. Images observed from multiple viewpoints and directions can be reconstructed by the image processing unit.

The reconstruction involves, as one process, adjusting the focus after image capturing (hereafter, referred to as refocus) (for example, Japanese Patent Laid-Open No. 2011-22796), and an image capturing apparatus capable of performing refocus after image capturing (hereafter, referred to as light field camera) is developed.

In a refocus calculation process of reconstructing the images observed from multiple viewpoints and directions in the image processing unit, it is necessary to perform a positioning process for the images observed from multiple viewpoints and directions. The calculation amount (processing load) of this positioning process is large.

Moreover, the refocus calculation process requires calculation of focusing or calculation of blurring for each region. In the case of blurring process, in particular, uniform burring of regions other than the focus region is not sufficient, but visually-natural blurring (for example, generation of captured image data with a shallow depth of field) needs to be achieved. This process also requires a large calculation amount (processing load).

In a case of a conventional image apparatus that generates a refocus image on the occasion of image display, there is a waiting time because the image apparatus generates the refocus image in response to an operation of a user and requires the time to generate the refocus image.

### SUMMARY OF THE INVENTION

An image processing apparatus of the present invention includes: a determining unit configured to determine ranks of targets to be in focus on the basis of history information indicating operation history; and a generating unit configured to sequentially generate a plurality pieces of combined image data, from multi-viewpoint image data obtained by capturing images from multiple viewpoints, by focusing on targets in accordance with the ranks determined by the determining unit.

In the present invention, it is possible to predict the region for which the user desires refocus display, and to start or complete the refocus calculation before the user performs an operation of designating a region for refocus display. Accordingly, waiting time from the designation of refocus region by the user to display of a refocus image can be reduced.

Further features of the present invention will become apparent from the following description of exemplary embodiments (with reference to the attached drawings).

### BRIEF DESCRIPTION OF THE DRAWINGS

FIG. 1 is a block diagram showing an example of a hardware configuration of an entire camera array in Embodiment 1 of the present invention;

FIG. 2 is a flowchart showing an example of a refocus process performed in reproduction in Embodiment 1 of the present invention;

FIG. 3 is a flowchart showing an example of a parameter selection process in Embodiment 1 of the present invention;

FIG. 4 is a diagram showing the relationship of FIGS. 4A and 4B;

FIGS. 4A and 4B are a flowchart showing an example of a method of predicting a refocus calculation region in Embodiment 1 of the present invention;

FIGS. 5A and 5B are each a graph showing an example of past refocus history related to people in Embodiment 1 of the present invention;

FIGS. 6A and 6B are each a view showing an example of display of a refocus image in Embodiment 1 of the present invention;

FIG. 7 is a diagram showing an example of a temporary image file format for storing a piece of refocus image data in Embodiment 1 of the present invention;

FIG. 8 is a diagram showing an example of an image data format for storing multi-viewpoint image data in Embodiment 1 of the present invention;

FIG. 9 is a diagram showing the relationship of FIGS. 9A and 9B;

FIGS. 9A and 9B are a flowchart showing an example of a refocus process performed in reproduction in Embodiment 2 of the present invention;

FIG. 10 is a diagram showing the relationship of FIGS. 10A and 10B;

FIGS. 10A and 10B are a flowchart showing the example of the refocus process performed in reproduction in Embodiment 2 of the present invention;

FIG. 11 is a view showing an example of an exterior of an image capturing camera array unit in Embodiment 3 of the present invention;

FIGS. 12A and 12B are each a diagram showing an example of an image data format for storing multi-viewpoint image data in Embodiment 3 of the present invention;

FIG. 13 is a diagram showing an example of a functional configuration of a refocus calculation unit and an example of a flow of process in Embodiment 3 of the present invention;

FIG. 14 is a diagram showing the relationship of FIGS. 14A, 14B and 14C;

FIGS. 14A to 14C are a flowchart showing an example of the flow of the process in a case where a non-focus target is designated in Embodiment 3 of the present invention;

FIG. 15A is a view showing an example of a relationship among a position of an image capturing apparatus, positions of objects in a captured image, the depth of field, and the like at image capturing of a target to be subjected to image processing in Embodiment 3 of the present invention, and FIG. 15B is a view showing a display example of the captured image on a display;

FIG. 16A is a view showing an example of a relationship among the position of the image capturing apparatus, the positions of the objects in the captured image, the depth of field, and the like at image capturing of the target to be subjected to image processing in Embodiment 3 of the present invention, and FIG. 16B is a view showing a display example of the captured image on the display;

FIG. 17A is a view showing an example of a relationship among the position of the image capturing apparatus, the positions of the objects in the captured image, the depth of field, and the like at image capturing of the target to be subjected to image processing in Embodiment 3 of the present invention, and FIG. 17B is a view showing a display example of the captured image on the display;

FIG. 18 is a diagram showing an example of a data format of a focus and non-focus target list in Embodiment 4 of the present invention;

FIG. 19 is a diagram showing an example of an image data format for storing multi-viewpoint image data in Embodiment 4 of the present invention;

FIG. 20 is a view showing an example of a management structure of the focus and non-focus target list in Embodiment 4 of the present invention;

FIG. 21 is a diagram showing the relationship of FIGS. 21A and 21B;

FIGS. 21A and 21B are a flowchart showing an example of a process of adding and deleting target objects to and from the focus and non-focus target list in Embodiment 4 of the present invention;

FIG. 22 is a flowchart showing an example of a process of reflecting addition of the target object to the focus and non-focus target list to refocus position information of the multi-viewpoint image data in Embodiment 4 of the present invention;

FIG. 23 is a flowchart showing an example of a process of reflecting deletion of target object from the focus and non-focus target list to the refocus position information of the multi-viewpoint image data in Embodiment 4 of the present invention;

FIG. 24 is a flowchart showing an example of a process of attaching the refocus position information to the multi-viewpoint image data in a case where the multi-viewpoint image data is captured in Embodiment 4 of the present invention;

FIG. 25 is a diagram showing the relationship of FIGS. 25A and 25B;

FIGS. 25A and 25B are a flowchart showing an example of a process of reflecting information on target objects in the focus and non-focus target list to the refocus position information of the stored multi-viewpoint image data in Embodiment 4 of the present invention;

FIG. 26 is a diagram showing an example of a data format of a focus and non-focus target list in Embodiment 5 of the present invention;

FIGS. 27A to 27C are views each showing an example of a user interface (UI) for updating recognition information on a target object in the focus and non-focus target list and for deleting refocus position information generated based on the target object in Embodiment 5 of the present invention;

FIG. 28 is a view showing an example of a system configuration for performing focus and non-focus target list management, refocus position information generation, and refocus image generation in Embodiment 6 of the present invention;

FIG. 29A is a view showing an example of a relationship among a position of an image capturing apparatus, positions of objects in a captured image, the depth of field, and the like at image capturing of a target to be subjected to image processing in Embodiment 7 of the present invention, and FIG. 29B is a view showing a display example of the captured image on a display;

FIG. 30A is a view showing an example of a relationship among the position of the image capturing apparatus, the positions of the objects in the captured image, the depth of field, and the like at image capturing of the target to be subjected to image processing is captured in Embodiment 7 of the present invention, and FIG. 30B is a view showing an example of display of the captured image on the display in Embodiment 7 of the present invention;

FIG. 31A is a view showing an example of a relationship among the position of the image capturing apparatus, the positions of the objects in the captured image, the depth of field, and the like at image capturing of the target to be subjected to image processing is captured in Embodiment 7 of the present invention, and FIG. 31B is a view showing a display example of the captured image on the display;

FIG. 32A is a view showing an example of a relationship among the position of the image capturing apparatus, the positions of the objects in the captured image, and a virtual focus surface at image capturing of the target to be subjected to image processing is captured in Embodiment 7 of the present invention, and FIG. 32B is a view showing a display example of the captured image on the display;

FIG. 33A is a view showing an example of a relationship among the position of the image capturing apparatus, the positions of the objects in the captured image, and the virtual focus surface at image capturing of the target to be subjected to image processing is captured in Embodiment 7 of the present invention, and FIG. 33B is a view showing an example of display of the captured image on the display in Embodiment 7 of the present invention;

FIG. 34 is a view showing an example of a relationship among a position of an image capturing apparatus, positions of objects in a captured image, and a virtual focus surface at image capturing of a target to be subjected to image processing is captured in Embodiment 8 of the present invention;

FIG. 35 is a diagram showing the relationship of FIGS. 35A and 35B;

FIGS. 35A and 35B are a flowchart showing an example of a refocus process in Embodiment 9 of the present invention;

FIGS. 36A to 36D are views each explaining a display example of a screen in Embodiment 9 of the present invention;

FIG. 37 is a flowchart showing an example of a method of displaying a recommended region in Embodiment 9 of the present invention;

FIG. 38 is a block diagram showing an example of a hardware configuration in Embodiment 9 of the present invention;

FIG. 39 is a diagram showing the relationship of FIGS. 39A and 39B;

FIGS. 39A and 39B are a flowchart showing an example of a refocus process in reproduction in Embodiment 10 of the present invention;

FIG. 40 is a view for explaining an example of a method of displaying the progress of the process in Embodiment 10 of the present invention;

FIGS. 41A to 41D are each a view for explaining an example of progress display in Embodiment 10 of the present invention;

FIGS. 42A to 42E are each a view for explaining a display example of a screen in Embodiment 10 of the present invention;

FIG. 43 is a diagram showing an example of a system configuration in Embodiment 11 of the present invention;

FIG. 44 is a diagram showing an example of a configuration of a cloud server in Embodiment 11 of the present invention;

FIG. 45 is a diagram showing the relationship of FIGS. 45A, 45B and 45C;

FIGS. 45A to 45C are a flowchart showing an example of an operation in Embodiment 11 of the present invention;

FIGS. 46A to 46E are views showing display examples of an image and a GUI in a case where there is no feedback from a viewer in Embodiment 11 of the present invention;

FIGS. 47A to 47F are views showing display examples of the image and the GUI in a case where there is a feedback from the viewer in Embodiment 11 of the present invention;

FIGS. 48A to 48D are views each showing an example of an image displayed on a display terminal in Embodiments 11 and 12 of the present invention;

FIG. 49 is a block diagram showing an example of a hardware configuration of the display terminal in Embodiment 11 of the present invention;

FIG. 50 is a flowchart showing an example of an operation of the display terminal in Embodiment 11 of the present invention;

FIG. 51 is a diagram showing the relationship of FIGS. 51A, 51B and 51C;

FIGS. 51A to 51C are a flowchart showing an example of an operation in Embodiment 12 of the present invention;

FIGS. 52A to 52E are views showing display examples of an image and a GUI in a case where there is a feedback from a viewer in Embodiment 12 of the present invention;

FIG. 53 is a diagram showing the relationship of FIGS. 53A, 53B and 53C;

FIGS. 53A to 53C are a flowchart showing an example of an operation in Embodiment 13 of the present invention;

FIG. 54 is a graph showing an example of a distribution (histogram) of the number of pixels with respect to distance in Embodiment 14 of the present invention;

FIG. 55 is a graph showing an example of a coefficient by which the distribution of the number of pixels with respect to distance is multiplied in Embodiment 14 of the present invention;

FIG. 56 is a view showing an example of the distribution (histogram) of the number of pixels with respect to distance after the multiplication of the coefficient in Embodiment 14 of the present invention;

FIG. 57 is a flowchart showing an example of an operation related to determination of refocus image generation ranks in Embodiment 14 of the present invention;

FIG. 58 is a flowchart showing an example of an operation related to generation of data for determining refocus image generation ranks in Embodiment 15 of the present invention;

FIGS. 59A and 59B are views each showing an example of a distribution (histogram) of the number of pixels with respect to distance in Embodiment 15 of the present invention;

FIG. 60 is a view showing an example of an image data format used to stored multi-viewpoint image data in Embodiment 16 of the present invention; and

FIG. 61 is a flowchart showing an example of a refocus process in reproduction in Embodiment 16 of the present invention.

### DESCRIPTION OF THE EMBODIMENTS

Embodiments of the present invention are described below in detail by using the drawings.

### Embodiment 1

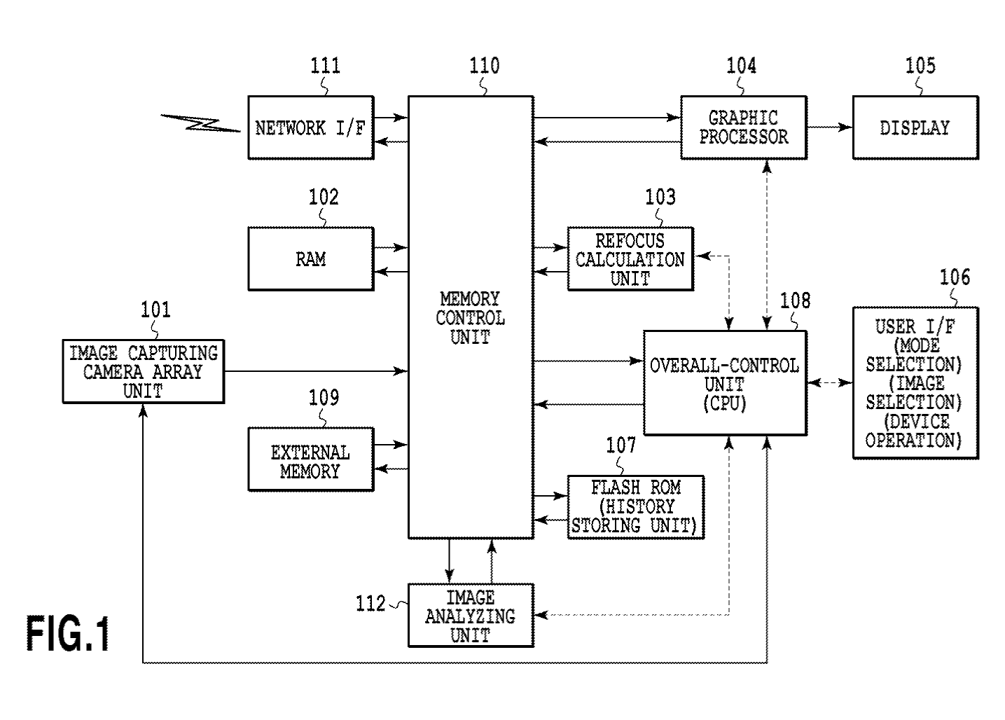

FIG. 1 is a block diagram showing an example of a hardware configuration of an image processing apparatus in Embodiment 1 of the present invention. FIG. 1 is described below in detail. An image capturing camera array (as known as camera array system, multiple lens camera and the like) unit 101 is an assembly of independent multiple cameras having independent optical systems and independent image capturing elements. The image capturing camera array unit 101 includes a controller of the image capturing elements and the like, and outputs a set of output data obtained from the multiple image capturing elements as multi-viewpoint image data.

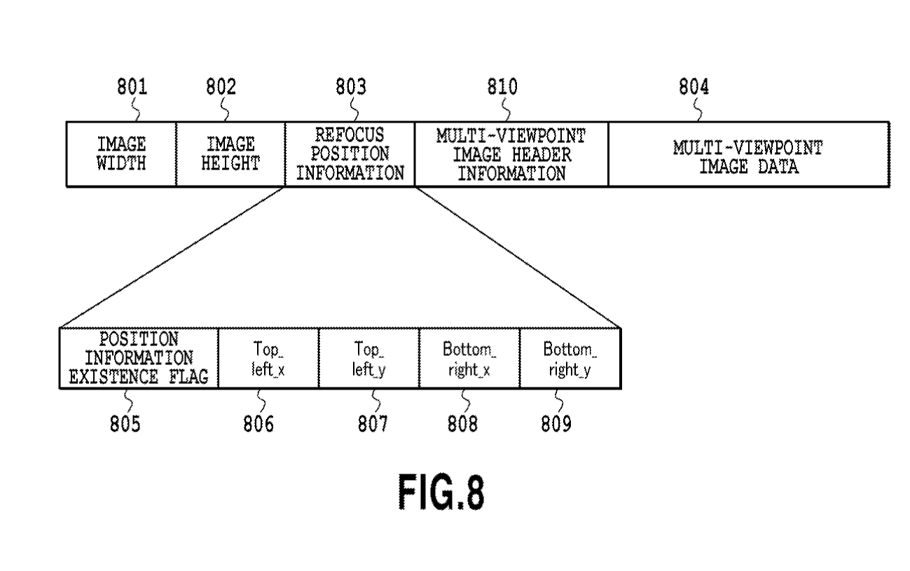

A RAM 102 is a memory used to temporarily store the multi-viewpoint image data captured by the image capturing camera array unit 101, generated refocus image data, and other data in the middle of calculation. A Flash ROM 107 is a non-volatile memory and functions as a history information storage unit which accumulates and stores operation history related to images (types and positions) and operations selected by a user in the past. An external memory 109 is an external memory such as a SD card. Moreover, the external memory 109 is a non-volatile memory and image data is stored therein even after the power is turned off. The multi-viewpoint image data captured by the image capturing camera array unit 101 is stored as an image file in the external memory 109 in an image data format shown in FIG. 8, for example. The details of the image data format will be described later. Moreover, the external memory 109 is also used as a region for temporary storing image data currently being processed as a temporary image file.

A memory control unit 110 includes a so-called bus-system as well as a controller for memories and devices which are connected to the bus-system. For example, the memory control unit 110 controls read and write of data from and to the memories including the RAM 102, the Flash ROM 107, and the external memory 109.

A user I/F (interface) 106 is an I/F (interface) used to operate the apparatus, select an image or a region for which refocus display is desired by the user, and select modes related to display of captured images. Specifically, a touch panel provided on a display 105, a shutter button, an operation dial, and the like correspond to the user I/F.

An overall-control unit (CPU) 108 performs arithmetic control of controlling the entire apparatus, selecting a region with the highest rank in frequency from the history information stored in the Flash ROM 107, giving instructions to a refocus calculation unit 103, and the like.

The refocus calculation unit 103 generates the refocus image data from the multi-viewpoint image data in accordance with an instruction from the overall-control unit 108. An outline of the generation of refocus image data from the multi-viewpoint image data is described. In light field photography, the direction and intensity (light field, hereafter referred to as “LF”) of each of light rays passing through multiple positions in a space are calculated from the multi-viewpoint image data. Thereafter, an image obtained if the light rays should pass through a virtual optically system and be focused on a virtual sensor is calculated by using the obtained information on LF. By appropriately setting the virtual optical system and the virtual sensor described above, the refocus image data which is combined image data with the focus on a certain target can be generated. Note that the refocus process is not the main theme of the embodiment and methods other than that described above can be used. The generated refocus image data is stored in the RAM 102, the external memory 109, or the like. The details will be described later.

A graphic processor 104 has a function of displaying the refocus image data generated by the refocus calculation unit 103 on the display 105. A network I/F 111 establishes a 3network connection with an external apparatus and performs data transfer with the external apparatus through the network.

An image analyzing unit 112 detects regions including objects in the image data and assigns an identification code for each region. The image analyzing unit 112 then stores region information and the identification code of each of the detected objects in the RAM 102. The objects in the embodiment are assumed to be objects including not only people and animals in the foreground but also a landscape portion in the background. The objects can be detected by, for example, utilizing several significant characteristics (such as pair of eyes, mouth, nose, and the like) and unique geometrical positional relationships among these characteristics. Alternatively, the objects can be detected by utilizing symmetric characteristics of a face, characteristics of face colors, template matching, a neural network, and the like. In the detection of the background, for example, faces of people and animals in an image are detected by the methods described above and positions and sizes thereof are calculated. Based on the result of this calculation, the image can be sectioned into an object region including the people in the image and into a background region other than the object region. For example, assuming that the object region has a rectangular shape, the format of the region information can be expressed in coordinates of the top left point and the bottom right point. Moreover, although the identification targets of objects are three types of people (or a face), animal, and landscape, the present invention is not limited to this and finer categories can be used. Note that the method of detecting and identifying the objects are not the main theme of the embodiment and methods other than that described above can be used. The image analyzing unit 112 executes the object detection and identification function immediately after an image is captured, and the result is stored in a non-volatile memory such as the Flash ROM 107 and the external memory 109. Accordingly, in the description of the embodiment, it is assumed that the region information and the identification codes of the objects are already stored.

The multi-viewpoint image data captured by the image capturing camera array unit 101 is stored as the image file in the external memory 109 in the image data format shown in FIG. 8.

FIG. 8 is a view for explaining the image data format used in a case where the multi-viewpoint image data is stored as the image file in the embodiment. The image file shown in FIG. 8 includes information 801 on the image width, information 802 on the image height, refocus position information 803, multi-viewpoint image header information 810, and the multi-viewpoint image data 804.

The refocus position information 803 includes a position information existence flag 805. The position information existence flag 805 is information indicating whether the refocus position information exists or not. The position information existence flag is 0 (false) in an initial state (state where there is no history) for example. In a case where the position information existence flag is 1 (true), the values of subsequent position information 806 to 809 are considered to be valid. Specifically, the position information existence flag being true means that information indicating a position of refocus is included. Top_left_x806 is information indicating an X coordinate of the top left point of a refocus region. Top_left_y807 is information indicating a Y coordinate of the top left point of the refocus region. Bottom_right_x808 is information indicating an X coordinate of the bottom right point of the refocus region. Bottom_right_y809 is information indicating a Y coordinate of the bottom right point of the refocus region.

One bit information added to the image file and indicating truth or false is sufficient as the position information existence flag 805. However, the position information existence flag 805 is not limited to one bit information and may be multi-bit information indicating the type of a refocus position information format. For example, the position information existence flag 805 can be configured as follows. The position information existence flag 805 being 0 means that no position information exists. The position information existence flag 805 being 1 means that the position information is expressed as information on a rectangle as described above. The position information existence flag 805 being 2 means that the position information is expressed as coordinates of the center of a circle indicating a focus target and a radius of this circle.

The multi-viewpoint image header information 810 includes information required to perform the refocus process and additional captured image information. For example, the multi-viewpoint image header information 810 includes model name of camera, lens configuration, image captured date, shutter speed, exposure program, and the like. Moreover, the multi-viewpoint image header information 810 includes position information of each piece of image data included in the multi-viewpoint image data which is used for the refocus process. In other words, information indicating the position of each image capturing unit is included. In the embodiment, a configuration example is shown in which position information 806 to 809 exist regardless of the truth and false of the position information existence flag. However, the image file is not limited to this and may be configured to include no entries for the position information 806 to 809 in a case where the position information existence flag is false. Moreover, the refocus position information can be configured to indicate any shape and the indicated shape is not limited to the rectangular region described in the embodiment.

The multi-viewpoint image data 804 may be RAW image data obtained from the image capturing elements or may be developed image data subjected to development processes such as a demosaicing process, a white balance process, a gamma process, a noise reduction process, and the like. Moreover, although an example using the image capturing camera array unit 101 is described in the embodiment, the multi-viewpoint image data may be any type of data which is obtained from multiple viewpoints. For example, captured-image data obtained by using a microlens array may be used.

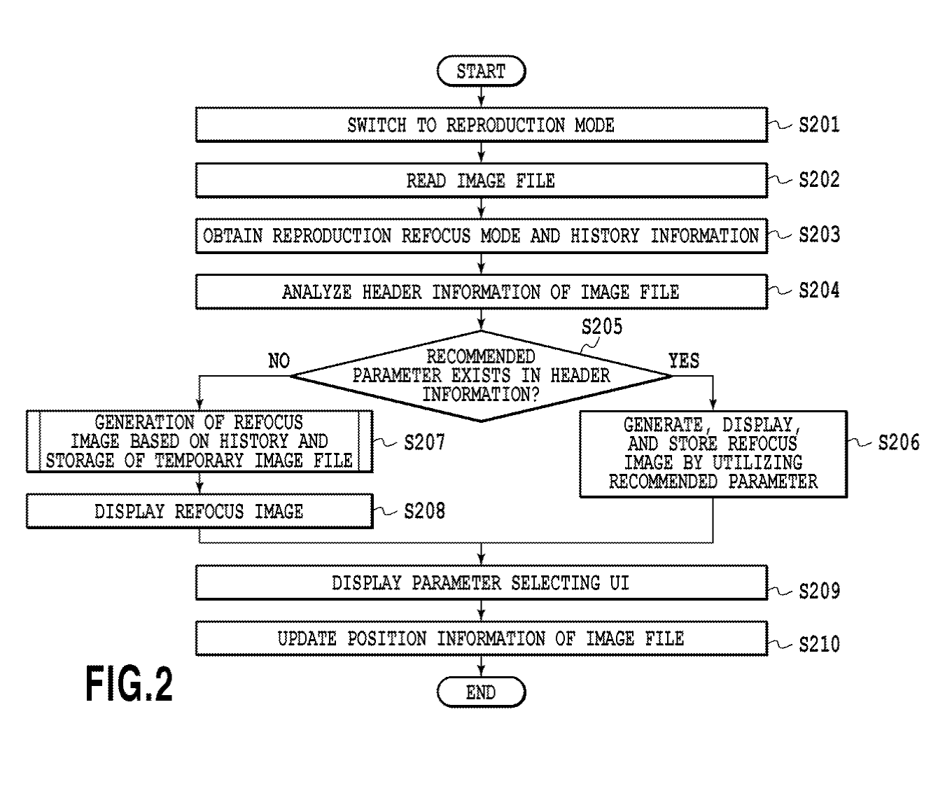

FIG. 2 is a flowchart showing a flow from switching to a reproduction mode to display of the first refocus image. The reproduction mode is an operation mode in which control is performed to display the image file stored in the external memory 109 on the display 105. The overall-control unit (CPU) 108 executes the flow of FIG. 2 by controlling the refocus calculation unit 103, the graphic processor 104, and the like.

A program for causing the overall-control unit 108 to execute the control shown in FIG. 2 is stored in, for example, the Flash ROM 107 or the like. Moreover, a program for the refocusing described above is also stored. The image file described in the flow of FIG. 2 is assumed to be the multi-viewpoint image data which is captured by the image capturing camera array unit 101 and which is already stored in the external memory 109 together with the header information as shown in FIG. 8.

In step S201, the overall-control unit 108 switches the operation mode to the reproduction mode. The following three patterns are conceivable as the case of proceeding to the process of step S201.

1. The apparatus is activated in a mode other than the reproduction mode and is then switched to the reproduction mode.
2. The apparatus is already in the reproduction mode when the apparatus is activated.
3. A different image is designated in the reproduction mode.

In step S202, the overall-control unit 108 obtains the image file from the external memory 109. In step S203, the overall-control unit 108 obtains a reproduction refocus mode and the history information, and causes the process to proceed to step S204. The reproduction refocus mode is a mode selected from, for example, a person mode, a landscape mode, an animal mode, and the like in a case of displaying an image data for which refocus calculation is already performed (hereafter, referred to as refocus image data). The history information is information obtained by accumulating history related to operations as well as the types and positions of the image data selected by the user in the past. The details of the history information will be described later. In step S204, the header information of the image file read by the overall-control unit 108 is analyzed. The header information corresponds to the information 801 to 803 in FIG. 8. In the embodiment, the refocus position information 803 is particularly analyzed.

In step S205, the overall-control unit 108 determines whether a recommended parameter exists in the header information analyzed in step S204. The recommended parameter is a parameter indicating an image and a display method which are recommended to be used in the refocusing of the image file. In a case where the recommended parameter exists, the process proceeds to step S206. In a case where no recommended parameter exists, the process proceeds to step S207. In the embodiment, the position information existence flag 805 shown in FIG. 8 is a flag of one bit. In a case where the value of the flag is 1, the overall-control unit 108 determines that the recommended parameter exists and causes the process to proceed to step S206. In a case where the value of the flag is 0, the overall-control unit 108 determines that no recommended parameter exists and causes the process to proceed to step S207.

In step S206, the overall-control unit 108 controls the refocus calculation unit 103 to generate the refocus image data by utilizing the recommended parameter obtained by analyzing the refocus position information 803 of the image file read in step S202.

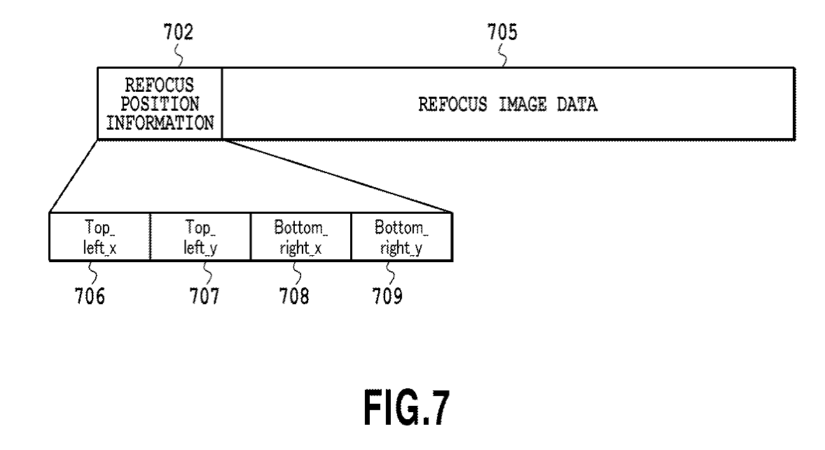

Specifically, the refocus calculation unit 103 generates, from the multi-viewpoint image data 804 included in a reproduction file, a piece of image data with the focus on a position whose X coordinate is equal to the mean of the position information 806 and 808 and whose Y coordinate is equal to the mean of the position information 807 and 809. The refocus image data generated by the refocus calculation unit 103 is displayed on the display 105 via the graphic processor 104. Moreover, the generated refocus image data is stored as the temporary image file in the external memory 109 or the RAM 102 in a temporary image file format shown in FIG. 7. FIG. 7 is a view showing an example of the temporary image file format of the image file including a piece of refocus image data generated by the refocus calculation unit 103. The image file stored in the temporary image file format includes refocus position information 702 and a piece of refocus image data 705. The refocus position information 702 includes information indicating the position brought in focus in the refocus process of the refocus image data 705. The position information 706 to 709 can be the same information as the position information 806 to 809 in FIG. 8. The temporary image file shown in FIG. 7 is generated for each refocus image data, for example.

The fact that the process has proceeded to step S206 means that the recommended parameter exists. Accordingly, there is stored the temporary image file in which the information included in the recommended parameter is included in the refocus position information denoted by reference numeral 702 in FIG. 7. The stored area of the temporary image file is not limited to the external memory 109 and the RAM 102. The temporary image file may be stored in a storage device on a cloud via the network I/F 111.

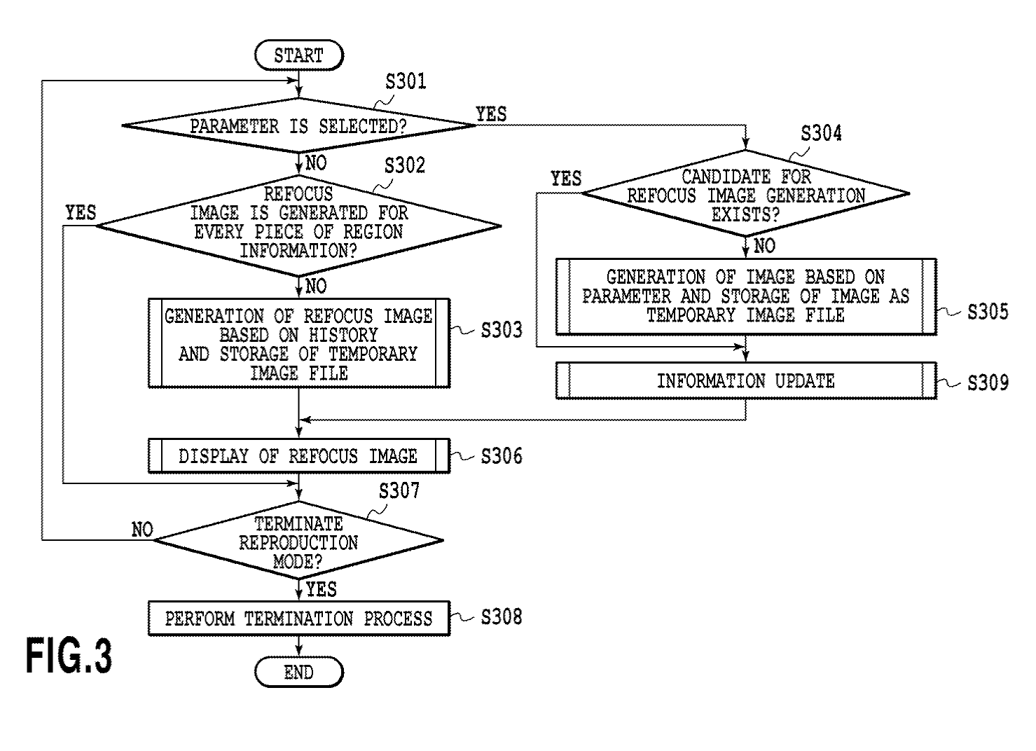

Next, description is given of a process performed in a case where no recommended parameter exists in the header information in step S205. The process of step S207 is a process performed in a case where no recommended parameter exists in the image file read from the memory in step S202, i.e. in a case where the image file is displayed in the reproduction mode for the first time. In the embodiment, the refocus image data is generated based on the history information and is stored as the temporary image file. Moreover, the history information is updated. A process of generating the refocus image data on the basis of the history information and a process of updating the history information are described later in relation with FIG. 3 and description thereof is omitted herein.

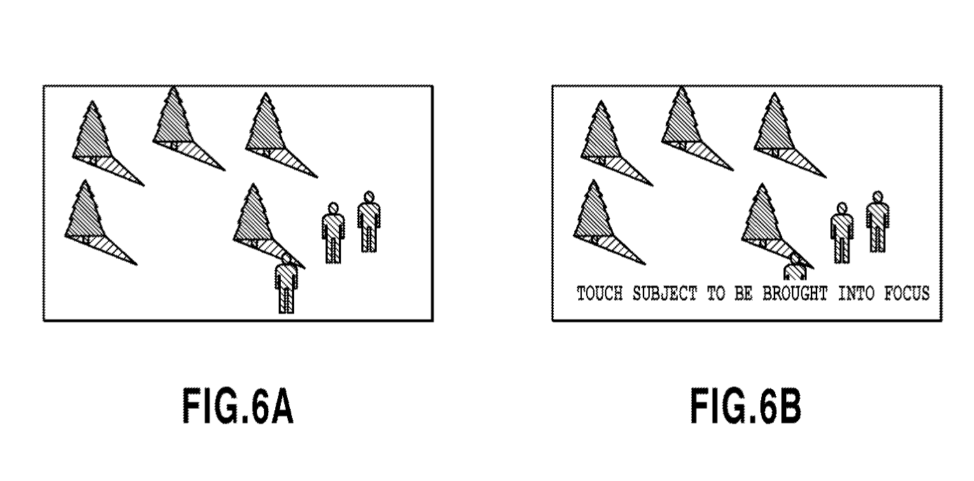

In step S208, a refocused image generated by the graphic processor 104 in step S207 is displayed on the display 105. FIGS. 6A and 6B are each a view showing an example of display of the refocus image data generated in step S206 or step S207. FIG. 6A shows an example of an image with the focus on the landscape (trees).

In step S209, the graphic processor 104 additionally displays a parameter selecting UI screen on the display 105. An example in which the parameter selecting UI screen is added is shown in FIG. 6B. In the example of FIG. 6B, the user is assumed to designate a point desired to be in focus by using a touch panel. In other words, the graphic processor 104 displays a UI screen by which the user can input the position (parameter) to be in focus. Note that the parameter may represent information of a two-dimensional position in the image or a spatial distance (depth) in the multi-viewpoint image.

In step S210, the overall-control unit 108 updates the refocus position information 803 of the image file read in step S202. Specifically, in a case where no recommended parameter exists in the header information, the overall-control unit 108 updates the refocus position information 803 to position information of the region including the refocus position determined in step S207. In a case where the recommended parameter exists in the header information, there is no need update the refocus position information 803 of the image file read in step S202. In other words, step S210 is a process of storing the refocus position information of the currently-displayed refocus image as first recommended information in a case where no first recommended information is included in the refocus position information of the image file. Meanwhile, in a case where the first recommended information is included in the refocus position information of the image file and is different from the refocus position information of the currently-displayed refocus image, the following process is performed. Specifically, the refocus position information of the currently-displayed refocus image is used as second recommended information and the first recommended information stored in the image file is updated to the second recommended information. This is the operation performed in the case where the reproduction mode is activated, i.e. the process related to the refocus image displayed first in the case where a certain image file is read.

Next, operations performed after the display of the first refocus image data (display of the second and subsequent refocus image data, termination of the operation, and the like) are described by using FIG. 3. Specifically, a process performed after the display of the refocus image is described by using FIG. 3, the refocus image displayed first in the case where the image file is read, as described in the flow of FIG. 2. The overall-control unit 108 controls the entire flow shown in FIG. 3, as in the flow of FIG. 2.

In a case where the parameter selecting UI shown in FIG. 6B is displayed in step S209 of FIG. 2, the user can select a parameter by utilizing the displayed UI. In step S301, in a case where the user selects a parameter by using the UI, the overall-control unit 108 causes the process to proceed to step S304. In the embodiment, the user selects a parameter by designating one point on a screen. Next, in step S304, the parameter selected by the user in step S301 is obtained. In step S304, the overall-control unit 108 determines whether the refocus image data including the parameter designated (selected) by the user in step S301 exists in a temporary image file group stored in the format shown in FIG. 7. In other words, the overall-control unit 108 determines whether the temporary image file including the refocus position information 702 including the parameter designated by the user exists. In a case where the temporary image file including the piece of refocus image data matching the parameter designated by the user exists in step S304, the overall-control unit 108 causes the process to proceed to step S309. In step S309, information (position and display history information) on the temporary image including the refocus image is updated, and the process proceeds to step S306. The details will be described later.

In step S306, the graphic processor 104 displays the temporary image including the refocus image data matching the parameter designated by the user, on the predetermined display 105.

Meanwhile, in a case where no temporary image file including the piece of refocus image data matching the parameter designated by the user exists in step S304, the overall-control unit 108 causes the process to proceed to step S305. In step S305, based on the parameter designated by the user in step S301, the refocus calculation unit 103 generates the piece of refocus image data with the focus on the region indicated by the parameter. In step S305, the generated refocus image data is stored in the RAM 102 or the like, as the temporary image file shown in FIG. 7.

After the process of step S305 is completed, the overall-control unit 108 causes the process to proceed to step S309.

In step S309, the information (position and display history information) on the refocused image generated in step S305 in accordance with the parameter designated by the user in step S301 is updated and the process proceeds to step S306. The details will be described later.

In step S306, for example, the refocus image data generated or selected in accordance with the parameter designated in step S301 is read from the RAM 102 or the like and is displayed on the display 105.

Detailed description is given of the information update in step S309. As described above, the image analyzing unit 112 detects the regions of the objects in the captured multi-viewpoint image data and assigns the identification code to each region. The region information and the identification code of each region are stored in a non-volatile memory such as the Flash ROM 107 and the external memory 109. Here, the stored region information and the designated parameter are compared to each other. In a case where the designated parameter is included in the region information, update is performed by using the region information as the position information. In other words, the refocus position information 702 of the temporary image file is updated to the region information which is categorized as the object and in which the position of the object is specified. Meanwhile, in the case where the stored region information and the designated parameter are compared to each other and no designated parameter is included in the region information, the refocus position information 702 of the temporary image file is updated to the designated parameter.

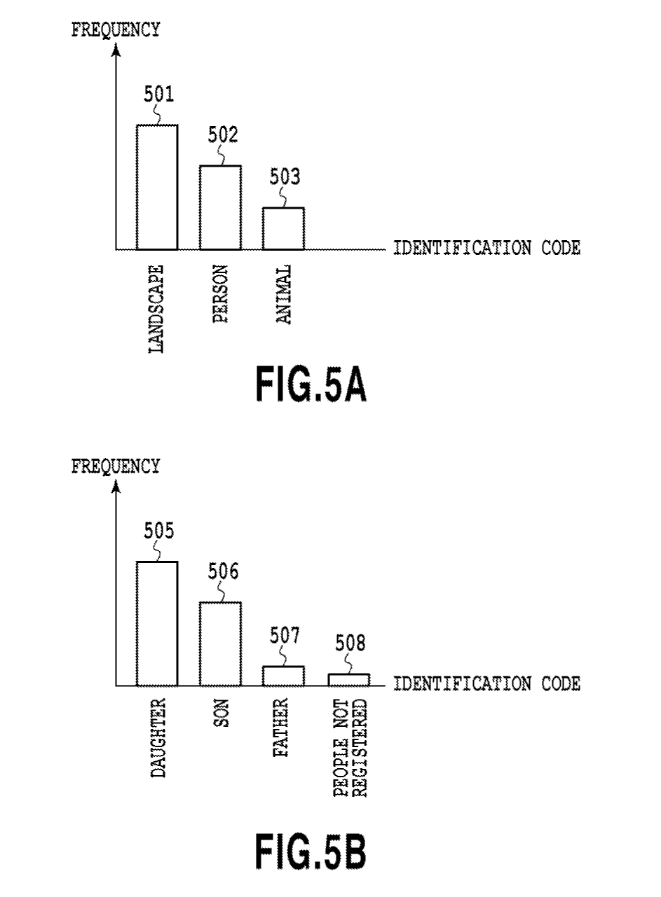

Next, description is given of the history information by using FIGS. 5A and 5B. In FIGS. 5A and 5B, “identification code” refers to identification codes identified by the image analyzing unit 112. “Frequency” refers to a frequency of the user making instructions to display images with the focus on the regions indicated by each of the identification codes (figure, landscape, and the like) in the reproduction mode. The frequency may be the frequency in each image file or may be the frequency of instructions given by a certain user in the image processing apparatus irrespective of image files. FIG. 5A shows an example in which reference numeral 501 denotes identification code=landscape, reference numeral 502 denotes identification code=figure, and reference numeral 503 denotes identification code=animal. Here, the frequency ranks of the respective identification codes are as follows.

### First Rank: Landscape (501)

### Second Rank: Person (502)

### Third Rank Animal (503)

FIG. 5B shows an example in which identification code=person is further segmented. Note that the daughter, the son, and the father can be identified from each other by, for example, calculating a feature vector of a face image of each person in advance and comparing a region determined to be a person with the feature vector. Here, the frequency ranks of the respective identification codes are as follows.

First Rank: The daughter of user (505)
Second Rank: The son of user (506)
Third Rank: The father of user (507)

Fourth Rank: People not registered (508)

In the embodiment, the history information refers to the frequency information on each of the identification codes.

Next, the update of the history information is described. As described above, in a case where the designated parameter is included in the region information, the frequency information on the identification code associated with the region of the region information is incremented. Meanwhile, in a case where no designated parameter is included in the region information, the history information is not updated because the coordinate information is the only useful information.

Next, description is given of a process performed in the case where the user selects no parameter in step S301. The process proceeds to step S302 with the already-displayed image continuously displayed.

In step S302, the overall-control unit 108 determines whether the refocus image data is generated for every piece of region information extracted by the image analyzing unit 112, with the focus on the piece of the region information. Specifically, the overall-control unit 108 determines whether the temporary image file having the refocus position information 702 including the region information exist for every piece of region information.

In a case where the overall-control unit 108 determines in step S302 that the refocus image is not generated for every piece of region information, the process proceeds to step S303. Meanwhile, in a case where the overall-control unit 108 determines in step S302 that the refocus image has been generated for every piece of region information, the process proceeds to step S307.

In a case where the overall-control unit 108 determines that the refocus image is not generated for every piece of the region information, the refocus image data is generated based on the history information in step S303. The details will be described later. Next, the generated refocus image is displayed in step S306 and the process proceeds to step S307.

In step S307, the overall-control unit 108 determines whether to terminate or continue the reproduction mode. The terminating conditions of the reproduction mode in step S307 include the following three conditions for example.

1. The operation mode is switched to a mode other than the reproduction mode.
2. Power source is turned off.
3. Another image is designated in the reproduction mode.
In a case where the reproduction mode is determined to be terminated in step S307, the process proceeds to step S308 and various processes required to terminate the reproduction mode are executed and the reproduction mode is thereby terminated. Meanwhile, in a case where the reproduction mode is determined to be continued in step S307, the process returns to step S301 and the operation is repeated from step S301.

Although the parameter selection is performed by the user pointing one point on the screen, the point may be designated as a closed region. For example, absence and presence of the history information can be determined by comparing the image including the point designated by the user and the image included in the designated closed region with the history in the Flash ROM (history storing unit) 107.

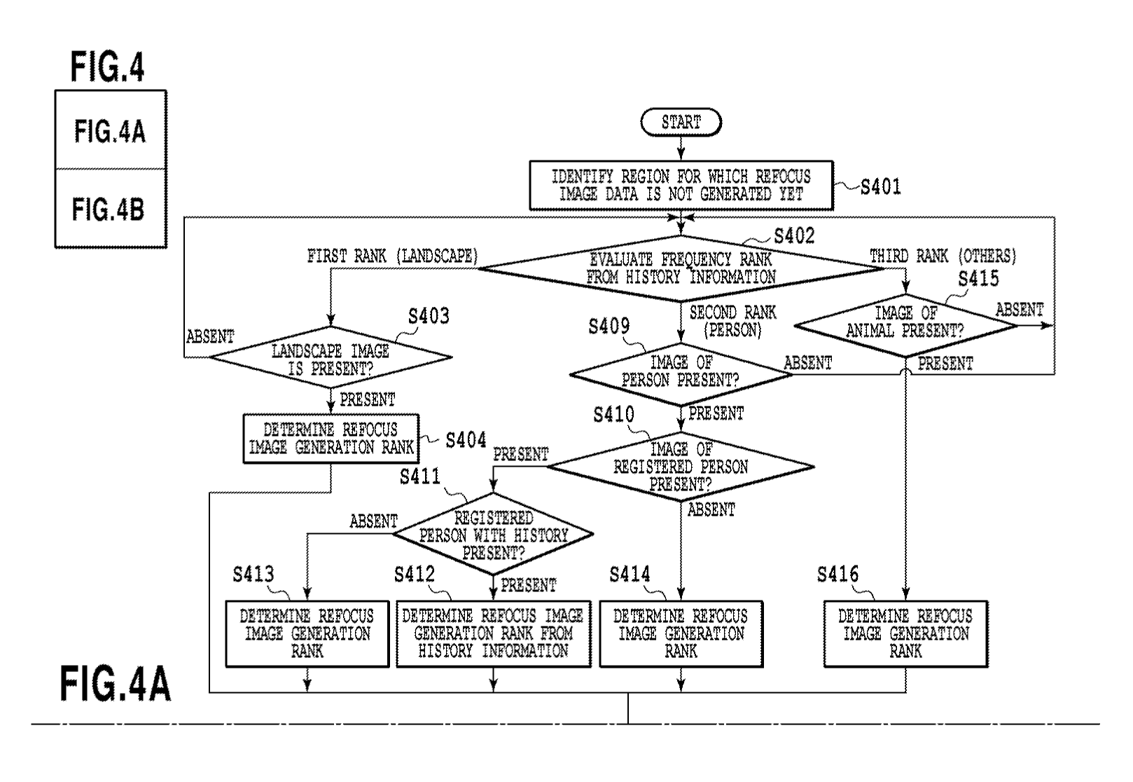

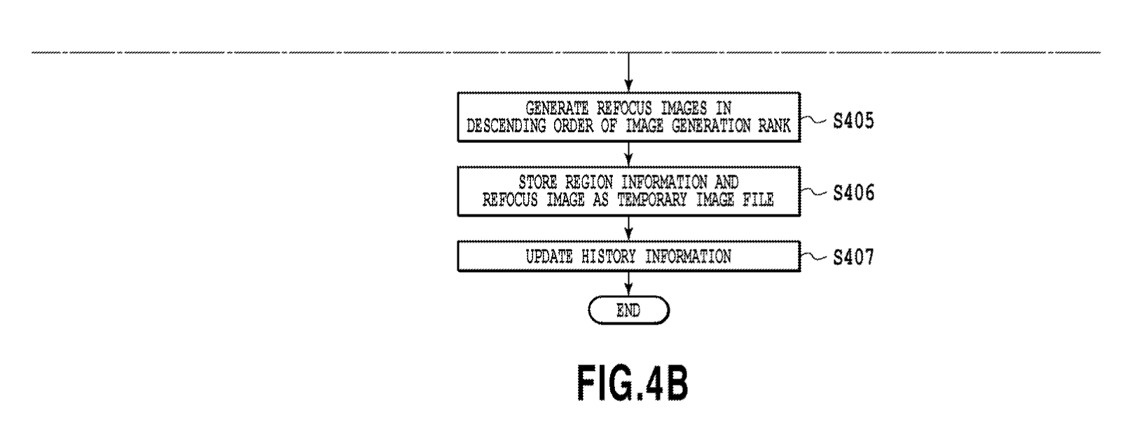

Next, the details of processes in step S207 of FIG. 2 and in step S303 of FIG. 3 are described by using the flowchart of FIGS. 4A and 4B. The overall-control unit (CPU) 108 executes the process shown in the flowchart of FIGS. 4A and 4B by controlling the refocus calculation unit 103, the graphic processor 104, and the like.

As described above, the image analyzing unit 112 detects regions of objects in the captured multi-viewpoint image data and assigns an identification code for each region. The region information and the identification code of each region are then stored in a non-volatile memory such as the RAM 102 and the external memory 109. Moreover, the history information refers to the frequency information shown in FIGS. 5A and 5B. Specifically, it is assumed that, in the past history (frequency), the images of landscapes are the first rank in frequency, the images of people are the second rank, and the images of animals are the third rank. Moreover, it is assumed that, in the images of peoples, the daughter is the first rank in frequency, the son is the second rank, the father is the third rank, and people not registered is the fourth rank.

In step S401, the overall-control unit 108 identifies a region for which the refocus image data is not generated. First, the overall-control unit 108 obtains all of the pairs of the identification code and the region information of the image analysis results related to the target image data (i.e. image data expressed by the multi-viewpoint image data of the image file read in step S202). The overall-control unit 108 also obtains the position information of the refocus image data included in all of the temporary image files. Next, among the obtained information, the region information and the refocus position information 702 included in the temporary image files are compared with each other. Then, the region information including the position information is excluded and the region information for which the corresponding position information does not exist is extracted. In other words, the extracted region information corresponds to a region for which the refocus image data is not generated.

Next, in step S402, the overall-control unit 108 selects, from the identification codes associated with the region information extracted in step S401, an identification code with the highest rank in frequency in the history information. In a case where the frequency of the identification code corresponding to landscape ranked the highest as a result of selection, the step proceeds to step S403. In step S403, the overall-control unit 108 determines whether a region corresponding to the landscape image exists in the region information extracted in step S401. In a case where a landscape image exists, the step proceeds to step S404.

In step S404, the region information whose identification code is landscape is extracted. In a case where there is only one piece of region information, the region corresponding to this region information is determined as a region for which the refocus image data is to be generated next. In a case where there are multiple regions having the identification code corresponding to landscape, the ranks can be determined by using the X coordinate and the Y coordinate of the top left point in the region information of each region for example. Specifically, the refocus calculation ranks can be determined in the ascending order of the value of the X coordinate. Moreover, in a case where there are multiple X coordinates with the same value, the refocus calculation ranks can be determined in the ascending order of the Y coordinate. Here, the region information with the highest rank is determined as a region for which the refocus image is to be generated next.

Next, the process proceeds to step S405. In step S405, the refocus calculation unit 103 generates the refocus image data with the focus on the region information of each rank, based on the ranks determined in step S404. Specifically, the refocus calculation unit 103 generates, from the multi-viewpoint image data, the image data with the focus on the position whose X coordinate and Y coordinate are each equal to the mean of the coordinates of the top left point and the bottom right point.

Next, the process proceeds to step S406. In step S406, the refocus image data generated in step S405 and the temporary image file including, as the refocus position information, the region information in focus in the generated refocus image data are stored in the temporary image file format shown in FIG. 7.

Then the process proceeds to step S407. In step S407, the history information is updated. Specifically, the frequency corresponding to the selected identification code is incremented. Thereafter, the process is terminated.

Next, the process returns to step S402. In a case where the frequency of the identification code corresponding to person ranked the highest as a result of selection, the step proceeds to step S409. In step S409, the overall-control unit 108 determines whether an image of person exists. In a case where no image of person exists, the process returns to step S402. In a case where an image of person exists, the process proceeds to step S410. In step S410, the overall-control unit 108 determines whether an identification code of registered person like one shown in FIG. 5B exists. In a case where an identification code of registered person exists, the process proceeds to step S411. In Step S411, the overall-control unit 108 determines whether the registered person confirmed to exist in step S410 exists in the history information. In a case where the registered person exists in the history information, the process proceeds to step S412. In step S412, the ranks of the refocus image generation is determined in accordance with the frequency in the history information. In FIG. 5B, the daughter is first in the rank, the son is second, and the father is third. Accordingly, in a case where the identification code of the daughter exists in the identification codes, the daughter is ranked highest.

In a case where no registered person exists in the history information in step S411, the process proceeds to step S413. Moreover, in a case where no identification code of the registered person exists in step S410, the process proceeds to step S414. A process similar to that in step S404 is performed in steps S413 and S414.

Next, the process returns to step S402. In a case where the frequency of the identification code corresponding to animal is ranked highest as a result of selection, the step proceeds to step S415. In a case where an image of animal is determined to exist, the process proceeds to step S416. In step S416, a process similar to that in step S404 can be performed.

In a configuration described above, the refocus image data can be generated before receiving an instruction from the user, by utilizing the past history. Specifically, in a case where no recommended parameter is included in the header information of the image file including the multi-viewpoint image data in the first reading of the image file, the refocus image data can be generated without an instruction from the user, by using the history information. Moreover, using the history information allows the refocus image data to be generated in accordance with the selected frequency of the objects which are brought in focus by the user in the past. Generating the refocus image data in advance without an instruction from the user has the following effect. In a case where the user designates a desired focus region, the refocus image desired by the user can be displayed without waiting for a refocus calculation time to elapse.

Moreover, since it is possible to predict the refocus image to be displayed next and perform the refocus calculation while the previous refocus image is displayed, the utilization efficiency of the calculation resource is improved. Accordingly, effects similar to that obtained by improving the processing speed can be expected without upgrading the hardware.

Furthermore, the image processing apparatus is improved to make clearer determination of the taste of the user every time the refocus calculation is performed. Accordingly, the prediction accuracy of the refocus region is improved every time the image processing apparatus is used. Thus, switching of the refocus images can be expected to be increased in speed.

In addition, in the embodiment, parameter information specifying the focus position lastly designated by the user is buried in the image file including the multi-viewpoint image data. Accordingly, in a case where the image file is read and displayed next time, the image lastly displayed by the user is displayed without performing any resetting of the parameter. Thus, the work of setting the parameter performed by the user can be omitted and this leads to improvement in operability of an apparatus employing this technique.

In the embodiment, the flow of FIGS. 4A and 4B is described by using an example in which three (people, landscape, and animal) choices are provided, for the sake of simplifying the description. However, any identifiable object can be included in the choices. Furthermore, in the embodiment, the image of person is described by using an example in which there are three registered people and an unregistered people, i.e. the daughter, the son, the father, and an unregistered people. However, the number of registered people may be four or more. Moreover, although the registered people are all family members, the registered people are not limited to this.

Moreover, in the embodiment, description is given of an example in which a plurality of refocus image data are sequentially generated based on the history information in the case where no recommended parameter exists in the header information of the image file. However, refocus image data can be generated based on the history information as shown in the process of step S209 of FIG. 2 (i.e. process shown in FIG. 3), even in the case where the recommended parameter exists in the header information of the image file.

### Embodiment 2

In Embodiment 2, description is given of an example in which a current reproduction refocus mode and history information on the reproduction refocus mode are added to prediction factors.

The description of step S207 of FIG. 2 (Embodiment 1) explains the process which is performed in a case where no recommended parameter exists in the image file stored in the memory, i.e. in the case where the display in the reproduction mode is performed for the first time. Moreover, the description related to step S207 of Embodiment 1 explains that the refocus calculation can be performed by predicting the refocus region on the basis of the past history information related to the reproduction of the refocus image.

Embodiment 2 is different from Embodiment 1 in that information on the current reproduction refocus mode and the history information on the current reproduction refocus mode are added to the prediction factor (i.e. past history information) of the refocus region shown in step S207 of FIG. 2 and step S303 of FIG. 3. The reproduction refocus mode is a function capable of switching a refocus target depending on a target desired to be in focus. For example, the reproduction refocus mode can be selected from people, landscape, and animal modes and is a setting which allows refocus calculation suitable for each type of object to be performed.

The history information described in Embodiment 1 is information on overall history of past. The history information on the current reproduction refocus mode in Embodiment 2 is information on history of the reproduction refocus mode. Here, the history information described in Embodiment 1 is referred to as first history information and the history information on the current reproduction refocus mode is referred to as second history information.

In Embodiment 1, description is given of an example using only the history information on the past refocus calculation or display. In Embodiment 2, the information on the reproduction refocus mode is added to the history information as the prediction factor to improve the prediction accuracy of the refocus region and the calculation ranks.

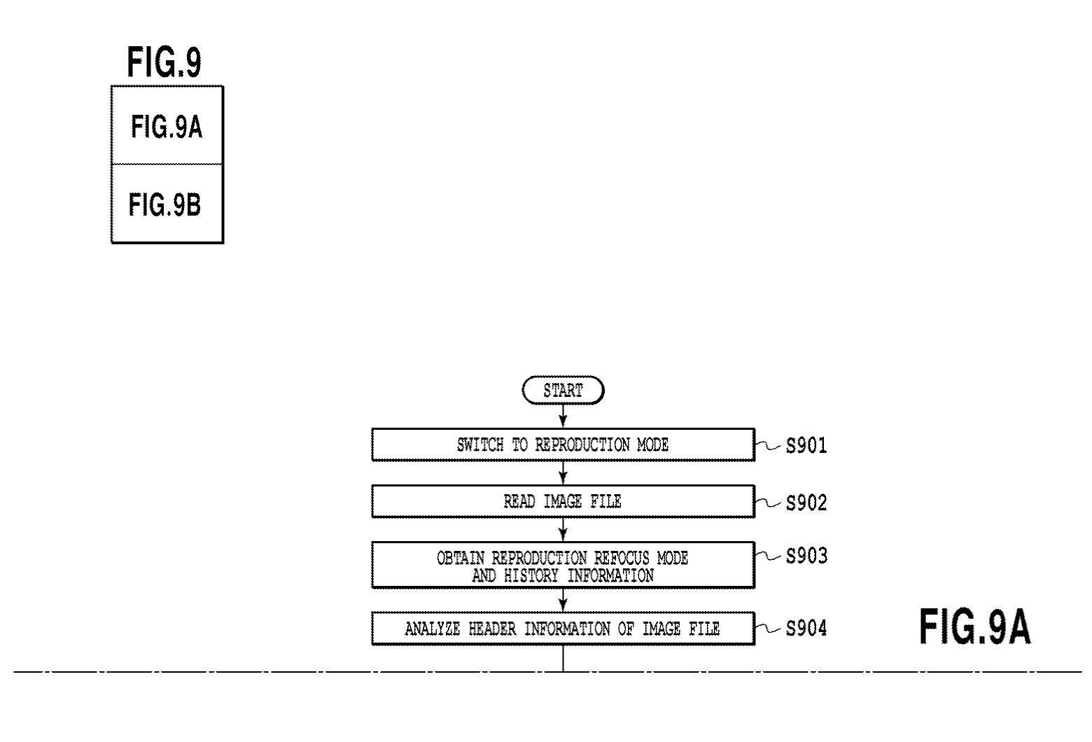

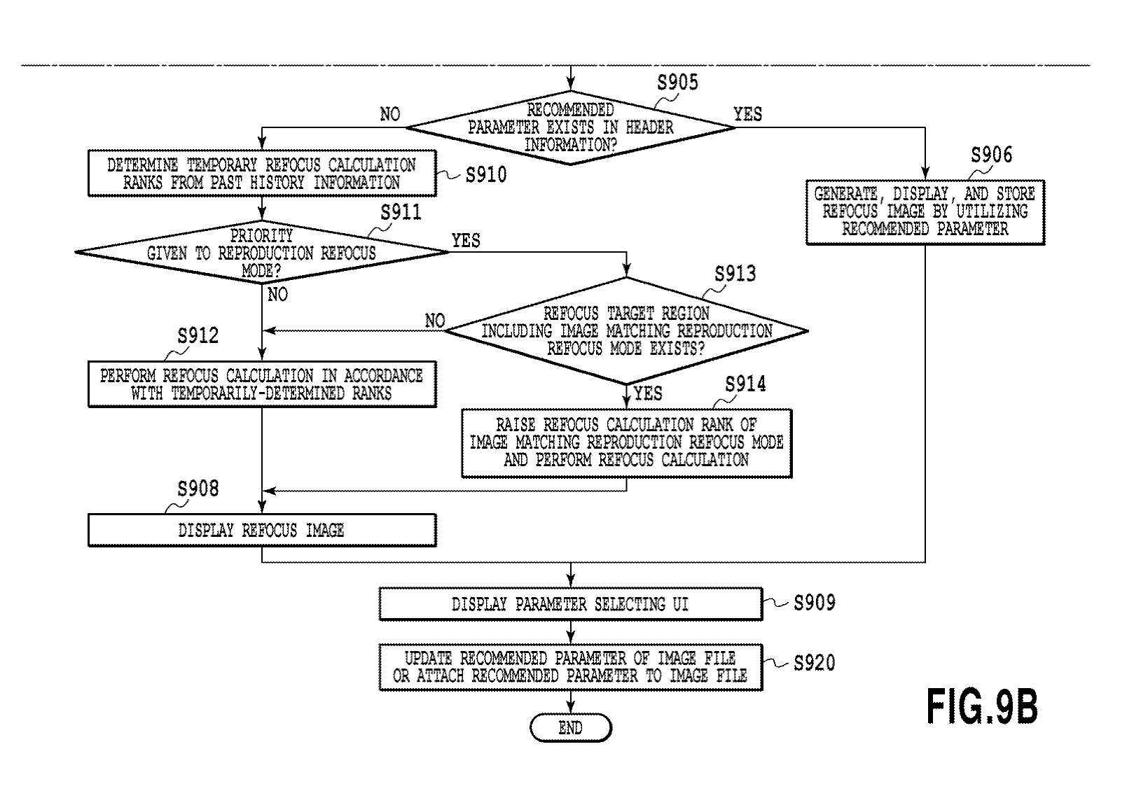

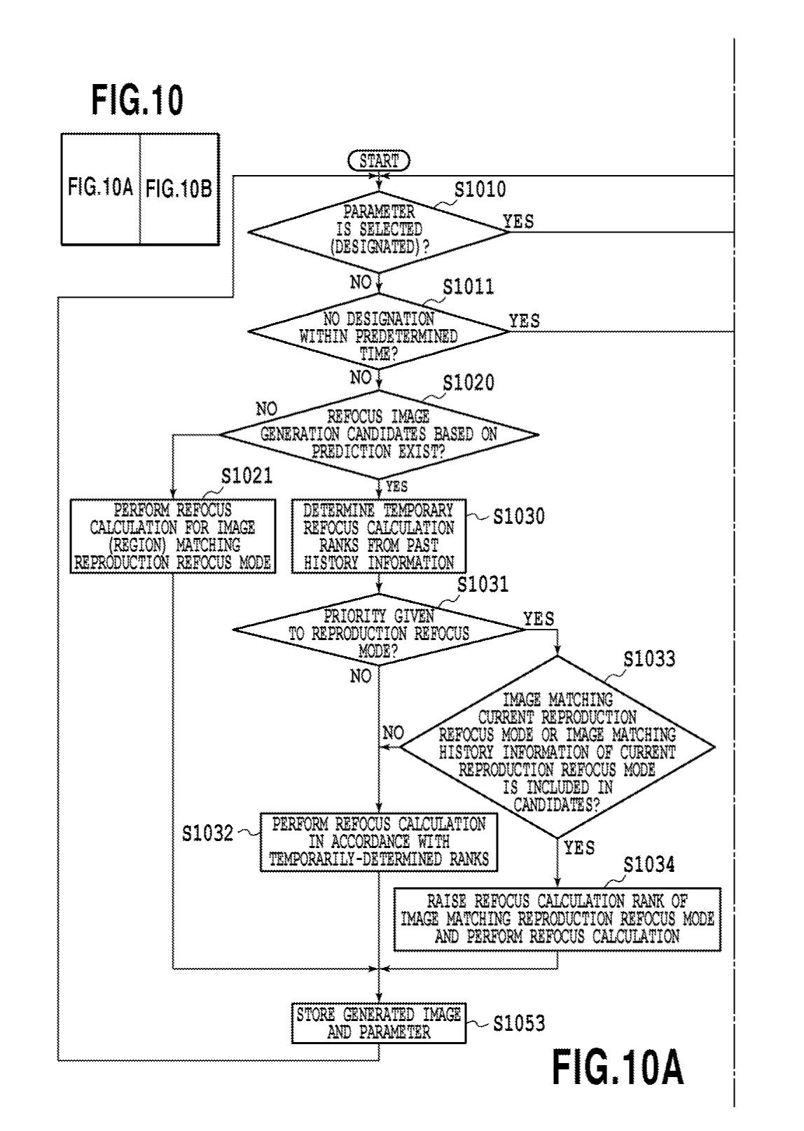

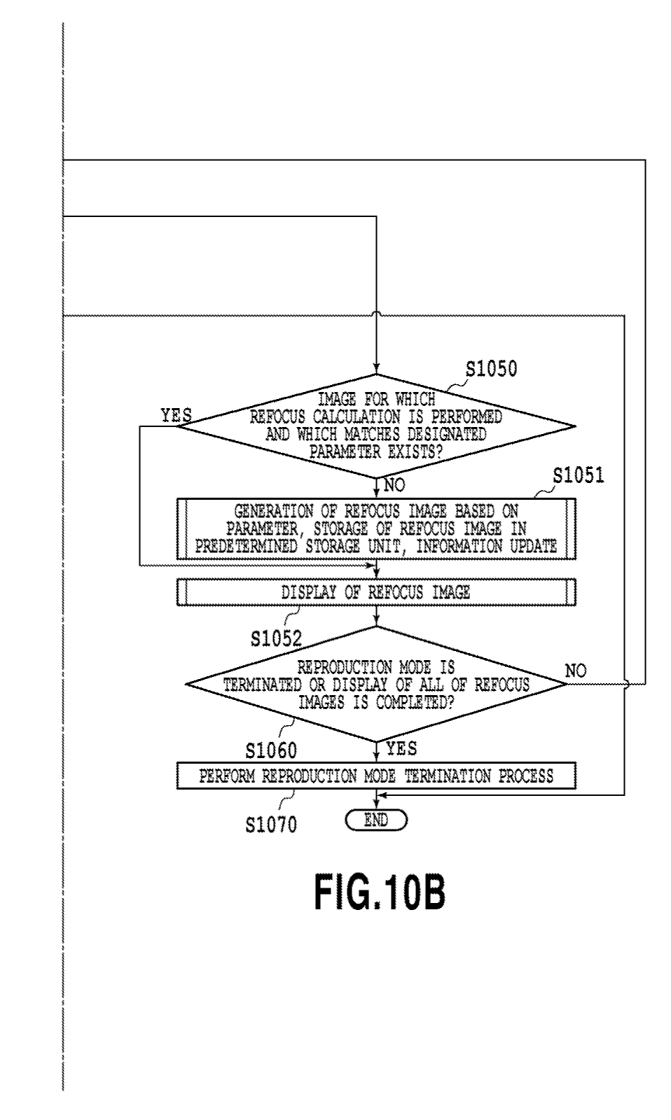

First, description is given of a process performed in a case where no recommended parameter exists in a refocus image file stored in a memory, i.e. a process performed up to the display of the first refocus image in the embodiment. In the example described below with reference to FIGS. 9A and 9B, the aforementioned history information (second history information) on the reproduction refocus mode is not used to display the first refocus image. However, the second history information can be used as in the process of FIGS. 10A and 10B to be described later.

Steps S901 to S906 of FIGS. 9A and 9B are similar to the processes in FIG. 2 and description thereof is thereby omitted. In step S910 of FIG. 9B, an overall-control unit 108 refers to the first history information and read frequency information on past refocus calculation processes. The overall-control unit 108 thereby temporarily determines refocus calculation ranks in the descending order of frequency and causes the process to proceed to step S911. This process of temporal determination may be the same as the process shown in the flow of FIGS. 4A and 4B for example.

In step S911, the overall-control unit 108 determines whether a camera or the like is a set to give priority to the current reproduction refocus mode or to the past history information (for example, FIGS. 5A and 5B). In a case where the overall-control unit 108 determines in step S910 that the priority is given to the current reproduction refocus mode, the process proceeds to step S913. In a case where the overall-control unit 108 determines that the priority is given to the past history information, the process proceeds to step S912.

A user generally selects the setting of giving priority to the current reproduction refocus mode or the setting of giving priority to the past history information by using a menu or the like displayed on, for example, a viewer of a device such as a camera main body or a PC. Moreover, the one which the priority is to be given may be set in advance as an initial value.

In a case where the overall-control unit 108 determines in step S911 that the priority is given to the reproduction refocus mode, the overall-control unit 108 performs the following process in step S913. Specifically, the overall-control unit 108 determines whether each of refocus target regions of objects detected by an image analyzing unit 112 includes an image matching the current reproduction refocus mode. In a case where the overall-control unit 108 determines that the refocus target region includes an image matching the current reproduction refocus mode, the process proceeds to step S914. Meanwhile, in a case where the overall-control unit 108 determines in step S913 that the refocus target region does not include an image matching the current reproduction refocus mode, the process proceeds to step S912. The subsequent processes are the same as in the case where the overall-control unit 108 determines in step S911 that the priority is not given to the current reproduction refocus mode.

In step S914, the overall-control unit 108 raises the refocus calculation rank (temporarily determined in step S910) of a region determined to include an image matching the current reproduction refocus mode in step S913, by one. Note that raising the rank by one is merely an example and there is no limitation on change of the rank. The refocus calculation order temporarily determined in step S910 is changed by the process in step S913. Then, the refocus calculation ranks of all of the refocus target regions are determined and the refocus calculation of each refocus target region is performed in accordance with the determined refocus calculation rank for generating refocus image data piece.

In step S914, after the refocus calculation is completed, the generated refocus image data is stored in a memory such as an external memory 109, as a temporary stored file. In step S908, the refocus image data stored in the memory is read and displayed on a predetermined display. Then, the process proceeds to step S909. Processes of steps S909 and S920 are similar to those of steps S209 and S210 of FIG. 2 in Embodiment 1 and description thereof is thereby omitted.

Next, the refocus process for the second and subsequent refocus images in the embodiment is described by mainly using FIGS. 10A and 10B. Specifically, a process subsequent to step S909 of FIG. 9B is described in FIGS. 10A and 10B. The second history information is used in some cases in FIGS. 10A and 10B.

It is assumed that the case shown in FIGS. 10A and 10B is a case where the refocus calculation for the second and subsequent refocus images is performed. Specifically, it is assumed that there is display history of the refocus image data generated by performing the refocus calculation at least one time in the past, and there remains history of refocus position information on the refocus calculation or the display. In a case where the recommended parameter is included in the header information of the image file, the recommended parameter can be used as the history of refocus position information. The overall-control unit 108 in FIG. 1 executes this operation by reading a program stored in a memory such as a RAM 102, a Flash ROM 107, or the external memory 109.

In step S1010, the overall-control unit 108 determines whether a parameter selection made by the user is present or absent. In a case where the overall-control unit 108 determines that there is a parameter selection, the process proceeds to step S1050.

In step S1050, the overall-control unit 108 searches the temporary image file stored in the predetermined memory for the refocus image data matching the designated parameter. Specifically, the overall-control unit 108 tries to detect the refocus image data associated with the refocus position information including the designated parameter. In a case where the matching refocus image data is detected (i.e. the refocus image data has been already generated), the process proceeds to step S1052. In a case where no matching refocus image data is detected, the process proceeds to step S1051.

In step S1051, the overall-control unit 108 performs the refocus calculation on the basis of the parameter designated by the user and thereby generates the refocus image data with the focus on the region corresponding to the designated parameter. Moreover, the overall-control unit 108 updates the history information such as position information on the refocus target and designation frequency of the object and causes the process to proceed to step S1052.

In step S1052, the overall-control unit 108 reads, from the predetermined memory, the image data detected in step S1050 or the refocus image data generated by performing the refocus calculation in step S1051. Then, the read image data is displayed on a predetermined display and the process proceeds to step S1060.

In step S1060, the overall-control unit 108 determines whether there is any of three factors (reproduction mode termination factors) of a factor corresponding to a reproduction mode terminating operation, a factor corresponding to an operation of switching to a mode other than the reproduction mode, and a factor corresponding to completion of the refocus calculation and display of all of refocus candidates, in a refocus image reproduction device of the camera, the PC, or the like.

In a case where there is no operation corresponding to any of the three determination factors of step S1060, the overall-control unit 108 determines to continue the reproduction mode. Then, the process proceeds to step S1010 and the process described above is repeated. In a case where the overall-control unit 108 determines that there is an operation corresponding to any of the three determination factors of step S1060, the overall-control unit 108 causes the process to proceed to step S1070 and performs a reproduction mode termination process.

In a case where the overall-control unit 108 determines in step S1010 that no parameter selection has been made as described above by the user, the process to proceeds to step S1011. In step S1011, the overall-control unit 108 determines whether a period with no parameter selection has exceeded a predetermined time. In a case where the overall-control unit 108 determines that the period has exceeded the predetermined time, the process of this flow is terminated. Alternatively, in a case where the overall-control unit 108 determines in step S1011 that no parameter designation has been made within a certain time, all of functions of the system can be terminated or set to a sleep mode or the like, from the viewpoint of energy saving.

In a case where the overall-control unit 108 determines in step S1011 that the period with no parameter selection is within the predetermined time, the overall-control unit 108 causes the process to proceed to step S1020. Note that the predetermined time is a time waiting for the user to make a selection of the parameter and is also a period of predicting the image of the region which is desired by the user to be displayed next for refocus, performing refocus calculation on the predicted image, and storing the generated image data in the memory.

In step S1020, the overall-control unit 108 determines whether refocus image generation candidates (image or region) based on the prediction exist in a refocus target image. Specifically, the overall-control unit 108 determines whether there are candidates for an object from which the region to be in focus is specified on the basis of the first history information. In a case where the overall-control unit 108 determines that the candidates exist, the overall-control unit 108 causes the process to proceed to step S1030. Meanwhile, in a case where the overall-control unit 108 determines in step S1020 that no candidates exist, the overall-control unit 108 causes the process to proceed to step S1021.

In step S1021, the overall-control unit 108 selects a candidate for the object which is to be in focus and which matches the current reproduction refocus mode in the current setting of the refocus image reproduction device in the camera, the PC, or the like. Then, the refocus calculation is performed and the process proceeds to step S1053.

In step S1030, as in the description of step S910 in FIG. 9B, the overall-control unit 108 reads the first history information used in the past refocus calculation. Then, the rank of the object which is a refocus calculation target is temporarily determined in accordance with the order of frequency and the process proceeds to step S1031. The process of temporal determination can be the same as the process shown in the flow of FIGS. 4A and 4B for example.

In step S1031, the overall-control unit 108 determines whether the refocus image reproduction device is currently set to give priority to a reproduction refocus mode. Modes used in the refocus image reproduction device include a mode in which the priority is given to reproduction refocus mode and a mode in which the priority is given to the past first history information. The user may perform setting through the user I/F 106 or may leave the setting at the default. In step S1031, the overall-control unit 108 determines which one of the modes is given priority.

In a case where the overall-control unit 108 determines in step S1031 that the priority is given to the reproduction refocus mode, the overall-control unit 108 causes the process to proceed to step S1033. In a case where the overall-control unit 108 determines that the priority is not given to the reproduction refocus mode, the process proceeds to step S1032. Giving priority to reproduction refocus mode in FIGS. 10A and 10B refers to a mode in which the refocus region and the calculation ranks thereof are predicted based on the current reproduction refocus mode or the history information (second history information) of the reproduction focus mode.

In step S1032, the refocus calculation of bringing in focus the region of the object being the refocus target is performed in accordance with the refocus calculation rank temporarily determined based on the first history information in step S1030, and the refocus image data is thereby generated. Specifically, the temporal refocus calculation rank is used as the actual refocus calculation rank. Then the process proceeds to step S1053.

In step S1033, the overall-control unit 108 determines whether an image matching the current reproduction refocus mode in the refocus target region is included in the candidates or an image matching the history information (second history information) of the reproduction refocus mode is included in the candidates. In a case where any of the above images exists, the process proceeds to step S1034. In a case where neither of the images exists, the process proceeds to step S1032. In other words, in step S1033, the overall-control unit 108 determines whether the refocus target region including the object matching the reproduction refocus mode is included in the multi-viewpoint image data of the read image file.

In step S1033, the overall-control unit 108 determines whether the history information (second history information) of the reproduction refocus mode exists. Ina case where the second history information exists, the overall-control unit 108 searches for the regions including the objects matching the reproduction refocus modes, subsequently from the reproduction refocus mode ranked first in frequency. In step S1033, the overall-control unit 108 searches for the region matching the current reproduction refocus mode ranked first in frequency, subsequently from the region with the highest calculation rank which is temporary determined in step S1030. In a case where the matching region is detected, the process proceeds to step S1034.

As a matter of course, after the search for the region matching the reproduction refocus mode ranked first in frequency is completed, the overall-control unit 108 performs searching in the descending order of the frequency rank in such a way that search for the region matching the reproduction focus mode ranked second in frequency is performed next.

In a case where no matching image is detected as a result of the search, the process proceeds to step S1032. Then, as described above, the overall-control unit 108 performs the refocus calculation in accordance with the refocus calculation rank temporarily determined based on the past first history information, and causes the process to proceed step S1053.

As described above, the reproduction refocus mode includes the case of the current reproduction refocus mode set by the user and the case where the second history information on the reproduction refocus mode is used. In the latter case, the ranks corresponding to frequency are attached respectively to multiple types of reproduction focus modes. Accordingly, step S1033 can be also referred to as a process in which the regions with ranks temporarily determined by using the first history information are searched in accordance with ranks determined by using the second history information.

Meanwhile, in a case where the region matching the current reproduction refocus image is detected in Step S1033, the process of changing (raising) the refocus calculation rank of the detected region including the image matching the reproduction refocus mode is performed in step S1034.

In step S1034, the overall-control unit 108 raises the calculation rank of the region which is detected in step S1033 and which matches the reproduction refocus mode is raised by n (n is an arbitrary integer) from the calculation rank temporary determined in step S1030. The value of n may be changed depending on the reproduction refocus mode. Specifically, the following process is conceivable, although not particularly limited to this. In a case where the reproduction refocus modes are provided for a person (family), a person (acquaintance), a person (other), landscape, and animals, the overall-control unit 108 determines that the highest priority is given to family and the calculation rank thereof is automatically set to the first rank while the calculation rank of a friend is raised by two.

After the change of the refocus calculation rank of the region including the image matching the reproduction refocus mode and the refocus calculation corresponding to the changed rank in step S1034 are completed, the overall-control unit 108 causes the process to proceed to step S1053.

In step S1053, as described in Embodiment 1, the parameter (position information of the refocus image) related to the refocus images obtained in step S1034 and the refocus image file are stored in the external memory 109 and the like. Then the process returns to step S1010.

In step S1053, a similar process is performed for the refocus image data generated in each of steps 1021 and 1032 described above, and the process proceeds to step S1010.

Various settings including the reproduction refocus mode can be set (selected) through software or like in the camera main body or the PC. For example, a mechanical selecting method using a dial of the camera and a method of selecting the setting from a display menu on a touch panel of the camera or the PC are conceivable.

Like the first history information (past frequency information) described in Embodiment 1, the second history information (for example, the frequency information on the person mode and the landscape mode) on the reproduction refocus mode is updated (accumulated) for each mode and the stored contents of the history information storage unit 107 is also updated.

Configuring the image processing apparatus as described above allows the image processing apparatus to predict the order of generation of the refocus images which is to be designated by the user and to start the refocus calculation before the user designates the refocus region.

The embodiment is intended to further improve the prediction accuracy of taste of the user and region selection by adding the current reproduction refocus mode or the second history information to the first history information of Embodiment 1. Moreover, the refocus calculation of the predicted regions is performed by utilizing the period in which the user is not performing the parameter selection and the images obtained from the calculation are stored in the external memory 109 or the like. This is expected to reduce the time required for the display of refocus image from the time point of the parameter designation.

The refocus image data generated through the prediction and the refocus calculation described above is stored in the external memory 109 or a storage device on a network, in a format in which the position information of the image is added as a header (see FIG. 7, for example).

In the flowchart of FIGS. 10A and 10B, although not stated, in the actual refocus production device, it is ideal to stop the process at the point where the parameter is designated and cause the process to compulsorily proceed to step S1051.

### Embodiment 3

In Embodiments 1 and 2, there are shown examples of a case where attention is given to a target to be in focus (hereafter, referred to as focus target) in the generation of the refocus image. However, in some cases, a user can express his/her intention better if the attention is given to a target to be out of focus (hereafter referred to as non-focus target) in the generation of the refocus image.

In a currently-available image processing apparatus, in a case where a piece of refocus image data is generated at the time of image display, there no method of easily designating a portion desired to be set to a non-focus state. For example, the technique of Japanese Patent Laid-Open No. 2011-22796 described above is a technique of bringing multiple objects in focus by deep focus in a case where there are multiple objects. However, in a case where a specific object among the multiple objects in focus is desired to be brought out of focus, it is impossible to appropriately designate and set the certain object to the non-focus state. Accordingly, the conventional technique also has a problem that an image with a specific object set to the non-focus state cannot be easily generated and displayed.

In Embodiment 3, there are shown an example of generating an image with a specific object out of focus on the basis of designation of a portion desired to be set to a non-focus state and an example of a method of easily designating the portion desired to be set to the non-focus state.

### [Overall Hardware Configuration of Image Processing Apparatus]

A hardware configuration of the image processing apparatus of Embodiment 3 is described in detail by using FIGS. 1, 11, 12, 13, and the like. Since FIG. 1 is also used in Embodiment 1, the detailed description thereof is omitted.

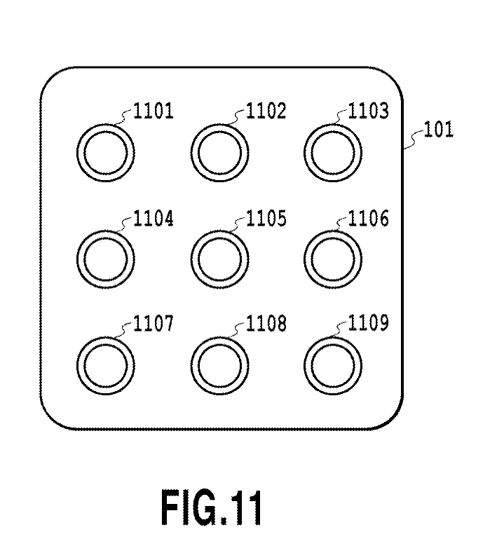

FIG. 11 is a view showing an exterior of the image capturing camera array unit 101.

As shown in FIG. 11, multiple image capturing units 1101 to 1109 are arranged in a front face of the image capturing camera array unit 101. Here, the image capturing units 1101 to 1109 are evenly arranged in square lattice. The image capturing units are the same in the extending directions of the up-down axis, the right-left axis, and the optical axis.

In response to an image capturing instruction from the user, each of the image capturing units 1101 to 1109 extracts an analog signal from an image capturing element, the analog signal corresponding to optical information of an object focused on an image capturing device through an image capturing lens and an aperture. Then, the image capturing units 1101 to 1109 perform analog-digital conversion of the analog signal, and output a set of image data pieces subjected to image processing such as demosaicing as multi-viewpoint image data.

An image data group in which the same object is captured from multiple viewpoints can be obtained by the image capturing camera array unit 101 described above. Although an example in which nine image capturing units are provided is shown in the embodiment, the embodiment can be applied as long as there are multiple image capturing units and an arbitrary number of image capturing units may be provided. Moreover, the image capturing units are not required to be evenly arranged in square lattice, and may be arranged in any pattern. For example, the image capturing units may be arranged radially or linearly or may be arranged in a completely random pattern.

### [Image Data Format of Multi-Viewpoint Image Data]

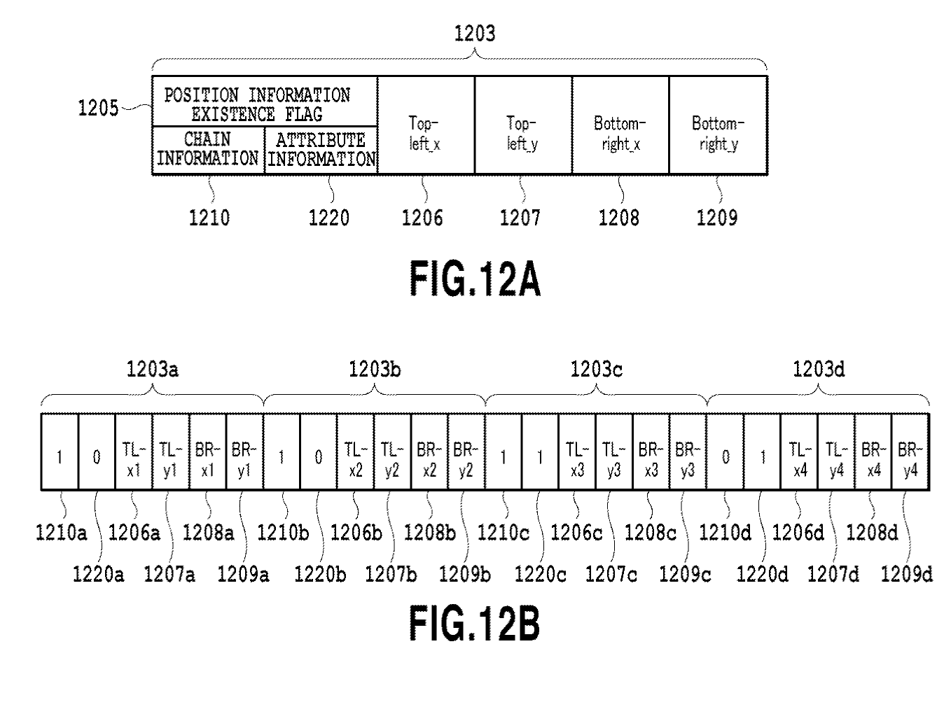

In FIG. 8 of Embodiment 1, description is given mainly of an example in which the position information existence flag 805 is information of one bit indicating whether the refocus position information exists in the image file. In Embodiment 3, the position information existence flag 805 may be multi-bit information indicating whether a region at a position specified by the refocus position information is the focus target or the non-focus target. For example, the refocus position information may have a configuration shown in FIG. 12A. Refocus position information 1203 of FIG. 12A corresponds to the refocus position information 803 of FIG. 8. In FIG. 12A, a position information existence flag 1205 is formed of flags including two fields of chain information 1210 and attribute information 1220. The chain information 1210 indicates whether the refocus position information subsequent to the flag of the chain information 1210 is valid, and also indicates whether a group of serial refocus position information from 1210 to 1209 shown in FIG. 12A is repeated continuously. For example, in a case where the chain information 1210 is 1, the attribute information 1220 and position information 1206 to 1209 which are series of information subsequent to the chain information 1210 are valid information. Moreover, this indicates that another group of serial refocus position information exists subsequent to this group of serial refocus position information. The attribute information 1220 indicates the attribute of the position information shown as field information of position information 1206 to 1209 subsequent to the attribute information 1220. For example, in a case where the attribute information 1220 is 0, the field information of the position information 1206 to 1209 subsequent to the attribute information 1220 is treated as information indicating a position to be in focus (focus position). Meanwhile, in a case where the attribute information 1220 is 1, the field information of the position information 1206 to 1209 subsequent to the attribute information 1220 is treated as information indicating a position where a target to be out of focus and blurred exists (non-focus position). In other words, the attribute information 1220 is focus state data indicating the state of focus.

FIG. 12B shows a specific example of a case where a multi-bit flag is used for the position information existence flag 1205. FIG. 12B shows a case where four fields for refocus position information shown in FIG. 12A exist at positions in the refocus position information 803 of FIG. 8, and these fields are extracted. Since each of the chain information 1210a to 1210c is 1, the focus position information in each of 1203a, 1203b, and 1203c are valid information. Meanwhile, since the chain information 1210d is 0, the refocus position information of 1203d is invalid information. This indicates that the field of the refocus position information is terminated at 1203d and the multi-viewpoint image header information 810 shown in FIG. 8 is provided subsequent to the refocus position information 1203d. Moreover, the attribute information 1220a and 1220b is 0. This means that the position information 1203a and 1203b each have the position information on the focus point. In this case, targets to be in focus exist in two separate positions. Meanwhile, the attribute information 1220c is 1. This means that the refocus position information 1203c includes the position information on the non-focus point which is a position of a target to be blurred. In other words, the example of FIG. 12B which includes the multi-bit flags is an example including three pieces of valid position information indicating existence of two focus points and one non-focus point.

### [Configuration Example of Refocus Calculation Unit 103 and Flow of Process]

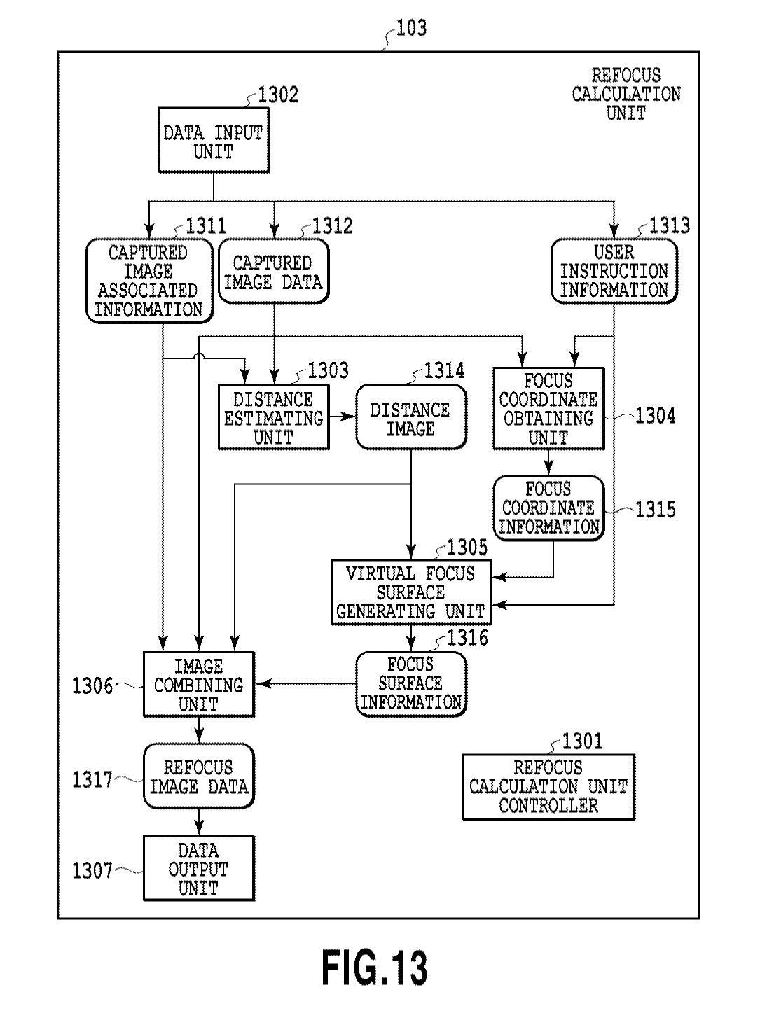

An example of a functional configuration of the refocus calculation unit 103 and a flow of a process are described by using a block diagram of FIG. 13. In FIG. 13, rectangular frames represent processing modules and rectangles with rounded corners represent data buffers formed of an internal SRAM and the like.

In the embodiment, it is assumed that the data buffers are provided inside the refocus calculation unit. However, in some cases, the RAM 102 or the like can be used as the data buffers via data input/output units. Moreover, in the embodiment, it is assumed that the processing modules inside the refocus calculation unit 103 execute processes on the basis of instructions from a refocus calculation unit controller 1301. Note that control signals expressing the instructions from the refocus calculation unit controller 1301 are not illustrated. However, the entire process described below can be implemented by using one or multiple CPUs to execute an image processing program.

A data input unit 1302 receives an instruction from the refocus calculation unit controller 1301 and receives an input of captured image data and captured image associated information from the RAM 102 or an external memory 109, the captured image associated information including information on a device used to capture the captured image data (for example, the image capturing camera array unit 101) and captured image information. Here, for example, the multi-viewpoint image header information 810 in FIG. 8 corresponds to the captured image information. Moreover, the multi-viewpoint image data 804 of FIG. 8 corresponds to the captured image data. Among the inputted data, the captured image associated information is stored in a buffer 1311 and the captured image data is stored in a buffer 1312. In this case, the captured image data includes multiple pieces of image data captured by multiple image capturing units (for example, the image capturing units 1101 to 1109 of the image capturing camera array unit 101).

The captured image associated information stored in the buffer 1311 includes image capturing positions (relationship of relative positions) of the respective image capturing units and the like, in addition to the captured image information of the independent image capturing units as described above.

Furthermore, the data input unit 1302 also inputs user instruction information as necessary. The user instruction information includes contents of an instruction which the user desires to particularly give in a case of generating the refocus image, such as information on the focus target desired to be in focus and the non-focus target desired to be out of focus. For example, the refocus position information 1203 in FIG. 12A corresponds to the user instruction information.

After the obtaining of data required for the process is completed, a focus coordinate obtaining unit 1304 receives an input of a piece of reference image data from the buffer 1312 in accordance with the control of the refocus calculation unit controller 1301. The focus coordinate obtaining unit 1304 outputs focus coordinate information indicating a position or the like to be in focus in a displayed picture in accordance with the user instruction information stored in a buffer 1313. The focus coordinate information is stored in a buffer 1315.

The reference image data is one of the multiple pieces of image data included in the captured image data stored in the buffer 1312, and may be any one of the multiple pieces of image data. In the embodiment, the reference image data is the image data captured by the image capturing unit 1105 at the center out of the image capturing units 1101 to 1109 of the image capturing camera array unit 101.

Next, the refocus calculation unit controller 1301 performs control in such a way that a distance estimating unit 1303 receives an input of the multiple pieces of image data from the buffer 1312. Moreover, the distance estimating unit 1303 receives an input of the captured image associated information from the buffer 1311. Then, the distance estimating unit 1303 estimates the depth value of the captured image scene by performing stereo matching based on the multiple pieces of image data and the captured image associated information, and thereby generates distance image data. The generated distance image data is stored in a buffer 1314.

After the generation of the focus coordinate information and the distance image data is completed, the refocus calculation unit controller 1301 performs control in such a way that a virtual focus surface generating unit 1305 receives the focus coordinate information, the distance image data, and the user instruction information and generates focus surface information.

The focus surface information is information for grasping the positions of the camera and the object to be in focus in a three-dimensional space at the time of image capturing, and includes information on the distance between the camera and the focus surface, the shape of the focus surface, the depth of field, and the like. The focus surface information is stored in a buffer 1316.

Lastly, the refocus calculation unit controller 1301 performs control in such a way that an image combining unit 1306 reads the multiple pieces of image data, the captured image associated information, the distance image data, and the focus surface information from the buffers 1312, 1311, 1314, and 1316, respectively. Then the image combining unit 1306 generates a piece of refocus image data.

The refocus image data is temporally stored in a buffer 1317 and is then outputted from the refocus calculation unit 103 via a data output unit to be stored in the RAM 102 or the external memory 109. Moreover, the refocus image data is displayed on the display 105 via the graphic processor 104 in some cases.

### [Flow of Process Performed in Case Where Non-focus Target is Designated]

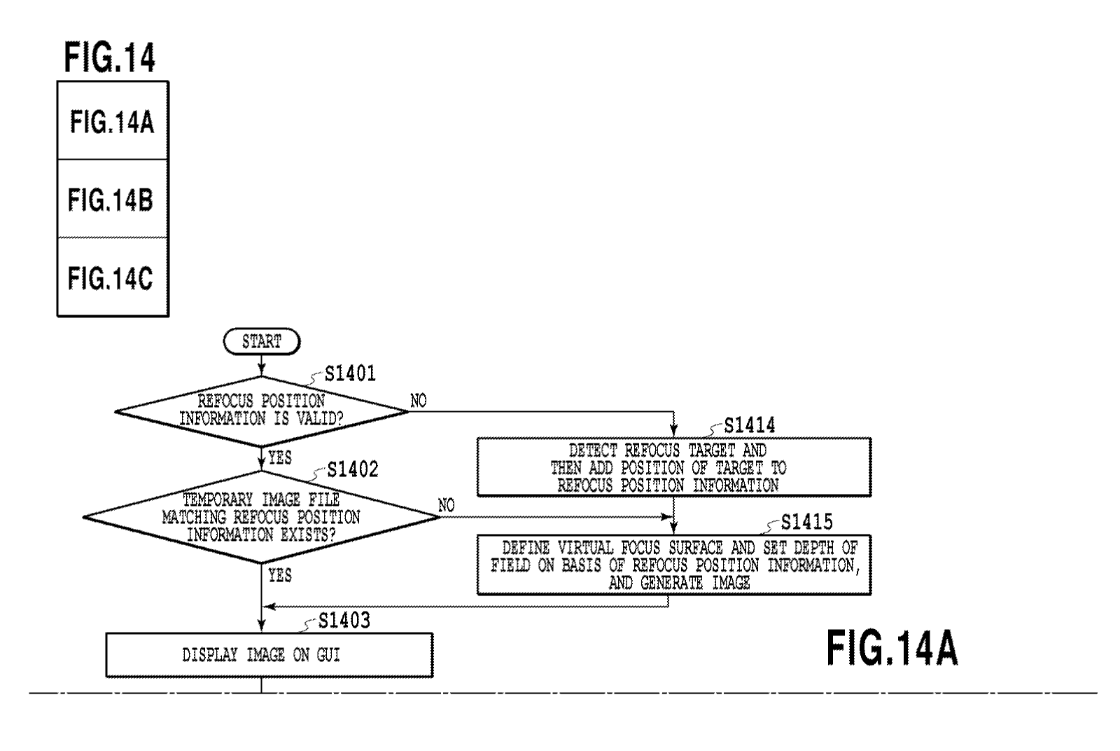

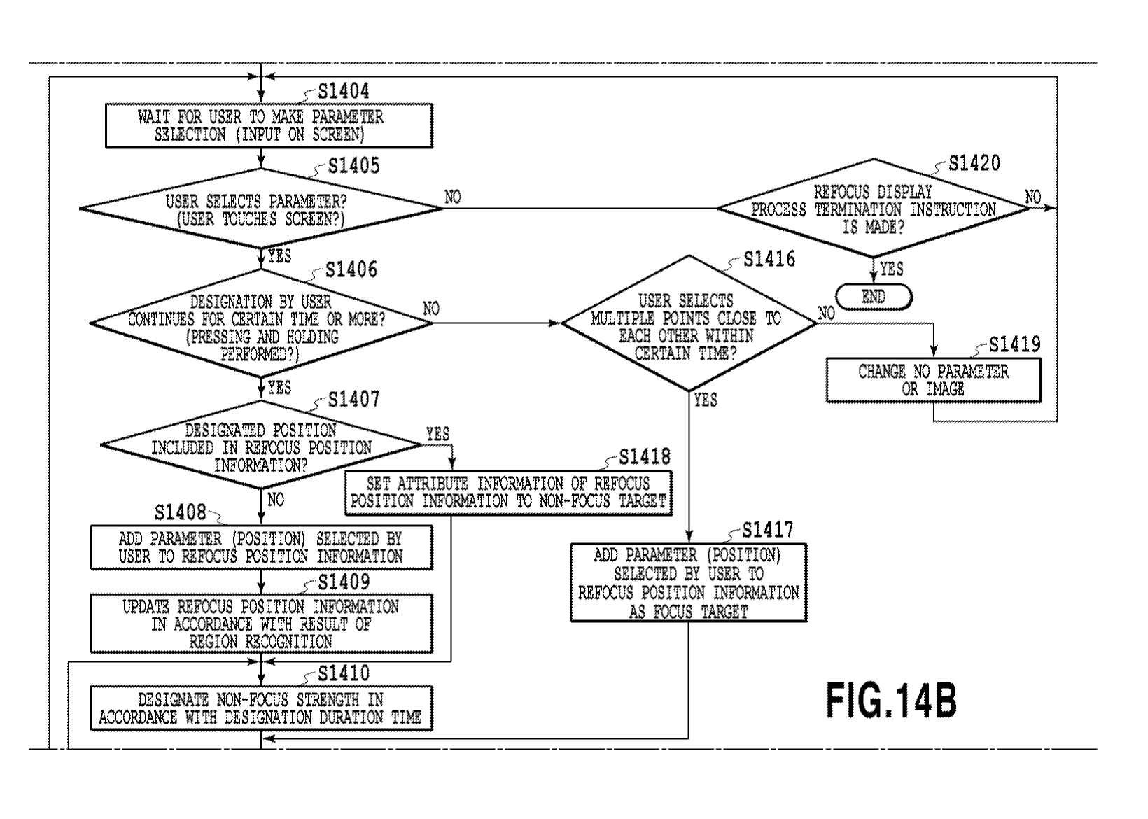

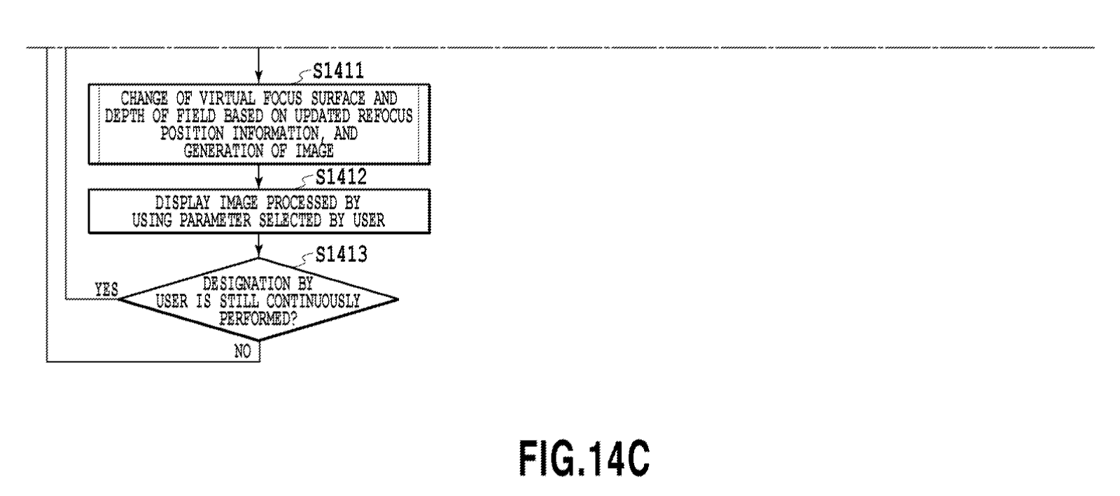

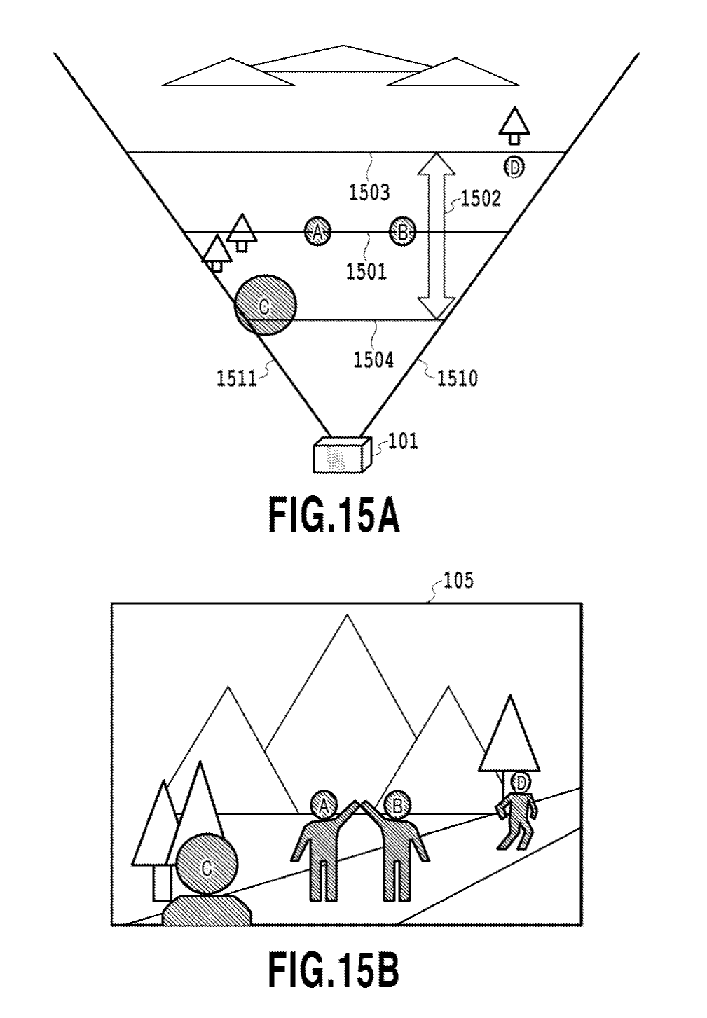

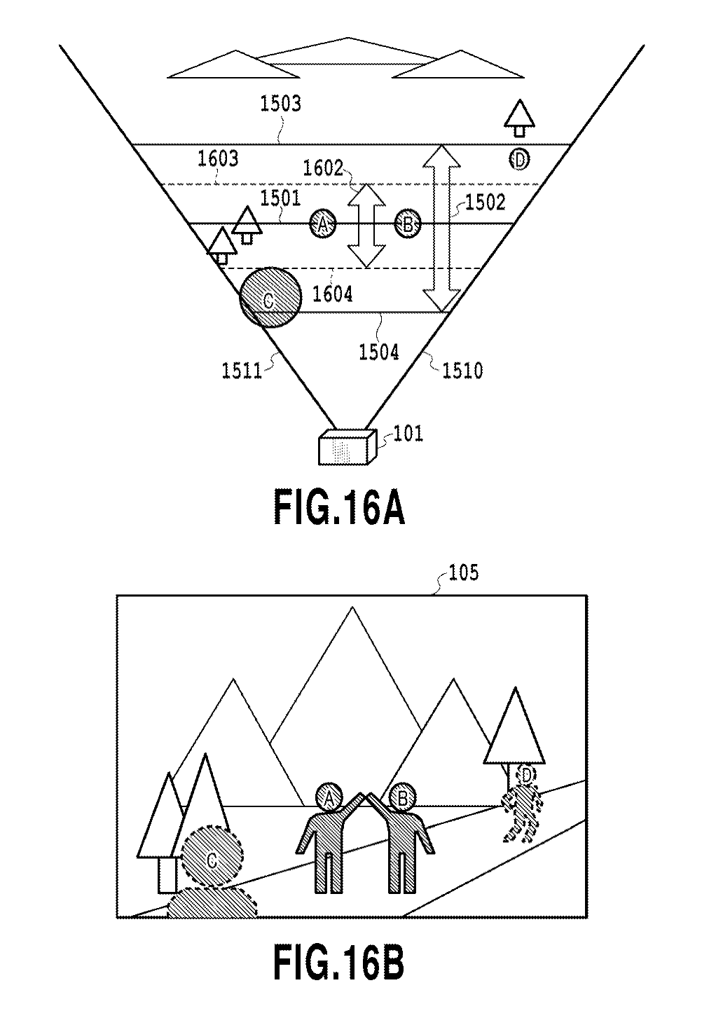

A flow of a process performed in a case where the non-focus target is designated is described by using FIGS. 1, 12A, 12B, 13, and the flowchart of FIGS. 14A to 14C, as well as FIGS. 15A, 15B, 16A, and 16B. The flowchart of FIGS. 14A to 14C shows kinds of processes which the modules such as the refocus calculation unit 103 are made to perform by the instruction of the overall-control unit 108 in response to an input of the user instruction information.

FIGS. 15A, 15B, 16A, and 16B illustrate the position relationship among an image capturing apparatus and the objects in the captured image in a case where an image of a target to be objected to image processing is captured, how the captured image is displayed on the display 105, and instructions made on a touch panel provided on the display 105.

FIG. 15A shows a top-down view illustrating the position relationship among the image capturing camera array unit 101 and the objects in the captured image in a case where an image shown in FIG. 15B is captured. The angle of view of the image capturing camera array unit 101 is shown by two lines 1510 and 1511 extending obliquely from the image capturing camera array unit 101. An image of people A, B, C, and D which are objects within the angle of view is captured together with mountains and trees. Moreover, FIG. 15B is an initial image displayed on the display 105 in a case where this image is captured.

Here, a process performed up to the point where the image of FIG. 15B is displayed is described by using steps S1401 to S1403 and steps S1414 to S1415 of FIG. 14A.

In step S1401 of FIG. 14A, in a case where display of image is instructed, the overall-control unit 108 determines whether the refocus position information 1203 of the stored multi-viewpoint image data is valid. In a case where the overall-control unit 108 determines that the refocus position information is valid, the process proceeds to step S1402. In step S1402, the overall-control unit 108 determines whether the temporary image file matching the refocus position information exists. Ina case where the overall-control unit 108 determines that the temporary image file exists, the process proceeds to step S1403. In step S1403, the overall-control unit 108 reads the image of the temporary image file from the external memory 109 or the like and sends the image to the graphic processor 104. The image is then displayed on a GUI screen of the display 105.

In a case where the overall-control unit 108 determines in step S1402 that no temporary image file exists, the process proceeds to step S1415. In step S1415, the overall-control unit 108 performs control in such a way that the refocus calculation unit 103 generates the image data with the virtual focus surface and the depth of field set based on the refocus position information. Next, in step S1403, the overall-control unit 108 displays an image expressed by the image data generated in step S1415.

Meanwhile, in a case where the overall-control unit 108 determines in step S1401 that the refocus position information is invalid, the process proceeds to step S1414. In step S1414, the overall-control unit 108 first detects a target to be refocused as described in FIGS. 4A and 4B of Embodiment 1 and adds a position including the target to the refocus position information. Next, the overall-control unit 108 generates an image in step S1415 and displays the image in step S1403.

Note that, in a case where the overall-control unit 108 determines in step S1401 that the refocus position information is invalid, the overall-control unit 108 may not perform the process shown in FIGS. 4A and 4B of Embodiment 1 and instead may simply perform a process of displaying an image expressed by the reference image data. In this case, in the example described below, the image expressed by the reference image data is assumed to be the image of FIG. 15B.

Description continues of the case where the image on the GUI displayed in step S1403 is the image of FIG. 15B. Here, objects shown by bold lines in FIG. 15B are the focus targets. In this case, the people A, B, C, and D as well as the trees behind the person C are displayed as the focus targets. This is because the people A, B, C, and D are designated as the focus targets in the refocus position information of the multi-viewpoint image data. In the embodiment, as shown in FIG. 15A, the virtual focus surface is set at the position on a line segment 1501 passing through the people A and B. Furthermore, the depth of field is set to have a range shown by an arrow 1502 so that the people C and D can be included in the focus range. Then, the display image is generated based on the virtual focus surface and the depth of field. As a result, an image with the focus on objects between a line segment 1503 on the farther side from the image capturing camera array unit 101 and a line segment 1504 on the closer side is displayed on the display 105. Here, since the trees behind the person C are also included in the range of the depth of field 1502, an image with the focus on the trees is displayed. Although the line segments 1501, 1503, and 1504 are shown as straight lines, these line segments each actually have a gentle arc shape corresponding to the distance from the image capturing camera array unit 101. However, in the embodiment, the expression form of straight lines is used to simplify the expression.

Next, description is given of a method of generating the image data in which a specific object is brought out of focus based on designation of a portion desired to be set to the non-focus state, and of a method of easily designating the portion desired to be set to the non-focus state, by using steps S1404 and steps subsequent thereto in FIGS. 14A to 14C.

After the image is displayed on the display 105 in step S1403, the overall-control unit 108 waits for the user to make parameter selection in step S1404. In the embodiment, the touch panel provided on the display 105 is used as the user I/F 106. Next, in step S1405, the overall-control unit 108 determines whether the user selects a parameter (in this case, a position at which the change of the state of focus and non-focus is intended) by touching a point on the screen with his/her finger. In a case where the overall-control unit 108 determines in step S1405 that user selects a parameter, the process proceeds to step S1406. In step S1406, the overall-control unit 108 determines whether the following action is made as the selection action of step S1405. A specific point on the screen is continuously pressed for a certain time or more (pressed and held) to select a parameter. In other words, the overall-control unit 108 determines whether the user gives an instruction on a region on the image for the certain time or more. In the embodiment, it is assumed that the action of pressing and holding corresponds to an instruction of setting the selected point to the non-focus state. For example, in the embodiment, pressing of three seconds or more is determined as the pressing and holding. This standard of time is an example and the time can be changed as need. In a case where the overall-control unit 108 determines in step S1406 that the pressing and holding has been performed, the process proceeds to step S1407. In step S1407, the overall-control unit 108 determines whether the position designated by the pressing and holding is included in the refocus position information 1203 of the displayed multi-viewpoint image data. Determination of whether the position designated by the pressing and holding is included is made by determining whether the designated position is included inside a rectangle expressed by the position information 1206 to 1209 of the valid refocus position information.

In step S1407, in a case where the overall-control unit 108 determines that the position designated by the pressing and holding is not included in the refocus position information, the process proceeds to step S1408. In step S1408, the overall-control unit 108 generates an entry for the refocus position information which is used to newly express a region centered on the position selected by the user in step S1405. At this time, a newly-generated field for the attribute information 1220 is set to 1 which means non-focus instruction.

Next, in step S1409, the overall-control unit 108 performs region recognition for determining a range of non-focus which includes the position designated by the user. The region recognition is performed in the image analyzing unit 112 as described Embodiment 1. Based on the result of the region recognition, the range to be set to the non-focus state is set to the position information 1206 to 1209 of the newly-generated refocus position information.

In a case where the overall-control unit 108 determines in step S1407 that the position designated by the pressing and holding is included inside the rectangle expressed by the position information 1206 to 1209 of the valid refocus position information, the process proceeds to step S1418. In step S1418, the overall-control unit 108 sets the field of the attribute information 1220 of the refocus position information to 1 which means non-focus instruction, if necessary.

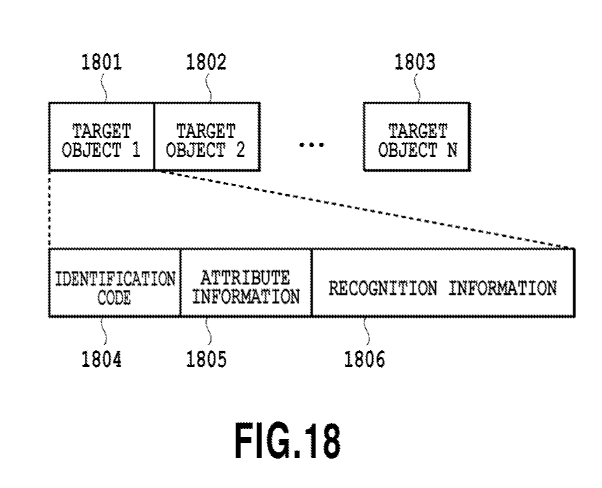

Here, an example is shown in which the information on focus and non-focus and the information on the refocus position are stored as unit of the image data format used to store the multi-viewpoint image. Meanwhile, at the same timing, the information on focus and non-focus and information such as image information cut out from the image on the basis of the information indicating the refocus position can be combined and then stored and used as a list independent from the individual multi-viewpoint image data. For example, it is conceivable to generate and store a list in a format shown in FIG. 18. The details and utilization of this list are described later in Embodiment 4.

Next, in step S1410, the overall-control unit 108 adds information designating non-focus strength to the multi-viewpoint image header information 810 of the displayed multi-viewpoint image data, depending on the length of time of the pressing and holding. Although the contents of the field of the multi-viewpoint image header information 810 is not described in detail, the information of designating the non-focus strength is stored in such a way that the position of the field indicating non-focus in the refocus position information and the strength of blur are paired. The strength of blur is set to become stronger as the time of pressing and holding becomes longer. However, in a case where the strength of blur is set to its maximum value, the strength does not change from the maximum value even if the pressing and holding is performed for a longer time.

Next, in step S1411, the refocus calculation unit 103 changes the virtual focus surface and the depth of field on the basis of the updated refocus position information, and then generates the image data on the basis of the changed virtual focus surface and the changed depth of field. In step S1412, the overall-control unit 108 displays the image generated in step S1411. An example of how the virtual focus surface and the depth of field are changed to achieve non-focus is described by using FIGS. 15A, 15B, 16A, 16B, 17A, and 17B.

Assume that, in FIG. 15B, the person C is selected as the target of non-focus and the user continuously presses and holds a position on the display 105 where a letter of C is drawn for three seconds or longer with his/her finger. The overall-control unit 108 monitors this state and sends data including the new refocus position information to the refocus calculation unit 103. The refocus calculation unit 103 determines the virtual focus surface and the depth of field on the basis of the flow of FIGS. 14A to 14C described above. The person D can be also designated as the target of non-focus in a similar way.

For example, consider a case where a request is made to generate an image in which the people C and D are excluded from the focus targets and only the people A and B are in focus. In the embodiment, the people A and B are on the virtual focus surface 1501 of the image displayed in FIG. 15B, and the people C and D are at positions slightly away from the virtual focus surface. In such a case, the people C and D can be excluded from the focus targets, without changing the virtual focus surface, by performing such adjustment that the depth of field becomes shallower. In this case, setting is performed in the following way in the embodiment. As shown in FIG. 16A, the virtual focus surface is not moved from the position on the line segment 1501 passing through the people A and B, and the depth of field is set to have a range shown by an arrow 1602 so that the people C and D can be excluded from the range of the depth of field. Then, the display image is generated based on the thus-set virtual focus surface and depth of field. In other words, an image (FIG. 16B) with the focus on objects located between a dotted line 1603 and a dotted line 1604 is generated and displayed on the display 105 in step S1412. In FIG. 16B, the fact that the people C and D are set to the non-focus state is indicated by bold dotted lines.

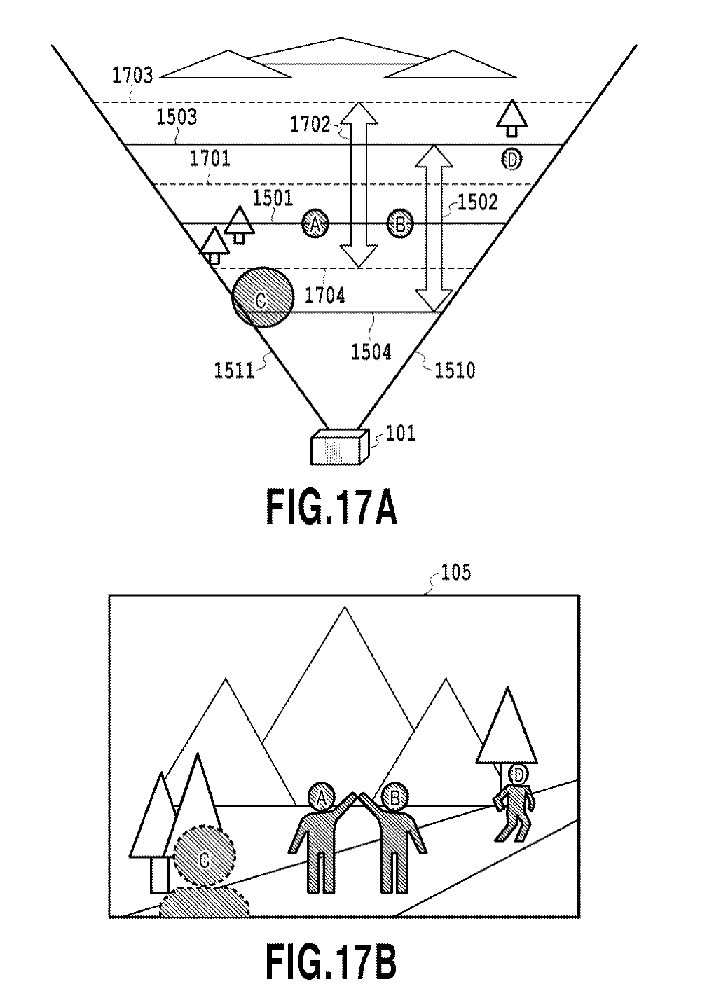

Moreover, the following case is also conceivable. A request is made to generate an image in which not both of the people C and D but only the people C is excluded from the focus target and the people A, B, and D are in focus. In this case, since the people C is at a position close to the image capturing camera array unit 101 than the people A, B, and D to be in focus, such an image can be generated by moving the focus surface rearward. Such a case is described by using FIGS. 17A and 17B. In this example, as shown in FIG. 17A, the virtual focus surface is provided at a position on a dotted line 1701 located behind the line segment 1501 passing through the people A and B. Furthermore, the depth of field is set to a range shown by an arrow 1702 so that the people C can be excluded from the range of the depth of field. The display image is generated based on the thus-set virtual focus surface and depth of field. In other words, the image of FIG. 17B with the focus on objects located between a dotted line 1703 and a dotted line 1704 is generated and displayed on the display 105 in step S1412.

In FIG. 17B, the fact that the person C is set to the non-focus state is indicated by bold dotted lines. In the example, the tree behind the person D is newly included in the focus target. However, in the embodiment, since no particular limitation is provided for the focus states of objects other than people, this does not become a problem.

Next, returning to FIGS. 14B and 14C, the description of the flowchart is continued.

After the image on the display 105 is updated in step S1412, the overall-control unit 108 determines whether the designation by the user is still continuously performed in step S1413. The fact that the designation by the user is still continuously performed means that the pressing and holding is still continuously performed. In a case where the overall-control unit 108 determines in step S1412 that the pressing and holding is still continuously performed, the process returns to S1410. The overall-control unit 108 then changes the non-focus strength depending on the duration time of the designation action, and regenerates the image as necessary. In a case where the overall-control unit 108 determines in step S1413 that the pressing and holding is no longer performed, the process returns to step S1404 and the overall-control unit 108 waits for the user to make the parameter selection. In a case where the overall-control unit 108 determines in subsequent step S1405 that the user selects no parameter, the process proceeds to step S1420. In step S1420, the overall-control unit 108 determines whether there is an instruction to terminate the display process for refocus. In a case where the overall-control unit 108 determines in step S1420 that there no instruction to terminate the display process for refocus, the process returns to step S1404 and the overall-control unit 108 waits for the user to make the parameter selection.

In a case where the overall-control unit 108 determines in step S1420 that the instruction to terminate the refocus display is made, the overall-control unit 108 terminates the display operation and terminates the series of operations. This instruction to terminate the refocus display can be given by the user explicitly selecting a user I/F such as a button such, or by an instruction based on time out which is a case where no instruction is given by the user for a certain time.

In a case where an instruction is given by the user on the touch panel but is not the pressing and holding in step S1406, the overall-control unit 108 causes the process to proceed to step S1416. In step S1416, the overall-control unit 108 determines whether the user selects multiple points close to each other within a certain time. In the embodiment, in a case where the user selects the multiple points located within a certain distance (for example, a distance of 5 mm on the touch panel), within the certain time (for example, two seconds), this selection is considered as an instruction to add the selected position to the target to be in focus. In a case where the overall-control unit 108 determines in step S1416 that the selection is made multiple times within the certain time, the overall-control unit 108 adds the positions selected by the user to the refocus position information as the focus target in step S1417. The contents of step S1417 is substantially the same as the contents of steps S1407 to S1409. The main difference is that the value in the field of the attribute information 1220 is set to 0 which means focus instruction. In a case where the overall-control unit 108 determines in step S1416 that the selection is not made multiple times within the certain time, neither the parameter nor the image is changed as shown in step S1419 and the overall-control unit 108 causes the process to proceed to step S1404.

In the embodiment, the method of pressing and holding a point on the display image by using the touch panel is used as the method by which the user designates a target to be out of focus. However, the designation can be made by other methods. For example, the following method may be used. A button used for non-focus setting is provided in advance on the screen of the touch panel and a point designated on the screen after touching this button is recognized as the point to be set to the non-focus state. Alternatively, the following method may be used. A menu is displayed upon designation of an object on the screen of the touch panel and an instruction of focus/non-focus is given by using this menu.

Moreover, in a case of using no touch panel, the instructions can be given by a mouse or the like. For example, it is conceivable to give an instruction by associating a right click with the non-focus instruction by using an application. In this case, an instruction of pressing and holding of a right button and an instruction of multiple right clicks may be given certain meanings.

The configuration described above makes it possible to easily designate a target to be out of focus in a system capable of displaying an image in which the position to be in focus is changed in accordance with the taste of the user after image capturing. Moreover, an image in which a specific object is out focus can be generated based on the designation of a target to be out of focus.

Accordingly, it is possible to cancel the focus state not intended by the user and to select and set only the specific object to the non-focus state. As a result, an image with the focus on only the target desired to be in focus by the user can be easily generated and displayed.

### Embodiment 4

Embodiment 3 shows a method of designating the target to be in focus and the target to be out of focus and generating the refocus image on the basis of the designation. For example, if the refocus images with the focus on a certain person can be generated in one operation by storing and managing the target to be in focus and the target to be out of focus in Embodiment 3 separately from individual pieces of image data, the operation load of a user can be reduced. This is because, in a current image processing apparatus, the user is required to perform operation for each image in a case where images captured from multiple viewpoints are combined and the focus surface is generated. This is cumbersome for the user in some cases. In the embodiment, description is given of an example of a method of storing and managing the target to be in focus and the target to be out of focus. Hereafter, the target to be in focus is referred to as focus target and focus to be out of focus is referred to as non-focus target.

An example of a hardware configuration in Embodiment 4 is shown in FIGS. 1, 11, and 13. Since FIGS. 1, 11, and 13 are also used in Embodiments 1 and 3, detailed description thereof is omitted.

### [Data Format and Data Structure]

A data format used to store and manage the focus target and the non-focus target is described in detail by using FIG. 18. As briefly described in Embodiment 3, FIG. 18 shows a data format of a list form which is independent from individual pieces of multi-viewpoint image data. Moreover, in regard to data of the focus target or the non-focus target, data on each target object is stored in a list form as shown in 1801 to 1803. This list is hereafter referred to as focus and non-focus target list or simply list. Note that the data format is not limited to the list form as long as an arbitrary stored target object is accessible.

The data on each target object in the list includes an identification code 1804, attribute information 1805, and recognition information 1806. The identification code 1804 is information for identifying the target object and is, for example, multi-bit information indicating a people, an animal, a tree, or the like. Moreover, the identification code 1804 may be identification information for categorizing people into more detailed categories such as the user himself/herself, the wife, the oldest daughter, the oldest son, and the like. The identification code can be referred to as identification data for identifying the target object. The attribute information 1805 is one-bit information indicating whether the target object is the focus target or the non-focus target. Although one bit is sufficient to indicate whether the target object is the focus target or the non-focus target, the number of bits of the attribute information is not limited to this. The recognition information 1806 is information indicating characteristics of the focus or non-focus target. For example, in a case where the target object is a person, the information include the distance between characteristics points such as eyebrows and eyes, the area of a region surrounded by the characteristic points, the luminance of pixels in the region, and the like. The recognition information 1806 is obtained through analysis made by the image analyzing unit 112. The object in the image is identified to be the focus target or the non-focus target on the basis of the recognition information 1806. The recognition information can be also referred to as the identification data for identifying the target object.

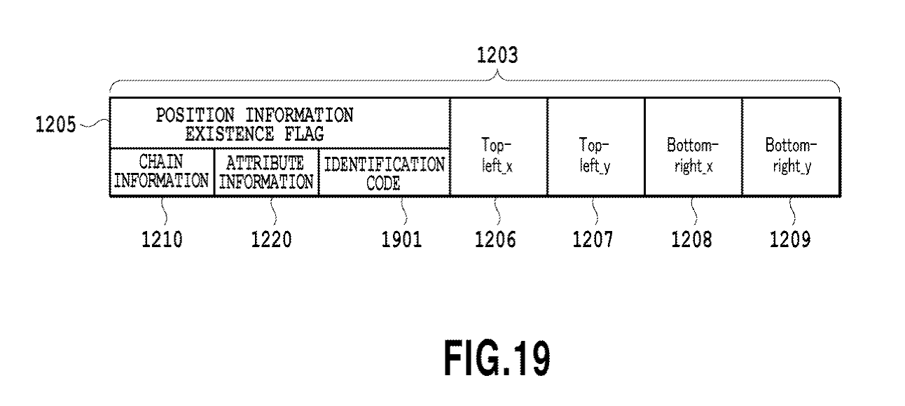

Next, a field of the refocus position information 1203 included in a data format of the image in the embodiment is described in detail by using FIG. 19. In Embodiment 3, description is given of an example of information in which the position information existence flag 1205 is formed of the chain information 1210 and the attribute information 1220. In the embodiment, the position information existence flag 1205 is configured to additionally include an identification code 1901. Here, the identification code 1901 is the same as the identification code 1804 of FIG. 18. The other constituent elements are the same those of Embodiment 3 and description thereof is thereby omitted. The field of the refocus position information 1203 shown in FIG. 19 can include multi-bit information as described in Embodiment 3. Specifically, the field of the refocus position information 1203 has such a form that multiple pieces of position information on the focus target or the non-focus target can be added to or deleted from the field.

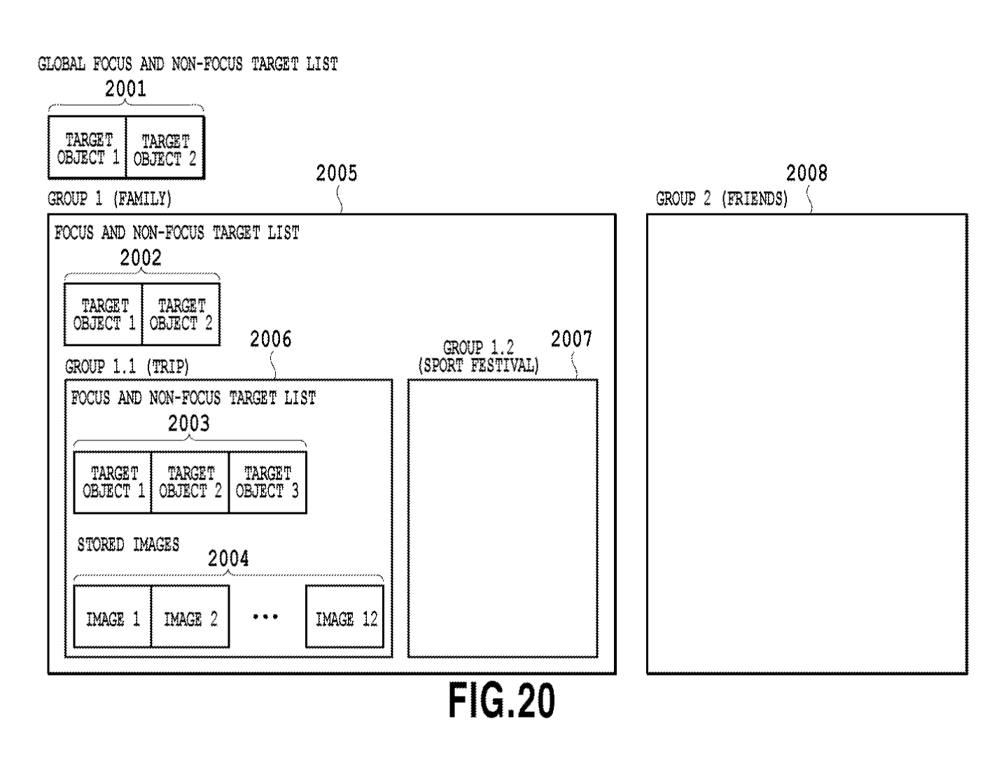

An example of a data structure for managing the focus and non-focus target list and stored images is described in detail by using FIG. 20. The stored images are image data stored in the external memory 109 or the like and are image data specified by the image data format of FIG. 8 including the refocus position information shown in FIG. 19. The focus and non-focus target lists and the pieces of image data shown in FIGS. 18 and 19 are categorized into groups layered in hierarchy as shown in FIG. 20 and are managed. The focus and non-focus target list may also be referred to as target object defining information. A refocus position information attaching process performed on each piece of image data based on a corresponding one of the focus and non-focus target lists to be described later is applied to the piece of image data in a group including the corresponding focus and non-focus target list and to the pieces of image data in a group included in the group including the corresponding list. The details of the refocus position information attaching process are described later.

In FIG. 20, a group 1 (family) 2005 is a group including a group 1.1 (trip) 2006 and a group 1.2 (sport festival) 2007. The refocus position information attaching process based on a focus and non-focus target list 2002 in the group 1 (family) 2005 is applied to the following stored images. Specifically, the process is applied to stored images 2004 in the group 1.1 (trip) and to stored images which are not illustrated and which are included in the group 1.2 (sport festival) 2007 and groups therein. Meanwhile, the refocus position information attaching process based on a focus and non-focus target list 2003 in the group 1.1 (trip) is applied only to the stored images 2004 in the group 1.1 (trip). A global focus and non-focus target list 2001 is a focus and non-focus target list used to attach the refocus position information to all of the stored images, irrespective of groups to which the images belong. Including the focus and non-focus target list and the stored images in each of the groups having such a hierarchal structure improves convenience of the user. For example, in the focus and non-focus target list of the group 1 (family) 2005, family members are set as targets to be in focus. Meanwhile, in the focus and non-focus target list of the group 1.1 (trip) 2006, accompanying members in a package tour are set as target objects to be out of focus, for example. Such setting allows generation of image data in which the family members are in focus but the accompanying members in the tour are not in focus, for the stored images in the group 1.1.

Although the data structure described above is used in the embodiment, the data structure is not limited to this and the embodiment can be carried in other data structures.

### [Process Flow for Updating Focus and Non-Focus Target List and for Updating Refocus Position Information]

A process flow for updating the focus and non-focus target list and for attaching the refocus position information is described in detail by using FIGS. 18, 19, and FIGS. 21A to 25B. The description below are given in three parts of a process performed in a case where the focus and non-focus target list is updated, a process performed in a case where a new image is captured, and a process performed in a case where the refocus position information is updated at an arbitrary timing on the basis of the focus and non-focus target list.

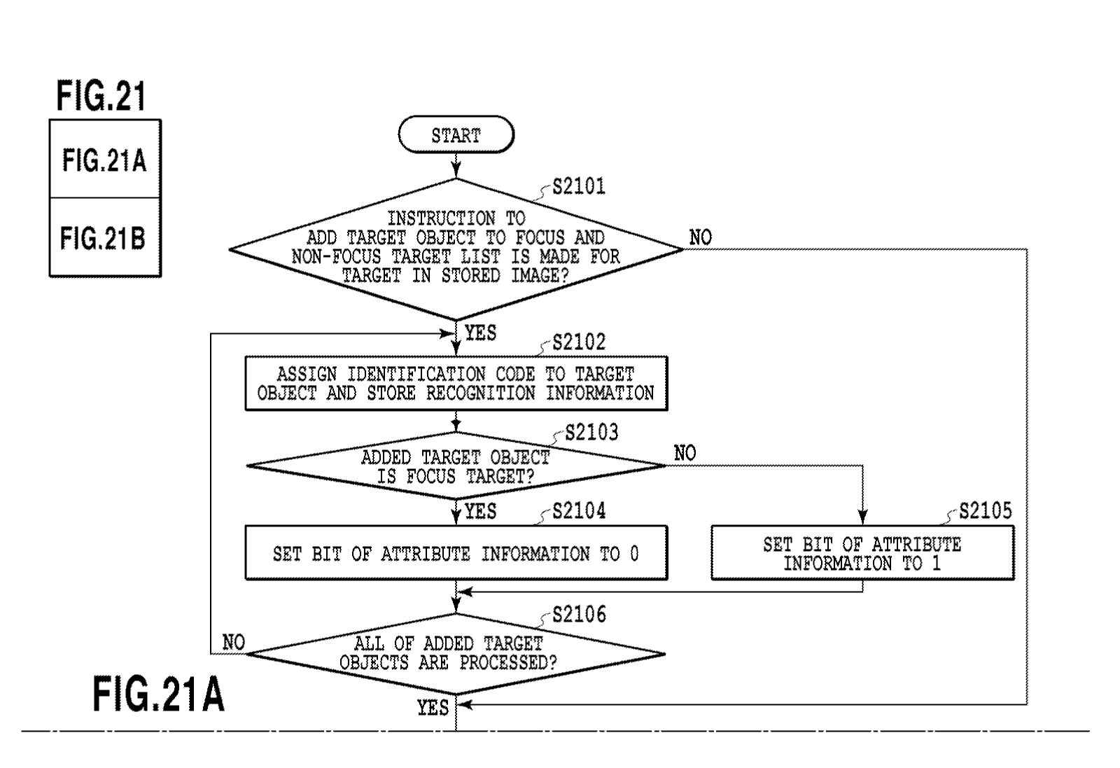

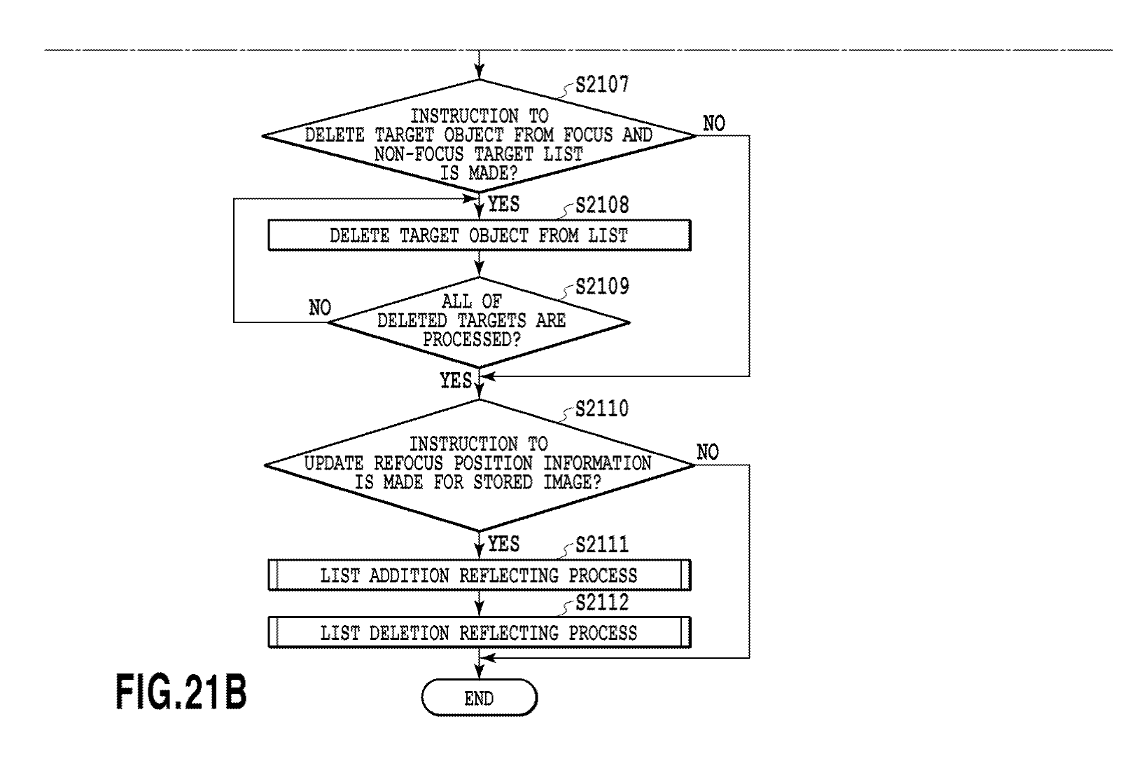

First, the process performed in a case where the focus and non-focus target list is updated is described. FIGS. 21 to 23 show a process flow performed in a case where list update such as addition of a new target object and deletion of an existing target object is performed on one or multiple focus and non-focus target lists. In step S2101 of FIG. 21A, the overall-control unit 108 determines whether the user designates a target object in the stored image and make an instruction to add the target object to the focus and non-focus target list. For example, the overall-control unit 108 causes the display 105 to display a certain stored image and determines whether the user makes the instruction to add the target object to the focus and non-focus target list through the user I/F. For example, in a case where the user designates a certain position in the stored image displayed on the display 105 and selects an item for adding a target object at the designated position to the focus and non-focus target list, the overall-control unit 108 determines that the addition instruction is made. The focus and non-focus target list in step S2101 can be a list belonging to the same group as the stored image, as described in FIG. 20. Alternatively, the user may select a group having the list to which the target object is to be added. In a case where the overall-control unit 108 determines in step S2101 that there is no instruction to add a target object to the list, the process proceeds to step S2107. In a case where the overall-control unit 108 determines in step S2101 that there is the instruction to add a target object to the list, the process proceeds to step S2102.

In step S2102, the overall-control unit 108 assigns the identification code 1804 to the target object for which the instruction is made in step S2102 and stores the identification code 1804 together with the recognition information 1806 of the target object, in the Flash ROM 107 or the external memory 109.

Here it is assumed that the user designates the target object in the stored image and the image analyzing unit 112 calculates and stores the recognition information of the designated target object. However, the recognition information on general people and the like who are not particular individuals may be stored in advance in the Flash ROM 107 or the like. In this case, the recognition information 1806 stored in step S2102 may be, for example, a pointer referring to an address in the Flash ROM 107 in which the recognition information is stored.

Next, in step S2103, the overall-control unit 108 determines whether the target object which is to be added to the focus and non-focus target list and for which the instruction is made in step S2101 is the focus target or the non-focus target. The user can give an instruction of designating the target object as the focus target or the non-focus target by the method shown in Embodiment 3. In a case where the target object to be added to the list is the focus target, the overall-control unit 108 causes the process to proceed to step S2104 and sets the bit of attribute information 1805 to 0. In a case where the target object to be added to the list is the non-focus target, the overall-control unit 108 causes the process to proceed to step S2105 and sets the bit of attribute information 1805 to 1. In step S2106, the overall-control unit 108 determines whether all of the added target objects for which the instructions are made are processed. The overall-control unit 108 repeats the process of steps 2102 to step S2105 until all of the target objects are processed.

After all of the target objects to be added to the list are processed, the overall-control unit 108 determines whether an instruction to delete a target object from the focus and non-focus target list is made in step S2107. For the deletion instruction, as in the case of the addition instruction, the overall-control unit 108 causes the display 105 to display a certain stored image and determines whether the user makes the instruction to delete the target object from the focus and non-focus target list through the user I/F. For example, in a case where the user designates a certain position in the stored image displayed on the display 105 and selects an item for deleting a target object at the designated position from the focus and non-focus target list, the overall-control unit 108 determines that the deletion instruction is made.

In a case where the overall-control unit 108 determines in step S2107 that there is no instruction to delete a target object from the list, the overall-control unit 108 causes the process to proceed to step S2110. In a case where the overall-control unit 108 determines in step S2107 that there is the instruction to delete a target object from the list, the overall-control unit 108 causes the process to proceed to step S2108. In step S2108, the overall-control unit 108 deletes the target object for which the instruction is made in step S2107 from the list. The list from which the target object is deleted at this time may be a list belonging to the same group as the stored image. Alternatively, the user may select a group having the list from which the target object is to be deleted. Moreover, the target object may be deleted from all of the lists belonging to the respective groups. In step S2109, the overall-control unit 108 determines whether all of the target objects for which instructions are made in step S2107 are deleted from the lists, and repeats the process of step S2108 until all of the deletion target objects are processed. After the process is completed for all of the target objects deleted from the lists, the overall-control unit 108 causes the process to proceed to step S2110.

In step S2110, the overall-control unit 108 determines whether there is an instruction to update the refocus position information for the stored image in a case where the focus and non-focus target list is updated. The stored image herein can be all of the stored images included in a group to which the updated focus and non-focus target list belongs and a group included in the group to which the list belongs. Moreover, the refocus position information update refers to a process of adding and deleting a field of the position information like one shown in FIG. 19, to and from the field of the refocus position information 803 in the format of FIG. 8. As described above, the refocus position information 1203 shown in FIG. 19 may include values for multiple items. The refocus position information update instruction can be given in the following way. The user can select whether to give the instruction or not at the time of the list update in step S2110 by using a user interface (hereafter, referred to as UI). Alternatively, the user may give the instruction at the time of giving the instruction to add the target object to the list in step S2101. Instead, the instruction may be an instruction set in advance by the user or an instruction automatically set by the apparatus. In a case where the overall-control unit 108 determines in step S2110 that there is no refocus position information update instruction, the process is terminated. In a case where the overall-control unit 108 determines in step S2110 that there is the refocus position information update instruction, the process proceeds to a list addition reflecting process of step S2111.

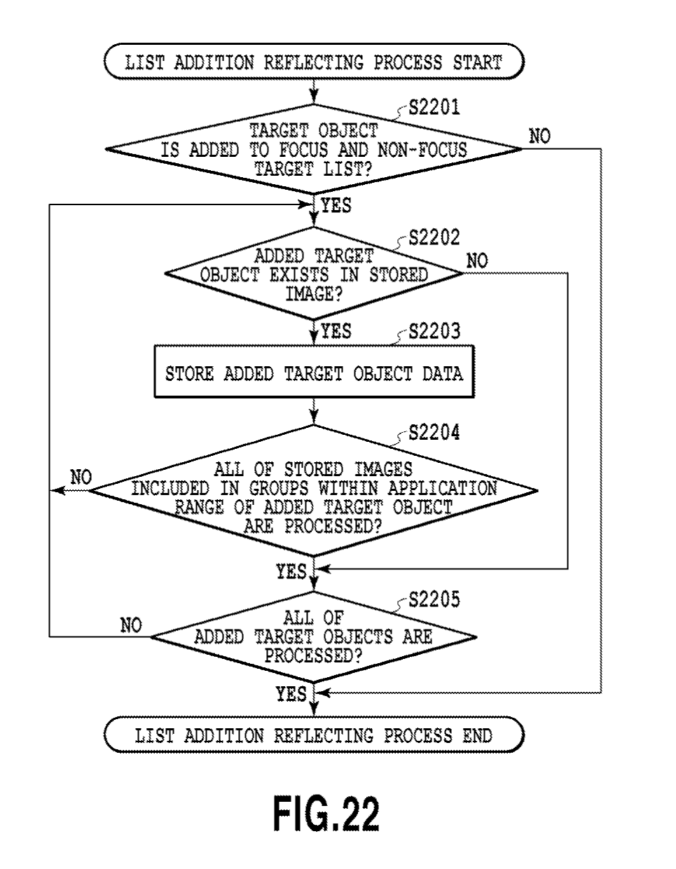

FIG. 22 shows details of the list addition reflecting process step S2111 in which the target object added to the list is reflected in the refocus position information of the stored image, and description is given of step S2111. First, in step S2201, the overall-control unit 108 determines whether the process of adding a target object to the focus and non-focus target list is performed. In a case where the overall-control unit 108 determines in step S2201 that no target object is added to the list, the overall-control unit 108 terminates the list addition reflecting process and causes the process to proceed to step S2112. In a case where the overall-control unit 108 determines in step S2201 that the process of adding a target object to the focus and non-focus target list is performed, the process proceeds to step S2202.

In step S2202, the overall-control unit 108 determines whether the added target object exists in the stored image. For example, the overall-control unit 108 extracts one stored image from all of the stored images to which the focus and non-focus target list added with the target object is applied. Then, the overall-control unit 108 determines whether the added target object exists in the stored image. This determination can be performed by causing the image analyzing unit 112 to compare the recognition information of a region in the stored image and the recognition information of the target object in the list with each other and by determining whether the difference in value therebetween is within a predetermined range. In a case where the overall-control unit 108 determines in step S2202 that no added target object exists in the stored image, the process proceeds to step S2205. In a case where the overall-control unit 108 determines in step S2202 that the added target object exists in the stored image, the process proceeds to step S2203. In step S2203, the overall-control unit 108 updates the position information 1206 to 1209, the chain information 1210, the attribute information 1220, and the identification code 1901 in the refocus position information 1203 of FIG. 19 in data of the stored image. Specifically, the overall-control unit 108 updates the stored image to a stored image including the refocus position information 1203 in which items related to the added target object are added. The refocus position information 1203 is updated in this step in a case where the added target is the focus target and in a case where the added target is the non-focus target. Since the position information 1206 to 1209, the chain information 1210, and the attribute information 1220 are the same as those of Embodiments 1 and 3, the description thereof is omitted. The update of the identification code 1901 is performed by copying and storing the identification code 1804 of the added target object in the focus and non-focus target list.

Next, in step S2204, the overall-control unit 108 determines whether the refocus position information attaching process is performed for all of the stored images included in groups within an application range of a certain target object added to the list. In a case where the overall-control unit 108 determines in step S2204 that there is an unprocessed stored image to be processed, the overall-control unit 108 causes the process to return to step S2202 to perform the refocus position information attaching process for the subsequent stored image. In a case where the overall-control unit 108 determines in step S2204 that there is no unprocessed stored image to be processed, the overall-control unit 108 causes the process to proceed to step S2205. In step S2205, the overall-control unit 108 determines whether the refocus position information attaching process is performed for all of the target objects added to the list. In a case where there is an unprocessed added target object, the overall-control unit 108 causes the process to return to step S2202 and performs the process for the subsequent added target object. In a case where the overall-control unit 108 determines in step S2205 that there is no unprocessed added target object, the overall-control unit 108 terminates the list addition reflecting process and causes the process to proceed to step S2112.

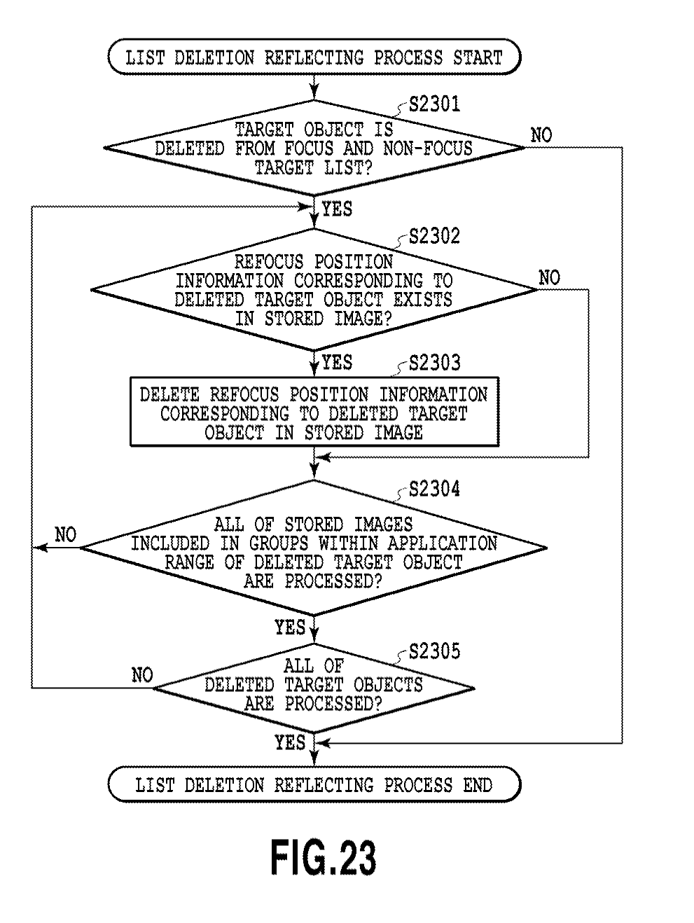

FIG. 23 is a view showing details of a list deletion reflecting process step S2112 in which the target object deleted from the list is reflected in the refocus position information in the stored image. First, in step S2301, the overall-control unit 108 determines whether a target object is deleted from the focus and non-focus target list. In a case where the overall-control unit 108 determines that there is no target object deleted from the list, the overall-control unit 108 terminates the list deletion reflecting process and the list updating process is completed. In a case where the overall-control unit 108 determines that there is a target object deleted from the list, the overall-control unit 108 causes the process to proceed to step S2302. In step S2302, the overall-control unit 108 determines whether, in respect to the deleted target object, the refocus position information corresponding to the deleted target object exists in the stored image data. This determination can be performed by comparing the identification code 1804 of the deleted target object and the identification code 1901 in the refocus position information attached to the stored image data. In a case where the overall-control unit 108 determines that there is no coincidence of the identification codes, the overall-control unit 108 causes the process to proceed to step S2304. In a case where the overall-control unit 108 determines that there is a coincidence of the identification codes, the overall-control unit 108 causes the process to proceed to step S2303. In step S2303, the overall-control unit 108 deletes the refocus position information having the identification code determined to coincide in step S2302. Specifically, the overall-control unit 108 deletes the identification code 1901 shown in FIG. 19 as well as the chain information 1210, the attribute information 1220, and the position information 1206 to 1209 which are associated with the identification code 1901. As described above, the refocus position information may have multiple bits. Accordingly, in a case where multiple fields (i.e. information related to multiple target objects) are included in the refocus position information, only the information associated with the identification code determined to coincide in step S2302 is deleted.

In step S2304, the overall-control unit 108 determines whether the process is performed for all of the stored images included in groups within an application range of a certain target object deleted from the list. In a case where the overall-control unit 108 determines that there is an unprocessed stored image to be processed, the overall-control unit 108 causes the process to return to step S2302 to perform the process for the subsequent stored image. In a case where the overall-control unit 108 determines that there is no unprocessed stored image to be processed, the overall-control unit 108 causes the process to proceed to step S2305. In step S2305, the overall-control unit 108 determines whether the refocus position information deletion process has been performed for all of the target objects deleted from the list. In a case where the overall-control unit 108 determines that there is an unprocessed target object deleted from the list, the overall-control unit 108 causes the process to return to step S2302 to perform the process for the subsequent deleted target object. In a case where the overall-control unit 108 determines that there is no unprocessed target object deleted from the list, the overall-control unit 108 terminates the list deletion reflecting process and the list updating process is completed.

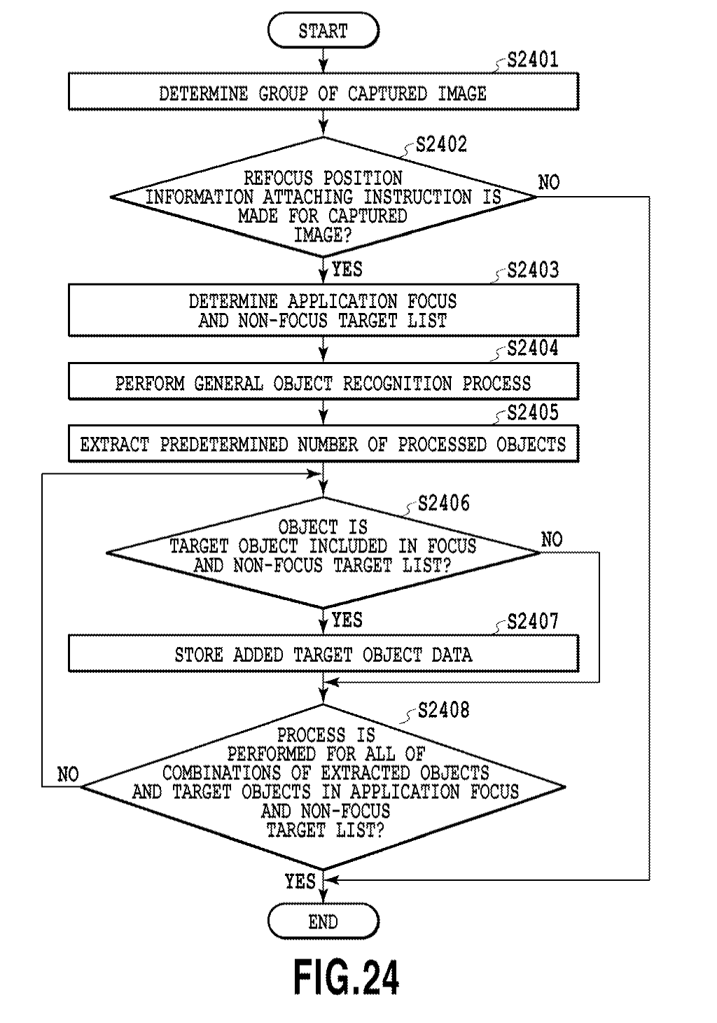

Next, detailed description is given of the process flow performed in a case where the refocus position information based on the focus and non-focus target list is attached to a captured image at the time of image capturing, by using FIG. 24. First, in step S2401, the overall-control unit 108 determines a group to which the captured image belongs, on the basis of an instruction given by the user. For example, the overall-control unit 108 displays, on the display 105, a setting screen for selecting a group to which the captured image belongs, and determines a group to which the captured image belongs on the basis of an instruction given by the user through the user I/F. Alternatively, the instruction may be an instruction set in advance by the user or an instruction automatically set by the apparatus.

Next, in step S2402, the overall-control unit 108 determines whether a refocus position information attaching instruction is made for the captured image. As in step S2401, the overall-control unit 108 displays, on the display 105, a setting screen which allows selection of whether to attach the refocus position information to the captured image or not. Then, the overall-control unit 108 determines whether the user made the refocus position information attaching instruction, on the basis of an instruction given by the user through the user I/F. Alternatively, the instruction may be an instruction set in advance by the user or an instruction automatically set by the apparatus. In a case where the overall-control unit 108 determines that no refocus position information attaching instruction is made, the overall-control unit 108 terminates the process. In a case where the overall-control unit 108 determines in step S2402 that the refocus position information attaching instruction is made, the overall-control unit 108 causes the process to proceed to step S2403. Moreover, whether to make the refocus position information attaching instruction can be selected by the user through the UI at the time of the list update.

In step S2403, the overall-control unit 108 determines the focus and non-focus target list to which the process is applied, on the basis of the group to which the captured image belongs. In step S2404, the overall-control unit 108 performs general object recognition for the captured image to extract objects. In step S2405, the overall-control unit 108 extracts a predetermined number of objects from the objects extracted in step S2404. For example, the overall-control unit 108 can perform a face recognition process as the general object recognition of step S2404 and perform a process of extracting the predetermined number of face regions from detected multiple face regions in the descending order of area in step S2405. The objects extracted in step S2404 are not limited to faces and may be animals, trees, and combination of these. Moreover, the method of extracting the predetermined number of objects in step S2405 is not limited to one extracting the regions of the objects in the descending order of area. The order of extraction may be determined in a different way. For example, the focus targets are extracted in the ascending order of distance from the center of the image, and the non-focus targets are extracted in the descending order of distance from the center of image. Performing the process as described in steps S2404 and S2405 reduces the processing load in steps S2406 to S2408 to be described later. Note that the steps S2404 and S2405 are not essential processes and the embodiment can be carried out without these steps.

In step S2406, the overall-control unit 108 determines whether each of the objects extracted in step S2405 corresponds to any of the target objects in the focus and non-focus target list. This determination is performed by comparing the objects extracted in S2405 and the recognition information in the focus and non-focus target list with each other. In a case where the overall-control unit 108 determines that the extracted object corresponds to none of the target objects in the list, the overall-control unit 108 causes the process to proceed to step S2408. In a case where the overall-control unit 108 determines that the extracted object corresponds to any of the target objects in the list, the overall-control unit 108 causes the process to proceed to step S2407. In step S2407, the captured image is subjected to the refocus position information attaching process. The process of step S2407 is the same as that of step S2203 and detailed description thereof is omitted.

In step S2408, the overall-control unit 108 determines whether the processes of steps S2406 and S2407 have been performed for all of combinations of the extracted objects and the target objects in the focus and non-focus target list to which the process is applied. In a case where the processes have not been performed for all of the combinations, the overall-control unit 108 causes the process to return to step S2406 to perform the processes for the subsequent combination. In a case where the processes have been completed for all of the combinations, the overall-control unit 108 terminates the entire process performed at the time of image capturing.

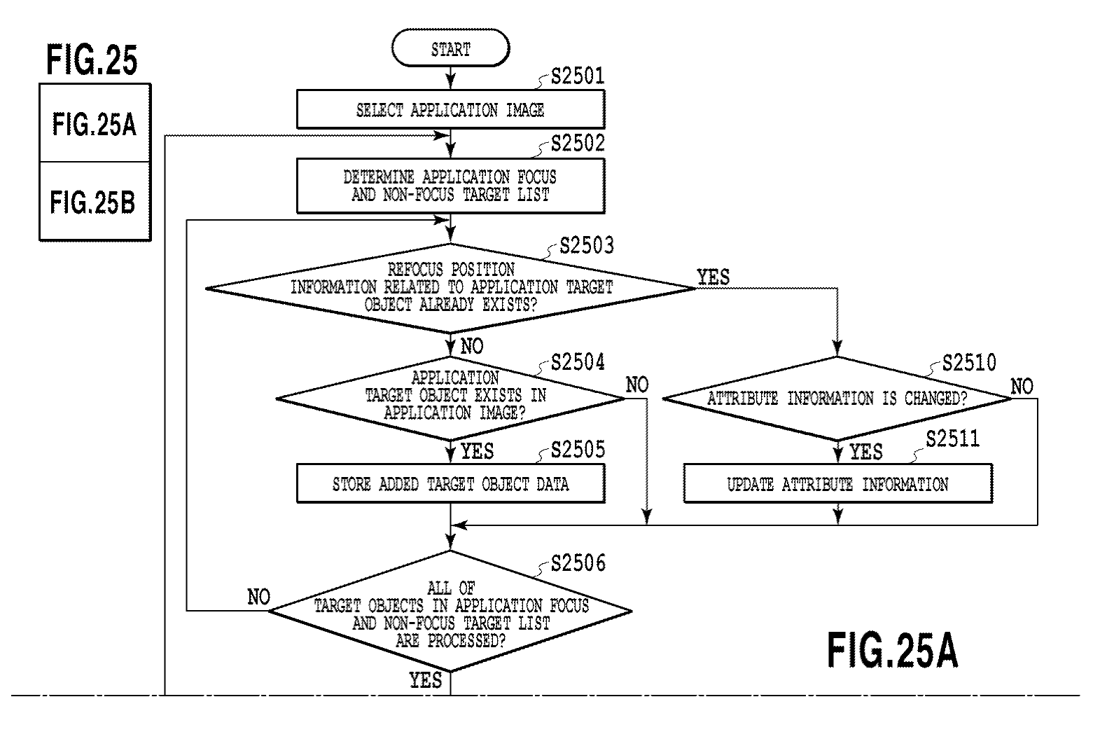

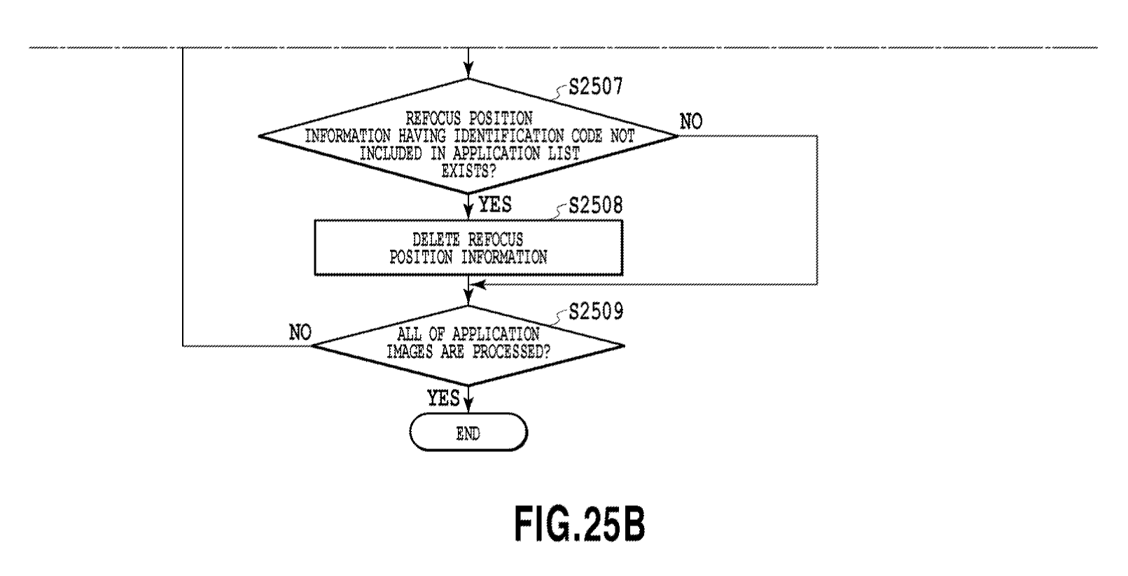

Next, description is given of the process performed in a case where the refocus position information of the stored image is updated at an arbitrary timing on the basis of the focus and non-focus target list at that time, by using FIGS. 25A and 25B and the like.

First, in step S2501, the overall-control unit 108 accepts selection of the image whose refocus position information is to be updated. The image may be selected by the user with the UI or may be selected automatically in accordance with the setting of the apparatus. In step S2502, the overall-control unit 108 determines, as an application list, the focus and non-focus target list to which the update is applied, on the basis the group including the image whose refocus position information is to be updated.

In step S2503, the overall-control unit 108 determines whether refocus position information related to the target object in the application list determined in step S2502 already exists in the stored image selected in step S2501. The determination can be performed by finding out whether the stored image data includes the refocus position information having the same identification code as the identification codes of the target object in the application list. In a case where the overall-control unit 108 determines in step S2503 that the refocus position information related to the target object in the application list already exists, the overall-control unit 108 causes the process to proceed to step S2510. In a case where the overall-control unit 108 determines in step S2503 that no refocus position information related to the target object in the application list exists, the overall-control unit 108 causes the process to proceed to step S2504.

In step S2504, the overall-control unit 108 determines whether the target object in the list exists in the image selected in step S2501. The process of step S2504 can be performed by can be performed by causing the image analyzing unit 112 to compare the recognition information of a region in the stored image and the recognition information of the target object in the list with each other and by determining whether the difference in value therebetween is within a predetermined range. In other words, the determination is made depending on the presence and absence of the identification code in step S2503 while the determination is made by comparing the recognition information in step S2504. In a case where, in step S2504, no target object in the list exists in the stored image selected in step S2501, the overall-control unit 108 causes the process to proceed to step S2506. Ina case where, in step S2504, the target object in the list exists in the stored image selected in step S2501, the overall-control unit 108 causes the process to proceed to step S2505. In step S2505, the overall-control unit 108 attaches the refocus position information to the stored image. The process of step S2505 is the same as that of S2203 and detailed description thereof is thereby omitted.

Meanwhile, in step S2510, the overall-control unit 108 compares the attribute information of the target object in the application list determined in step S2505 and the attribute information included in the refocus position information determined to have the same identification code in step S2503. In a case where the two pieces of attribute information coincide with each other, the overall-control unit 108 determines that the attribute information is not changed and causes the process to proceed to step S2506. In a case where the two pieces of attribute information do not coincide with each other, the overall-control unit 108 determines that the attribute information is changed, and causes the process to proceed to step S2511. In step S2511, the overall-control unit 108 writes the attribute information of the target object in the application list determined in step S2502 over the attribute information included in the refocus position information. This is applied in a case where the target object set as the focus target is set as the non-focus target, for example.

In step S2506, the overall-control unit 108 determines whether the refocus position information attaching process for the stored image is completed for all of the target objects in the application focus and non-focus target list. In a case where there is an unprocessed target object in the list, the overall-control unit 108 causes the process to return to step S2503 to perform the process for the subsequent target object. In a case where no unprocessed target object exists in the list, the overall-control unit 108 causes the process to proceed to step S2507.

In step S2507, the overall-control unit 108 determines whether the refocus position information related to the target object not included in the application list determined in step S2502 exists in the refocus position information attached to the stored image selected in step S2501. This determination can be performed by finding out whether there is the refocus position information having the identification code which does not correspond to any of the identification codes of the target objects in the application list. In a case where there is the refocus position information related to the target object not included in the application list, the overall-control unit 108 causes the process to proceed to step S2508 and deletes this refocus position information attached to the stored image. In a case where there is no refocus position information related to the target object not included in the application list, the overall-control unit 108 causes the process to proceed to step S2509.

In step S2509, the overall-control unit 108 determines whether the refocus position information updating process is performed for all of the stored images selected in step S2501. Ina case where an unprocessed stored image exists, the overall-control unit 108 causes the process to return to step S2502 to perform the process for the subsequent image. In a case where no unprocessed stored image exists, the overall-control unit 108 terminates the process.

Performing the process as shown in FIGS. 25A and 25B allows the update of the focus and non-focus target list to be applied to an arbitrary stored image at an arbitrary timing.

In FIGS. 21A, 21B, 24, and 25, description is given of the process of updating the list and the process of updating the refocus position information of the stored image. As a subsequent process, the process of generating the image data with a newly generated focus surface which is described in Embodiment 3 is performed for the stored image to which the refocus position information has been added or from which the refocus position information has been deleted. This process of updating the stored image may be performed after the processes of FIGS. 21A, 21B, 24, and 25 or may be performed in response to an instruction from the user.

By storing and managing the target to be in focus and the target to be out of focus separately from the individual pieces of image data as described above, an image reflecting the intention of the user can be quickly generated and displayed in a case where images captured from multiple viewpoints are combined.

Moreover, instructions to bring a specific target in focus can be given in one operation for the refocus images belonging to a certain group. The operation load of the user can be thereby reduced.

### Embodiment 5

Embodiment 5 is described in detail by using FIGS. 1, 11, 12A, 12B, and FIGS. 18 to 27C. Description of FIGS. 1, 11, 12A, 12B, and FIGS. 18 to 25B is omitted because it is the same as that in Embodiments 1, 3, and 4.

In Embodiment 4, there is shown an example in which the focus and non-focus target list is stored and managed and the refocus position information of the image data are updated in one operation based on this list. In Embodiment 5, there is shown an example of a method of easily updating the recognition information 1806 of the focus or non-focus target to one having higher identification, the focus or non-focus target specified by the user designating the target object from the stored image. Moreover, there is shown an example of a method which allows the user to find a piece of refocus position information not reflecting the intention of the user out of pieces of refocus position information generated based on the focus and non-focus target list and to easily correct this piece of refocus position information.

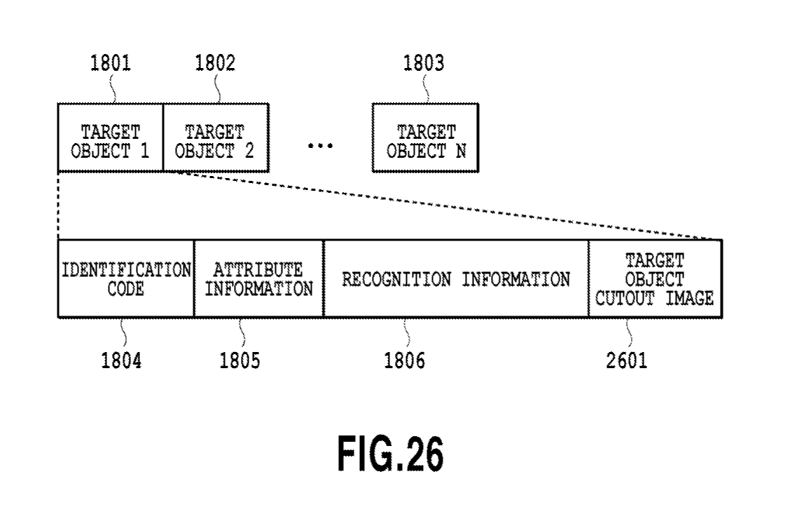

In the embodiment, the focus and non-focus target list in Embodiment 4 has a data format shown in FIG. 26. In FIG. 26, for each of the target objects, a target object cutout image 2601 which is an image of a cut-out region of the target object is attached to the data format of FIG. 18. The target object cutout image (hereafter, referred to as cutout image) 2601 is obtained as follows. Ina case where the user designates a target object to be added to the focus and non-focus target list from the image, a region of the recognized target object region is cut out.

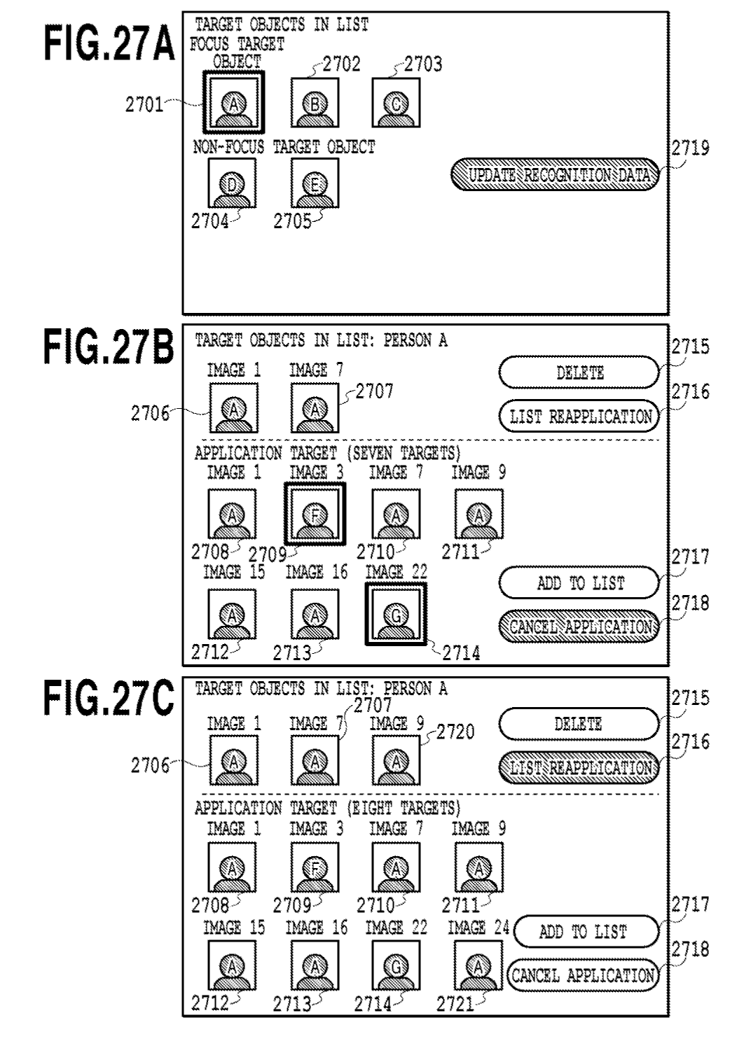

FIGS. 27A, 27B, and 27C show an example of UI used by the user to update the recognition information of the target object in the focus and non-focus target list and to correct the refocus position information not reflecting the intension of the user.

In FIG. 27A, reference numerals 2701 to 2703 denote images corresponding to the cutout images 2601 of the respective focus target objects in the focus and non-focus target list. Similarly, reference numerals 2704 and 2705 denote cutout images of the non-focus targets. Hereafter, description is given under the assumption that the selection operations using UI are performed as operations on a touch panel. However, the operation method is not limited to this and a method of performing selection by moving a cursor with a mouse or a method of performing selection by button operations may be used. Moreover, the operation of tap described hereafter refers to a series of operations of pressing a certain area on the touch panel for a certain time or more and then releasing the pressing.

Here, consider a case where the user performs operation on the recognition information and the refocus position information on a person A who is a target object in the list. First, the user taps and selects the image 2701 in FIG. 27A. A bold frame surrounding the image 2701 indicates that the image 2701 is selected. Next, the user taps a recognition data update button 2719 and the display changes from FIG. 27A to FIG. 27C.

Reference numerals 2706 and 2707 denote the target object cutout images 2601 in the focus and non-focus target list to which an identification code indicating the person A is assigned. In the example of FIG. 27B, the same identification code 1804 indicating the person A is assigned to the pieces of target object data of the images 2706 and 2707. Note that the list may include multiple pieces of target object data which have the same identification code as described above. In a case where there are multiple pieces of data having the same identification code, only one cutout image out of the cutout images of the target objects having the same identification code is required to be displayed as the cutout image shown in FIG. 27A described above. Moreover, in a case where there are multiple pieces of data having the same identification code, the comparison of the recognition information described in the aforementioned embodiments can be performed for each of the stored images by using multiple identification codes.

Reference numerals 2708 to 2714 in FIG. 27B denote cutout images obtained from image data including the refocus position information to which the same identification code as the target objects 2706 and 2707 in the focus and non-focus target list is assigned. These cutout images can be each obtained by cutting out a rectangular region indicated by the coordinates of position information 1206 to 1209 in the refocus position information 1203 included in the corresponding image data.

Here, it is preferable that the images 2708 to 2714 are all images of the person A. However, in the example of FIG. 27B, an image 2709 of a person F and an image 2714 of a person G are displayed as a result of erroneous recognition. In this case, the user can delete the refocus position information related to the images 2709 and 2714 from the corresponding image data by tapping and selecting the cutout images 2709 and 2714 and then tapping an application cancel button 2718. In other words, the field of refocus position information which includes the identification code indicating the person A is deleted from the pieces of image data which are cutout sources of the images 2709 and 2714. As a result, in a case where the next recognition information update is performed, the images 2709 and 2714 are not extracted as application targets of FIG. 27B because no identification code indicating the person A is included.

Moreover, it is preferable that the refocus position information for bringing the person A in focus is generated for all of the regions of the person A in the stored images which are application targets. However, depending on the recognition information of the person A included in the focus and non-focus target list, the refocus position information may not be always generated for all of the regions of the person A.

To solve this problem, the user first selects, from the images 2708 to 2714, an image which is determined to be suitable for identification, by tapping the image. Next, the user taps add-to-list button 2717 and thereby adds the selected image to the focus and non-focus target list as the focus target object having the identification code of the person A.

Furthermore, the user can delete the target object in the list which is shown in the images 2706 and 2707 by tapping and selecting the images 2706 and 2707 and then tapping a delete button 2715.

In a case where the user taps a list reapplication button 2716 after a series of processes for the list update, all refocus position information to which the identification code of the person A is assigned is deleted from the pieces of imaged data of the stored images. Thereafter, the refocus position information is attached again to each of the applied stored images by the method of Embodiment 4, by using the recognition information on the person A obtained after the list update. The result of this attachment is reflected in the UI of FIG. 27B. Here, the recognition information of the target object added in the list update is obtained by the image analyzing unit 112 processing the cutout image of the added target object or the source image of the cutout image.

FIG. 27C shows an image on the screen displayed as a result of adding the target object 2711 to the list in FIG. 27B and performing the list reapplication. The added image is denoted by reference numeral 2720 as a list-included target object. The images 2708 to 2714 and an image 2721 are the cutout images obtained from the stored images to which the refocus position information is attached based on the list-included target objects 2706, 2707, and 2720. As a result of the addition of the target object 2720 to the list, the cutout image 2721 is displayed as the application target in addition to the seven images in FIG. 27B. This means that the refocus position information associated with the identification code indicating the person A is attached to the source image of the cutout image 2721.

The process described above allows the user to update the recognition information in the list to one with higher identification while checking the cutout images of the focus targets and the non-focus targets. Moreover, an unnecessary piece of refocus position information out of the pieces of generated refocus position information can be easily deleted. In addition, instructions of focus and non-focus can be given to the refocus images belonging to a certain group in one operation, on the basis of the list update. The operation load of the user can be thereby reduced.

### Embodiment 6

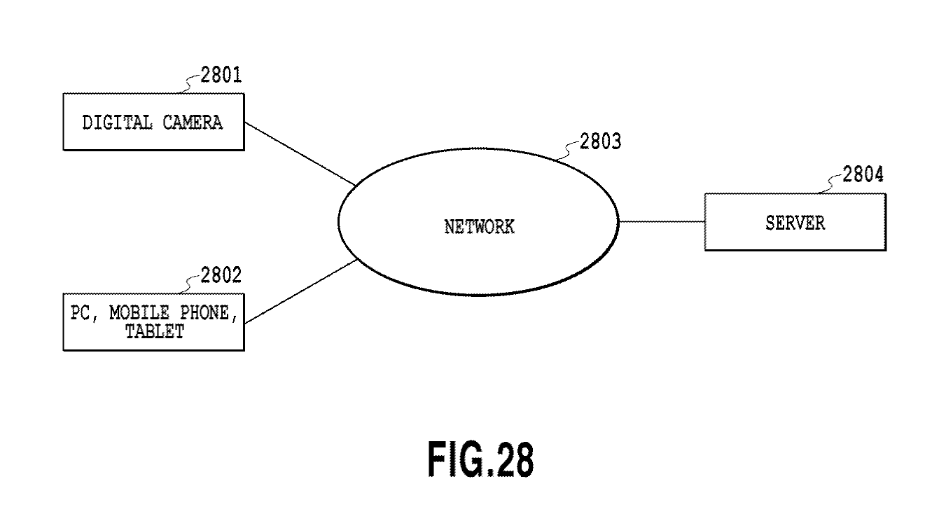

Embodiment 6 is described in detail by using FIG. 28. Description of contents which are the same as those in the aforementioned embodiments is omitted.

FIG. 28 shows a system configuration in the embodiment. The system in the embodiment includes a digital camera 2801 having a configuration as shown in FIG. 1, an image displaying terminal 2802 such as a PC, a mobile phone, or a tablet, and a server 2804. These apparatuses each have a communication function to connect to a network. The digital camera 2801, the image displaying terminal 2802 such as a PC, a mobile phone, or a tablet, the server 2804, and the like are connected to a network 2803.

The focus and non-focus target list shown in Embodiments 4 and 5 can be used more efficiently through cooperation of apparatuses via a network like one shown in FIG. 28.

The server 2804 has identification information for identifying general target objects such as people, animals, utility poles, and trees which are not individually registered in the focus and non-focus target list by the user, and also has a function of generating the refocus position information on the basis of the recognition information and information on the focus state. Moreover, the server 2804 may have a function of generating the refocus image on the basis of the refocus position information.

In a case where the refocus image is generated in the server 2804, the refocus image can be browsed in the image displaying terminal 2802 such as a PC, a mobile phone, or a tablet, by transmitting the refocus image to the image displaying terminal 2802 via the network.

Moreover, the image displaying terminal 2802 is capable of performing a work of updating a focus and non-focus target list like one shown in Embodiment 5, by using a display screen of the image displaying terminal 2802. In this case, the focus and non-focus target list may be downloaded from the server 2804 to the image displaying terminal 2802 or there may be a system which allows the image displaying terminal 2802 to directly change data in the server 2804. In a case where the focus and non-focus target list is downloaded to the image displaying terminal 2802, the list is uploaded to the server after the updating process of the list is completed. Thereafter, the refocus position information can be generated in the server as needed, in accordance with the updated focus and non-focus target list.

The digital camera 2801 obtains information on the focus and non-focus target objects which can be processed by the server, through communication with the server 2804. This obtaining of information can be performed automatically in a case where the communication between the server 2804 and the digital camera 2801 is performed after the update of the focus and non-focus target list in the server. Moreover, the contents of the update may be notified to the user by using an UI. In a case where the contents of the update are set to be notified to the user in the case of update, the user selects a focus or non-focus target object from the contents and the target object is stored in the digital camera 2801. This allows display of an image captured after the update to be optimized in the digital camera 2801, on the basis of the updated focus and non-focus target list.

The image data captured and stored by the digital camera 2801 and the stored focus and non-focus target object information to be processed by the server are transmitted to the server 2804 via the network 2803. The image data transmitted to the server 2804 each include the refocus position information attached thereto at that time. The server 2804 performs the refocus position information generating process on each piece of image data, on the basis of the focus and non-focus target object information set by the user. The generated refocus position information is transmitted to the digital camera 2801 via the network 2803 and the refocus position information of the corresponding image in the digital camera 2801 is updated. In this case, the refocus image data generated by the server 2804 on the basis of the refocus position information may be simultaneously transmitted to the digital camera 2801.

This configuration can reduce the processing load for the refocus position information generation and the refocus image generation in the digital camera 2801. Moreover, the data amount of the recognition information stored in the digital camera 2801 can be reduced.

### Embodiment 7

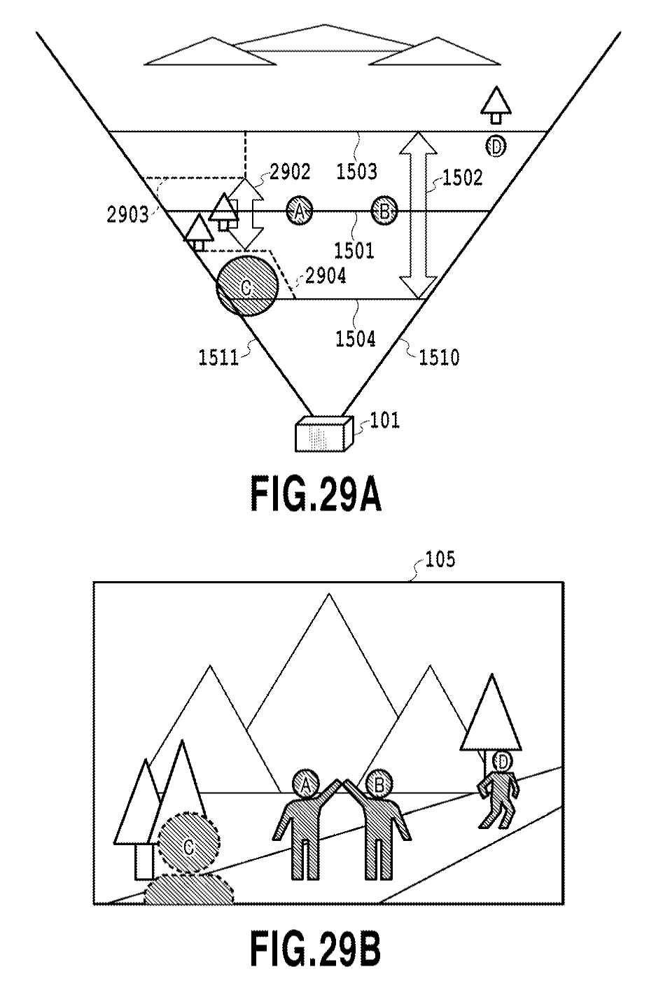

Embodiment 4 shows a basic method of changing the virtual focus surface and the depth of field in accordance with the focus and non-focus instructions. In Embodiment 7, description is given of a method of changing the virtual focus surface in accordance with a more complex request. Description is given by using FIGS. 15A and 15B as well as FIGS. 29A to 33B.

It is assumed that, in FIG. 15B, a person C on the screen is pressed and held and an instruction to set the person C to a non-focus target has been given. At this time, it is assumed that a policy of changing the virtual focus surface is set to such a policy that “the visibility of objects other than the designated target is not changed as much as possible”. In this case, the person C can be made to blur by reducing the depth of field only in a portion related to the person C in the angle of view, without changing the virtual focus surface. FIG. 29A shows an example of such a case. Although the virtual focus surface 1501 is not changed, the depth of field in the portion related to the person C in the angle of view is set to be shallow as shown by an arrow 2902. Accordingly, the range of focus is set between a dotted line 2903 and a dotted line 2904, and the person C is located outside the focus range. FIG. 29B shows an image displayed at this time.

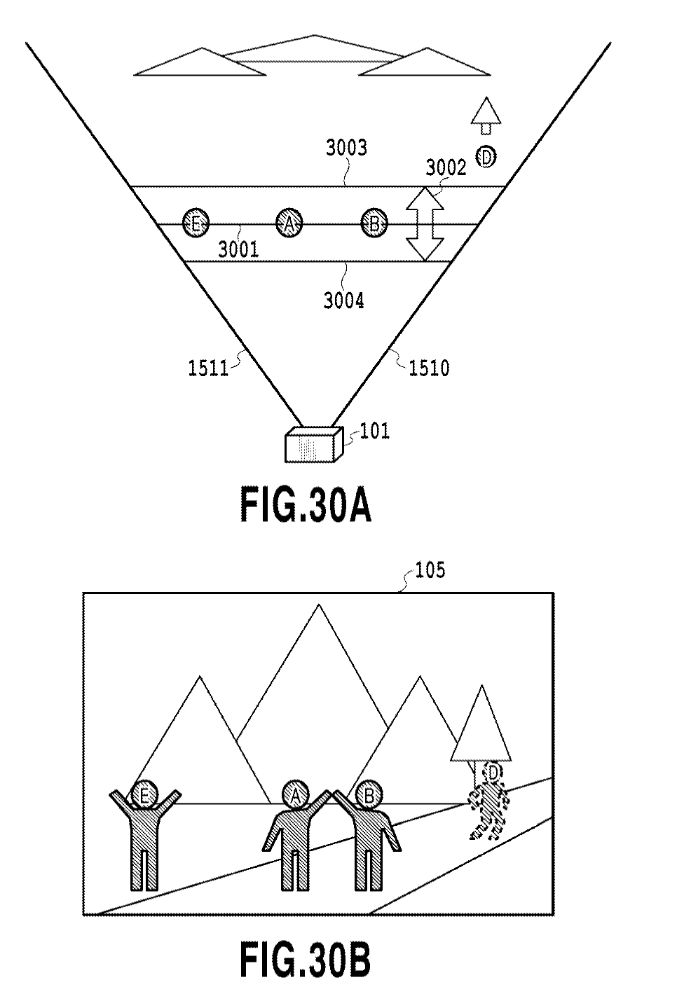

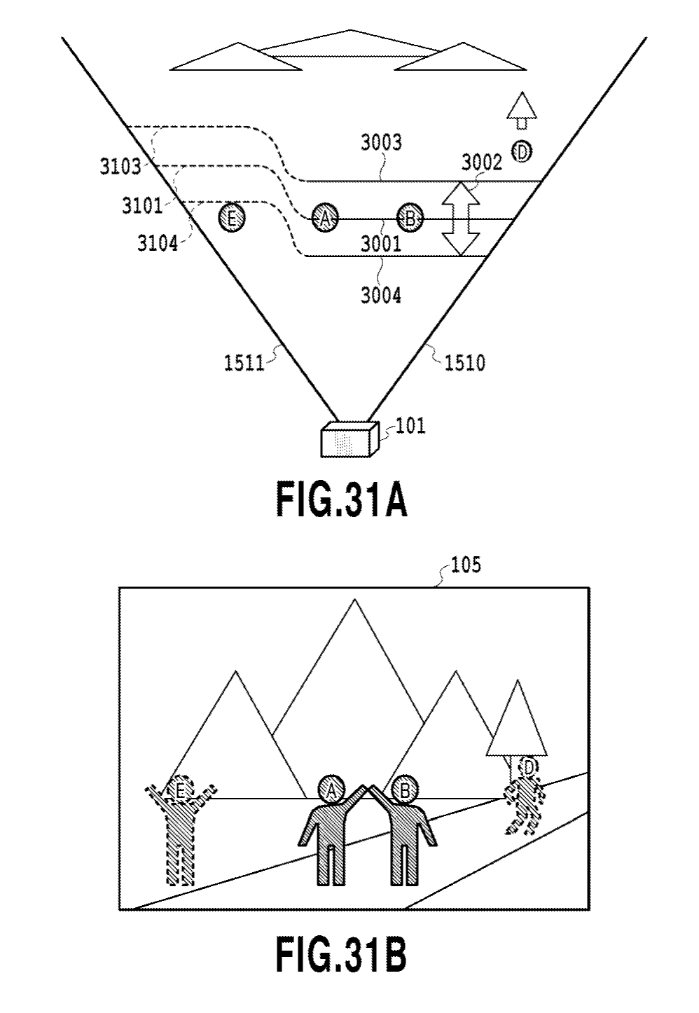

A method of changing the focus surface in a case where one of people on the same virtual focus surface is desired to be brought out of focus is described by using FIGS. 30A, 30B, and 31. In FIG. 30A, the people A, B, and E are assumed to be on the same virtual focus surface 3001 and are in the focus state. It is assumed that a depth of field 3002 is determined in such a way that the person D is located outside the focus range, because the person D is not the focus target in this case. Accordingly, in FIG. 30A, the focus range is between a straight line 3003 and a straight line 3004. An image displayed on the display 105 in this case is shown in FIG. 30B.

It is assumed that, in the screen of FIG. 30B, the person E on the screen is pressed and held and the instruction to set the person E to the non-focus target has been given. At this time, since the people A, B, and E exist on the same virtual focus surface, the person E cannot be set to the non-focus state by simply adjusting the depth of field. Such a case can be handled by shifting part of the virtual focus surface. Such a case is shown in FIGS. 31A and 31B. In FIG. 31A, a virtual focus surface 3101 is bent away from the image capturing camera array unit 101 in a portion around the person E. Since the depth of field is not changed, the range of depth of field is bent as shown by dotted lines 3103 and 3104 along with the change of the virtual focus surface. By this operation, as shown in FIG. 31B, an image with the focus on only the people A and B is displayed on the display 105.

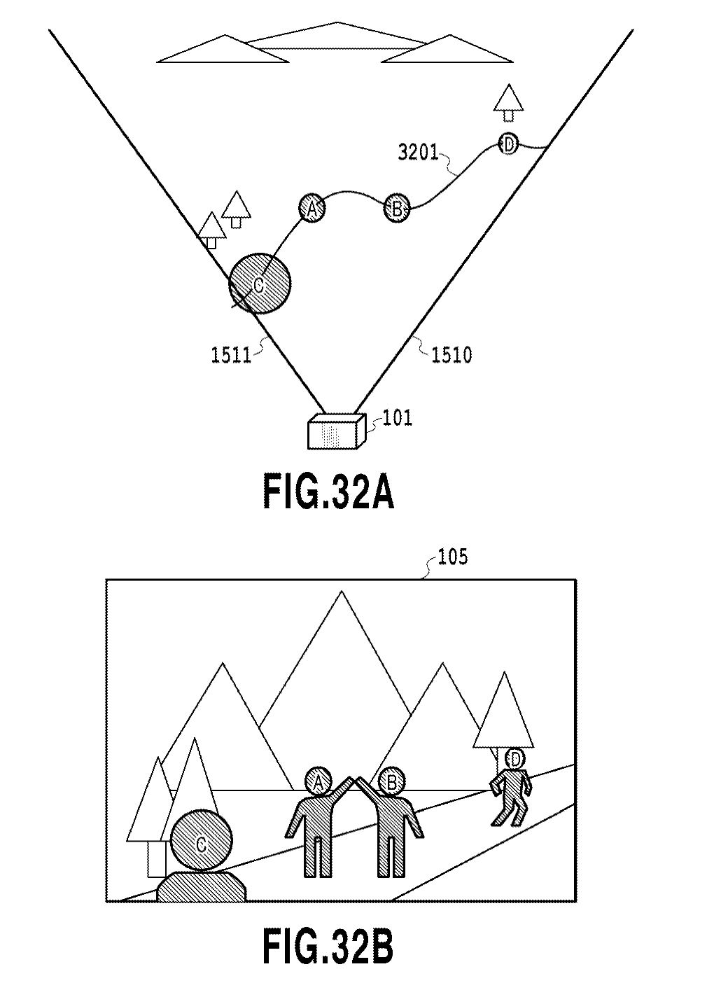

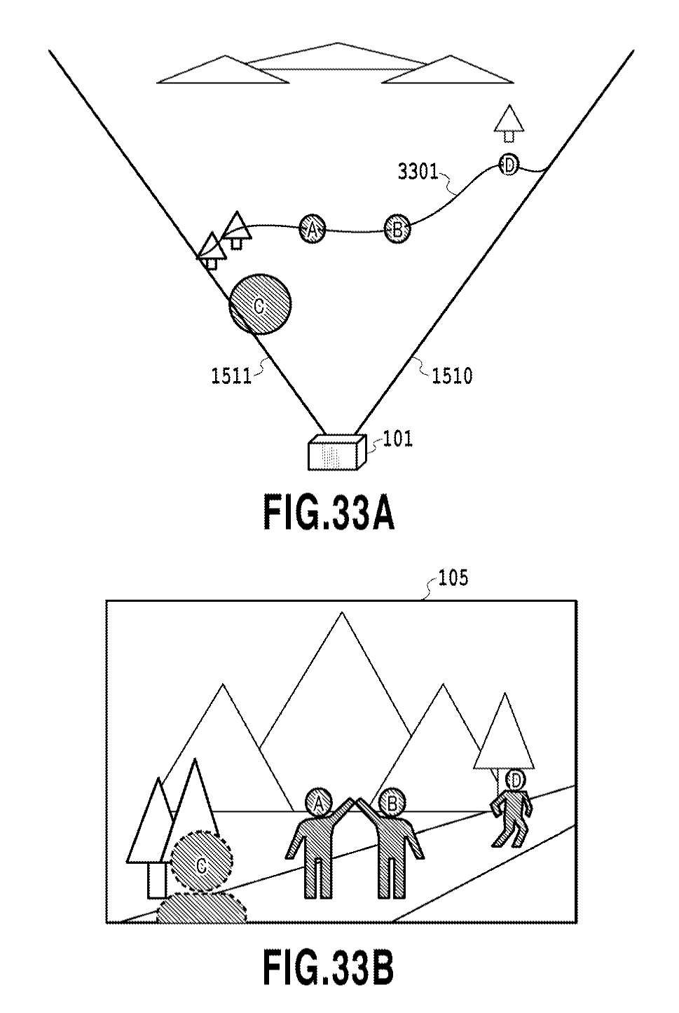

An example in which the virtual focus surface is defined as a curved plane is described by using FIGS. 32A, 32B, and 33. FIG. 32A shows a case where a combined image with the focus on the people A, B, C, and D is obtained. In this case, a virtual focus surface 3201 is defined as a curved plane passing through the people A, B, C, and D. Accordingly, as shown in FIG. 32B, an image in which the people A, B, C and D are in focus and which have a shallow depth of field (portions other than the portions in focus have a large degree of blur) can be displayed on the display 105.

Here, assume that the image of the person C on the display 105 is pressed and held and the person C is designated as the non-focus target. The image generated as a result of the designation and the state of the virtual focus surface is shown in FIGS. 33A and 33B. In FIG. 33A, a virtual focus surface 3301 is changed to pass through, instead of the person C, the positions of the trees behind the person C. Since the depth of field of this image is shallow as described above, an image with the person C in blurred is obtained as shown in FIG. 33B.

The flow of the process of defining the virtual focus surface as a curved plane and obtaining a combined image is described above by using FIG. 13 of Embodiment 3. Here, characteristic matters in the designation of the virtual focus surface as a curved plane are described by using FIG. 13 again.

The virtual focus surface generating portion 1305 generates a shape of the focus surface in accordance with the number and positions of the targets to be in focus in the instruction. For example, in FIG. 32A, an instruction to bring the people A, B, C, and D in focus is given. At this time, the virtual focus surface generating unit 1305 obtains two-dimensional coordinates (XA, YA), (XB, YB), (XC, YC), and (XD, YD) corresponding to the displayed image (image of FIG. 33B in this case) of the people A, B, C and D, from the focus coordinate information of the buffer 1315. Moreover, the virtual focus surface generating unit 1305 grasps three-dimensional spatial positions (xA, yA, zA), (xB, yB, zB), (xC, yC, zC), and (xD, yD, zD) of the people A, B, C, and D at the time of image capturing from the distance image of the buffer 1314, by using the two-dimensional coordinates. Then, the virtual focus surface generating unit defines the order of a curve to be a base for the generation of the focus surface, on the basis of the number of targets to be in focus. In the embodiment, the order is set to a number equal to “the number of target to be in focus−1”. In this example, since the target to be in focus are the four people of A, B, C, and D, the number of targets to be in focus is 4 and the order of the curve is defined as 3. Note that the order is not uniquely determined only by this method. In a case where there are many targets to be in focus, it is conceivable to provide an upper limit. Moreover, depending on the actual positional relationship between the targets to be in focus, the order of the curve may be smaller than the order determined in the method described above.

Next, the virtual focus surface generating unit 1305 defines an actual curved plane. FIG. 32A shows a state where a three-dimensional space in which the objects exist is viewed as it is from a y-axis direction. In other words, the depth direction in FIG. 32A is a z-axis and corresponds to distance between an image capturing unit and each of the objects. Since the order of curve is defined as 3, a polynomial corresponding to the curve is as shown below.

z=ax ̂3+bx̂2+cx+d

A simultaneous equation in which values corresponding to x and z in the previously-obtained three-dimensional spatial positions (xA, yA, zA), (xB, yB, zB), (xC, yC, zC), and (xD, yD, zD) of the people A, B, C, and D at the time of image capturing are put into the formula shown above is solved. A curve on an xz plane can be thereby obtained. A method for obtaining the curve includes various methods such as one using matrix operation and one obtaining an approximated curve by a least squares method, but description thereof is omitted herein. The order and coefficient of the polynomial obtained herein are used as the focus surface information which expresses the shape of the focus surface and which is stored in the buffer 1316.

After the focus surface information is obtained, the image combining unit 1306 expands the curve expressed by the obtained polynomial in the y-axis direction and thereby generates the virtual focus surface. Then, the image combining unit 1306 weighs and adds up captured pieces of image data of the respective cameras in the buffer 1312 to obtain a combined image. In this case, the image combining unit 1306 generates a combined image with the focus on the virtual focus surface, for positions corresponding to the people A, B, C, and D on the virtual focus surface. Moreover, the image combining unit 1306 calculates the degree of blur for each of captured targets other than the people A, B, C, and D from the distance between a position in the three-dimensional space where the captured target has actually existed and the position where the virtual focus surface exists, and generates a combined image having blur effects corresponding to the distance. The degree of blur is calculated in consideration of the set depth of field. By utilizing the curved focus surface as described above, only the targets designated as shown in FIGS. 31A, 31B, 33A, and 33B can be selectively brought out of focus.

In the configuration described above, it is possible to generate an image in which one of two objects at the same distance from the image capturing camera array unit 101 are selectively blurred. Accordingly, the user can easily generate an image as intended by giving an instruction of selecting the non-focus target from objects displayed on a screen, without particularly considering the distance and the depth of field.

### Embodiment 8

In the embodiments described above, the images simultaneously captured from different viewpoints by using the image capturing camera array unit 101 are used as the multiple images. However, for example, images captured at continuous time points may be also used. For example, the following cases are conceivable. Images are captured at two or more continuous time points with the position of the camera slightly varied. Images are captured with the focal position of the lens of the camera slightly varied. In both cases, as long as the object does not move and the position variation of the camera or the variation of the focal position of the lens is known, the distance image can be generated by performing distance estimation using the multiple images.

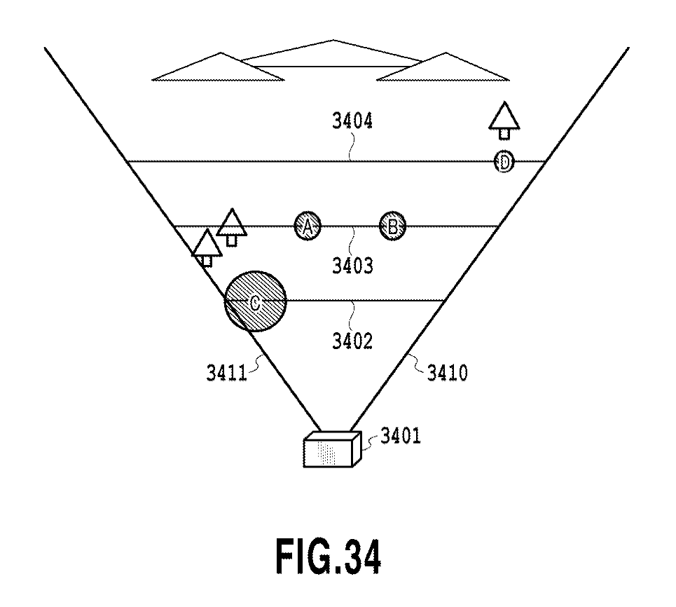

FIG. 34 shows an example of a case where continuous image capturing is performed with the focal position of the lens of the camera slightly varied. In FIG. 34, reference numeral 3401 denotes a camera image capturing unit capable of performing sequential shooting. The angle of view of the camera image capturing unit 3401 is shown by two lines of 3410 and 3411 obliquely extending from the camera image capturing unit 3401. Images of people A, B, C, and D which are objects within the field of view are captured together with mountains and trees.

Here, assume the following case. An image in which a virtual focus surface 3402 is set such that the person C is in focus is captured at a time point t1. Then, an image in which a virtual focus surface 3403 is set such that the people A and B are in focus is captured at a time point t2 right after the time point t1. Furthermore, an image in which a virtual focus surface 3404 is set such that the person D is in focus is captured at a time point t3.

Here, it is assumed that the intervals between the time points t1, t2, and t3 are sufficiently small and the movement of objects can be ignored. In this case, it is possible to generate the distance image by performing distance prediction from the images captured by using the three virtual focus surfaces, the focal distance information at the time of image capturing, and information on the captured images. If the distance image can be obtained, the image with the varied focal position can be generated by performing the flow of process described by using FIG. 13 in Embodiment 3. Accordingly, the following operation is made possible. The user designates a region to be out of focus on a displayed image, the focus surface is generated in such a way that the designated region is set as the non-focus region, and images are combined and displayed.

### Embodiment 9

As more functions are added to image processing of a digital camera, parameters to be designated by the user are becoming more complex and there is a demand for an easily-understandable GUI (Graphical User Interface) for setting the parameters. For example, conventionally, a position to be in focus is designated as the parameter during the image capturing to capture an image. Meanwhile, the user can designate an object to be in focus after the image capturing by utilizing the refocus process. In this case, the user designates, as a parameter, an arbitrary position on an image displayed on the screen and the image processing apparatus thereby generates image data with the focus on the object at the designated position. Operation methods of designating the parameters for focusing and the like after the image capturing as described above is a process unknown to the user.

Moreover, along with the increase in processing amount due to the increase in number of functions in the digital camera, more time is required for image processing. This leads to a very long response time from the designation of the parameter by the user to the display of the processed image. In a case where the response time is long, a method of displaying a progress bar can be employed as a method of presenting the progress of the processing, as shown in Japanese Patent Laid-Open No. 2010-73014. The progress bar has an effect of reducing the discomfort of the user due to waiting, by providing a function which allows the user to check the degree of progress.

In a case where the user is made to designate a parameter for image processing of an unconventional concept, the user is made to perform a new operation. At this time, if no guideline is provided, the user may be confused about the parameter to be designated and an appropriate parameter may not be set.

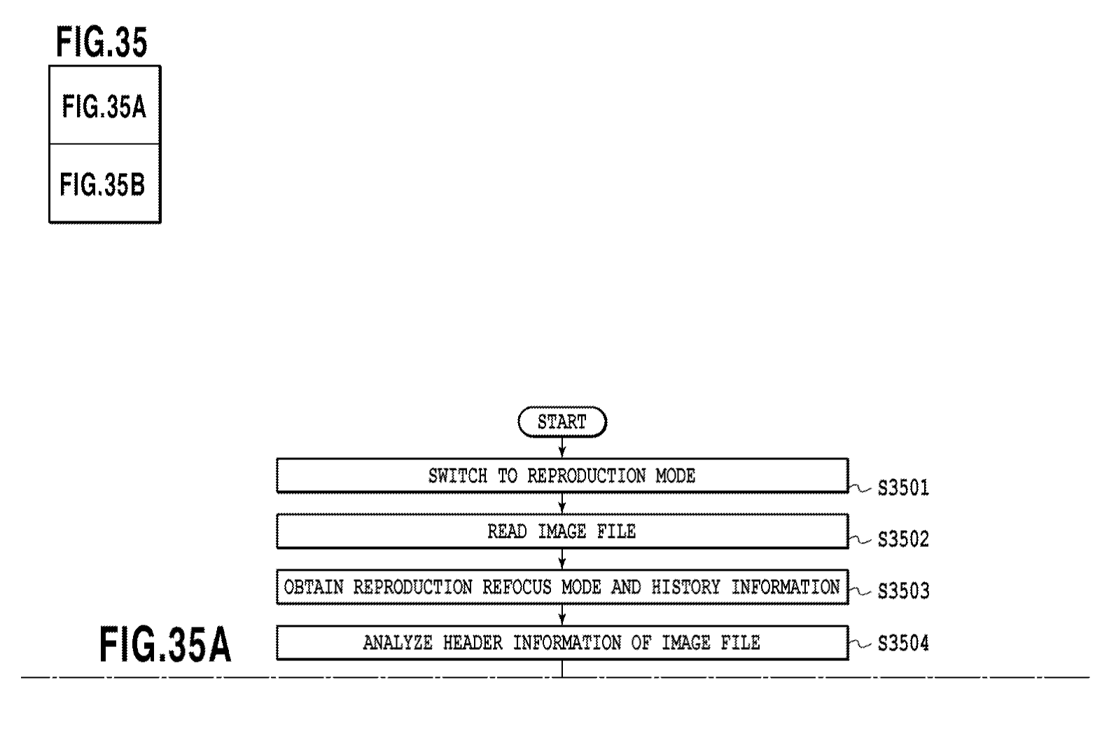

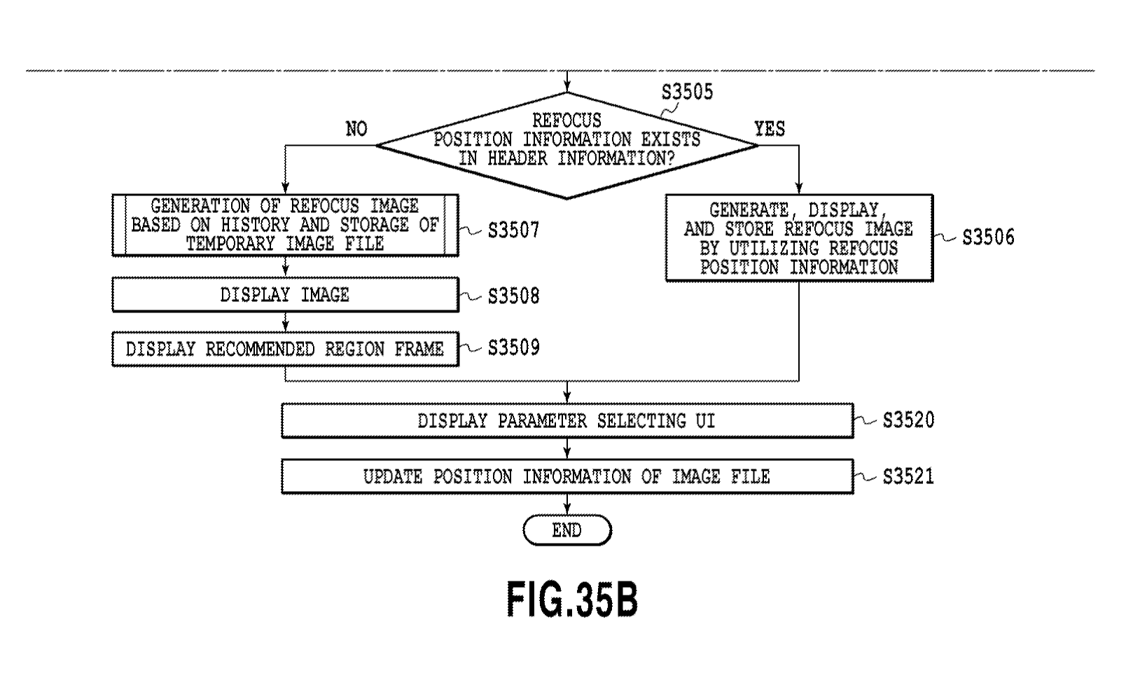

FIGS. 35A and 35B are a flowchart from transition to the reproduction mode to display of the first refocus image. Steps S3501 to S3504 are identical to steps S201 to S204 of FIG. 2 and description thereof is thereby omitted.

In step S3505, the overall-control unit 108 determines whether the refocus position information exists in the header information analyzed in step S3504. In a case where the refocus position information exists, the process proceeds to step S3506. In a case where no refocus position information exists, the process proceeds to step S3507. In the embodiment, the position information existence flag 805 shown in FIG. 8 is treated as a flag of one bit. In a case where the value of the flag is 1, the overall-control unit 108 determines that the refocus position information exists and causes the process to return to step S3506. In a case where the value of the flag is 0, the overall-control unit 108 determines that no refocus position information exists and causes the process to proceed to step S3507.

In step S3506, the overall-control unit 108 controls the refocus calculation unit 103 to generate apiece of refocus image data by utilizing the refocus position information obtained by analyzing the refocus position information 803 of an image file read in step S3502. The generation of the refocus image data utilizing the refocus position information is the same as that described in step S206 of Embodiment 1 and description thereof is thereby omitted.

In a case where no refocus position information exists in the header information in step S3505, the process proceeds to step S3507. Step S3507 is the same process as step S207 and description thereof is thereby omitted.

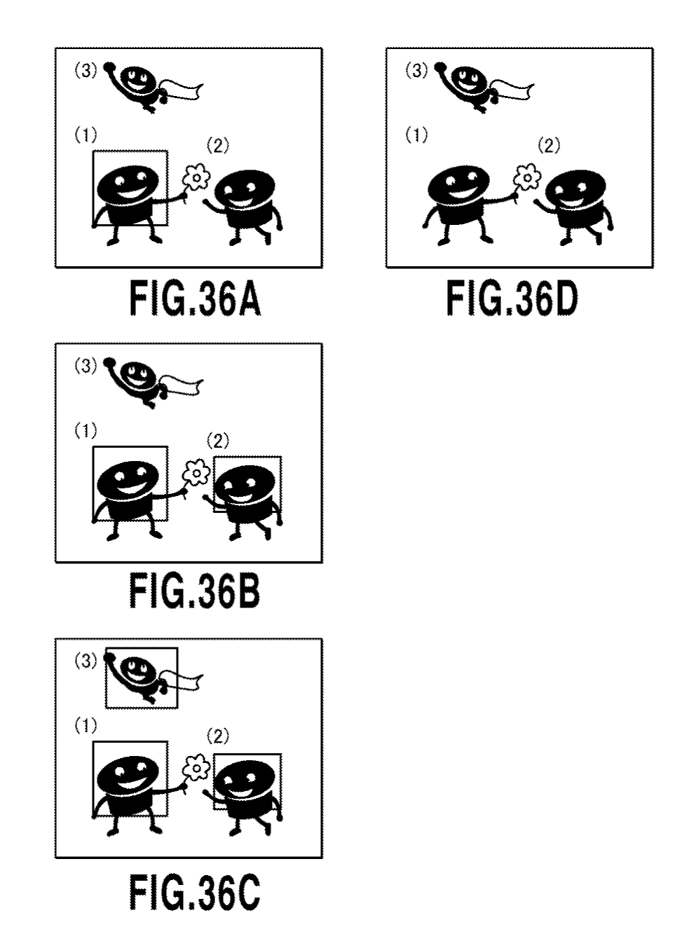

In step S3508, a refocused image generated by the graphic processor 104 in step S3507 is displayed on the display 105. In step S3508, the graphic processor 104 causes the display 105 to display a deep-focus image. For example, a deep-focus image in which all of the objects are in focus as shown in FIG. 36D is displayed on the display 105. However, the image to be control-displayed is not limited to the deep-focus image. The refocus image can be displayed if the refocus image has been already generated.

In step S3509, a recommended region displaying process is executed. In the embodiment, a recommended region is, for example, a rectangular region including an object candidate to be in focus and is expressed in coordinates of a top left point and a bottom right point in units of pixels in the image. The recommended region can be considered as the parameter designated by the user.

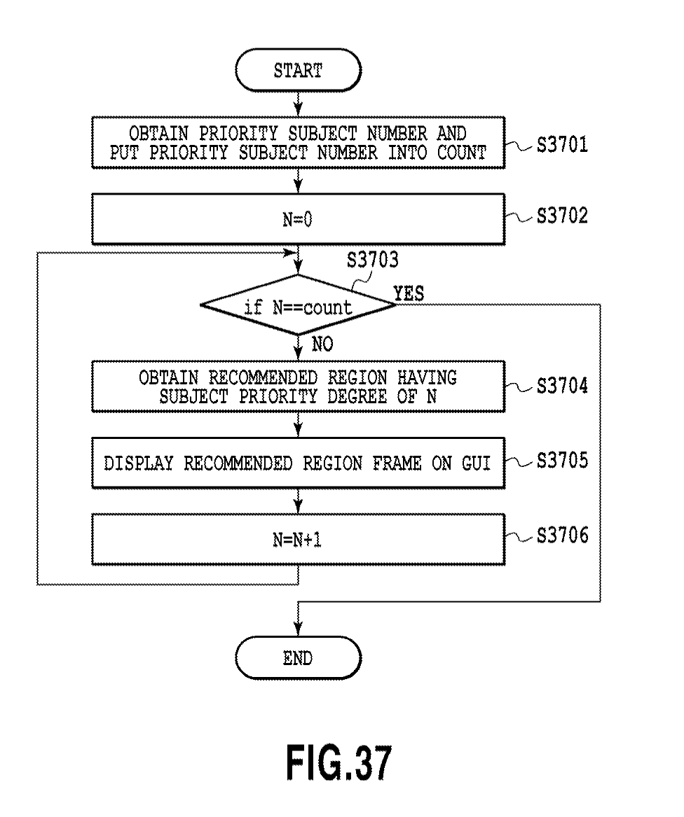

FIG. 37 is a flowchart describing an example of the recommended region displaying process. The recommended region displaying process is described below in detail.

In step S3701, the overall-control unit 108 obtains a priority object number and puts the priority object number into COUNT. The priority object number is generated in step S3507. Specifically, the priority object number is the number of objects in focus in a case where the refocus image data is generated based on the history information, for example. In the embodiment, description is given under the assumption that the priority object number is three. However, the priority object number is not limited to this.

In step S3702, the overall-control unit 108 initializes a counter N to 0. In step S3703, the overall-control unit 108 compares the counter N and the COUNT to each other. The process is terminated in a case where N>COUNT is satisfied and the process proceeds to step S3704 to continue a loop process in a case where % COUNT is satisfied.

In step S3704, the overall-control unit 108 obtains the recommended region having a predicted object priority degree of N. In the predicted object priority degree N, a smaller value of N indicates a higher degree of recommendation. The predicted object priority degree N is a degree of priority attached to an object having a high refocus frequency, on the basis of the history information.

In step S3705, the overall-control unit 108 controls the graphic processor 104 in such a way that a recommended region frame indicating the obtained recommended region is displayed on the screen of the display 105. A display example of the GUI is described below by using FIGS. 36A to 36D. In the embodiment, the recommended region is a rectangular region including the object. Accordingly, the recommended region frame is drawn in such a way that the rectangular region overlaps the displayed image. Note that, in the coordinate system of the recommended region, a pixel in the image is treated as a unit. Accordingly, in a case where the resolution of the display is lower than the resolution of the image, the rectangular region is subjected to scaling and is then drawn as the recommended region frame.

An image shown in FIG. 36D is displayed at the start of the recommended region displaying process as described in step S3508. Meanwhile, in a case where N=1 is satisfied, one recommended region frame is displayed on the image on the screen as shown in FIG. 36A. In the embodiment, the color of the frame is assumed to be red. In a case where N=2 is satisfied, the second recommended region frame is displayed as shown in FIG. 36B. In a case where N=3 is satisfied, the third recommended region frame is displayed as shown in FIG. 36C. As described above, rectangles are drawn one by one on objects which are candidates to be in focus, as the counter N increases in the loop process. The display order of the recommended region frames can be determined based on the history information as described above. In step S3706, the counter N is incremented and the process returns to step S3703. The loop process is thus executed.

In step S3520, the graphic processor 104 additionally displays the parameter selecting UI screen on the display 105. FIG. 6B shows an example in which the parameter selecting UI screen is added to the refocus image data displayed in step S3506. In the example of FIG. 6B, the user is assumed to designate a point desired to be in focus by using a touch panel. Specifically, the graphic processor 104 displays a UI screen by which the user can select the position (parameter) to be in focus. Note that the parameter may represent information of a two-dimensional position in the image or a spatial distance (depth) in the multi-viewpoint image.

Moreover, the parameter selecting UI screen including a message as shown in FIG. 6B is added also to the refocus image data for which the recommended region frame is displayed in step S3509. Since the recommended region frame is displayed in step S3509, a message prompting the user to select the region in the frame may be displayed.

In step S3521, the overall-control unit 108 updates the refocus position information 803 of the image file read in step S3502. Specifically, in a case where no refocus position information exists in the header information, the overall-control unit 108 updates the refocus position information 803 to the position information of the region including the refocus position determined in step S3507. In a case where the refocus position information exists in the header information, there is no need update the refocus position information 803 of the image file read in step S3502. This is the operation performed in the case where the reproduction mode is activated, i.e. the process related to the refocus image displayed first in the case where a certain image file is read.

Since processes of steps S3520 and S3510 can be the same as the processes of steps S209 and S210, description thereof is omitted. Moreover, since a process performed in a case where the parameters are selected can be the same process as the process described in FIG. 3, description thereof is omitted.

In the embodiment, displaying the recommended region which is the target to be in focus by using a rectangular frame allows the user to easily determine and designate the position to be in focus.

Moreover, in the embodiment, the refocus process for the region of the object likely to be selected by the user is executed in advance to the parameter selection by the user, on the basis of the history information. Combining the refocus process executed before the parameter selection by the user and the function of displaying the recommended region frame can prompt the user to select the recommended region frame. Accordingly, in the embodiment, in a case where the user selects the recommended region frame, the refocus image subjected to the refocus process in advance can be rapidly displayed.

In the embodiment, the predicted object priority degree N is the refocus frequency based on the history information. However, the predicted object priority degree N is not limited to this. For example, it is possible to perform face detection and set the degree of priority in the descending order of the area of the detected face region. Moreover, the image processing is not limited to refocus. For example, the image processing may be a selected region process for subjecting a selected region to a high-pass filter. Furthermore, although the recommended region frame is described as the position information of a rectangle indicating a region, the recommended region frame is not limited to this. For example, the shape of the recommended region frame may be a circle or any other shape.

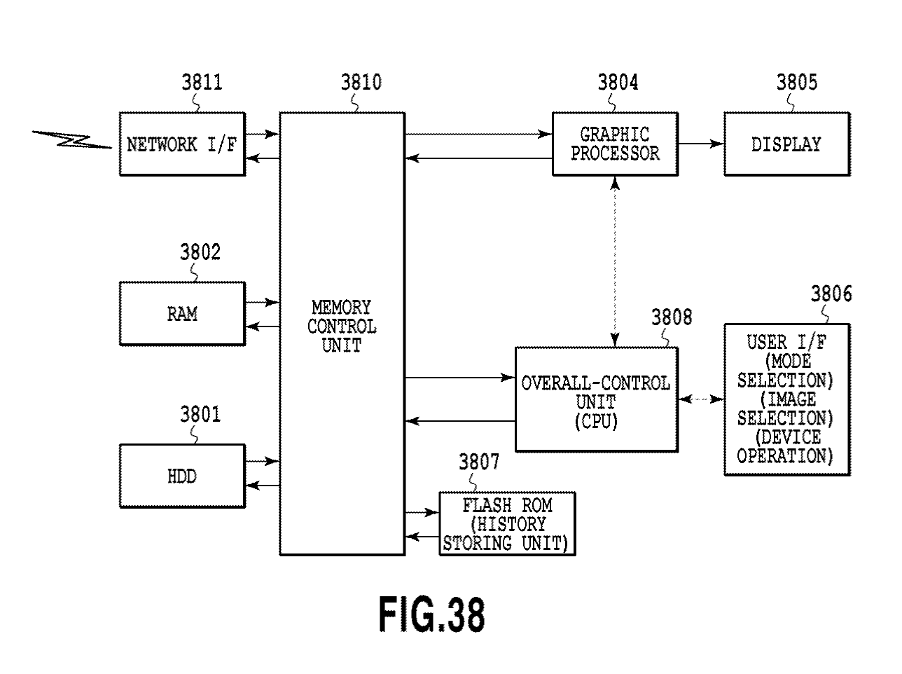

In the embodiment, the overall-control unit 108 of FIG. 1 is described as a unit for controlling the modules in FIG. 1. However, the hardware configuration for executing the processes is not limited. For example, the processes can be executed by a personal computer which is characterized to display the recommended region frame on a screen and which does not include the image capturing camera array unit 101, the refocus calculation unit 103, and the image analyzing unit 112. FIG. 38 is a block diagram showing a hardware configuration example of the personal computer. The configuration and operations thereof are the same as those of the hardware shown in FIG. 1 unless specifically stated otherwise. As shown in FIG. 38, a normal personal computer does not have the refocus calculation unit or the image analyzing unit described in FIG. 1. Accordingly, the refocus calculation process and the image analyzing process are executed by the overall-control unit 108. Moreover, the image file and the history information are stored in a HDD 3801 instead of the external memory and the history information storage unit.

### Embodiment 10

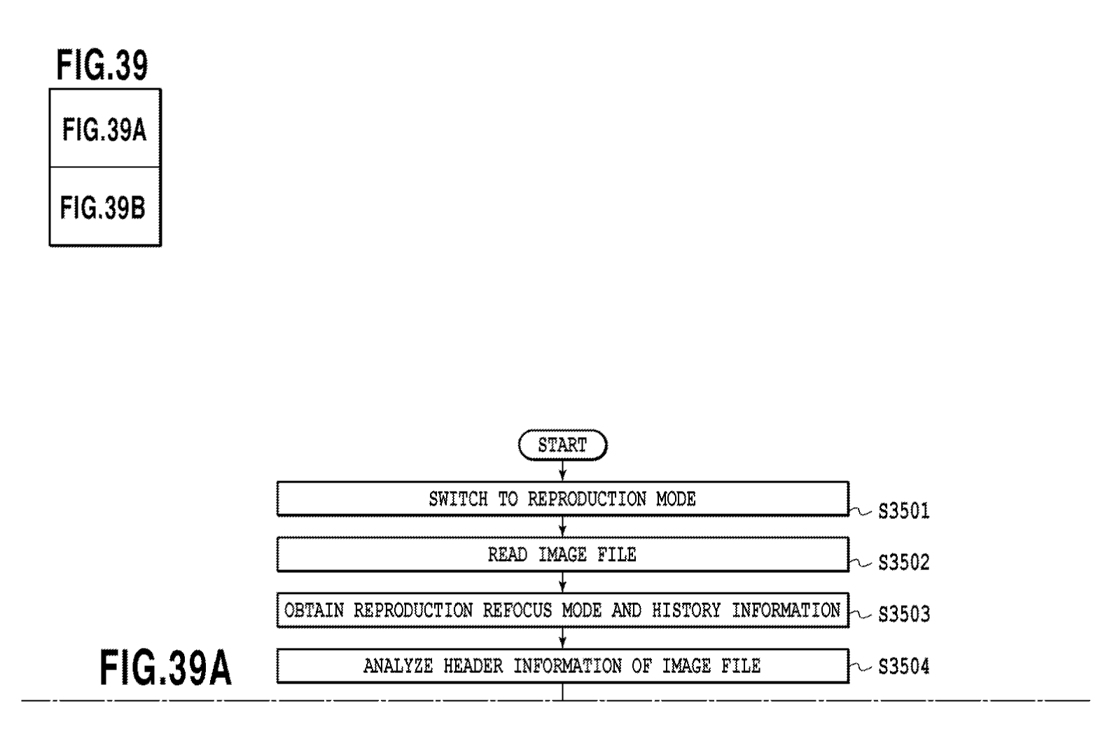

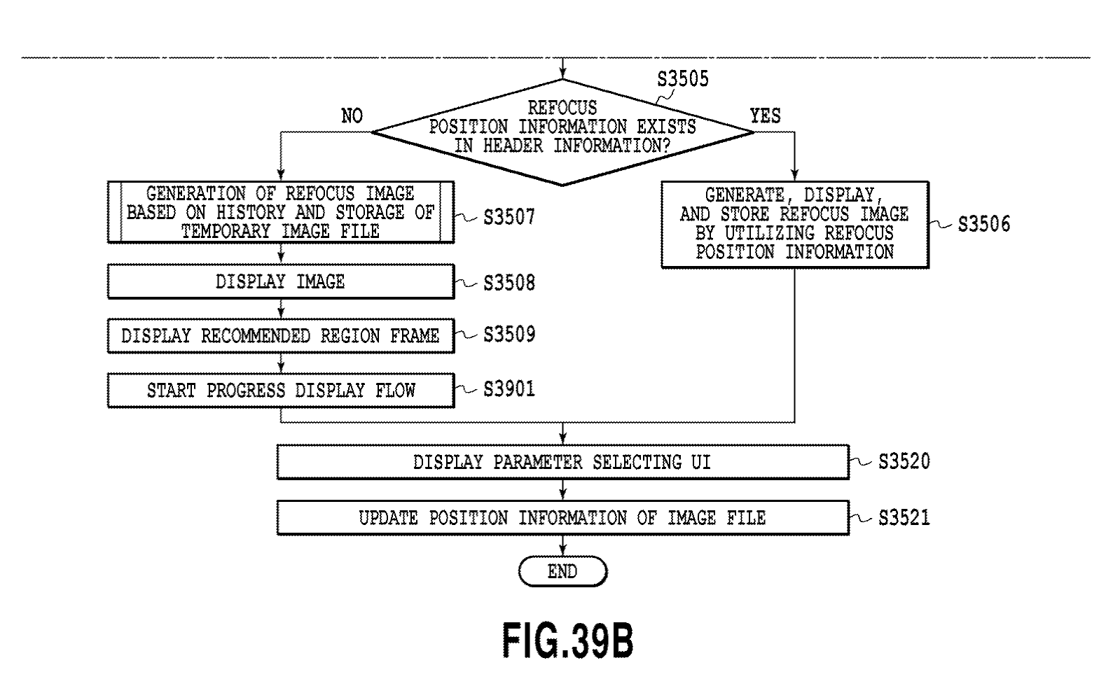

In Embodiment 10, description is given of a process in which the recommend region is displayed to bring a specific object in focus by the refocus process and then the refocus process is performed. Embodiment 10 is described by using FIGS. 39, 40, 41A to 41D, and 42A to 42D. The flowchart shown in the embodiment is described under the assumption that the flow is executed by the overall-control unit 108 of FIG. 1 and that the overall-control unit 108 implements processes in the flowchart by controlling the modules in FIG. 1. Processes similar to those in steps of Embodiment 9 are executed in the steps of Embodiment 10, unless specifically stated otherwise.

The flowchart of FIGS. 39A and 39B is described in detail. FIGS. 39A and 39B are a flowchart for explaining a modified example of the flow of FIGS. 35A and 35B. Step S3901 is added to the flow of FIG. 35B, subsequent to step S3509. Since other processes can be the same as those described in FIGS. 35A and 35B, description thereof is omitted.

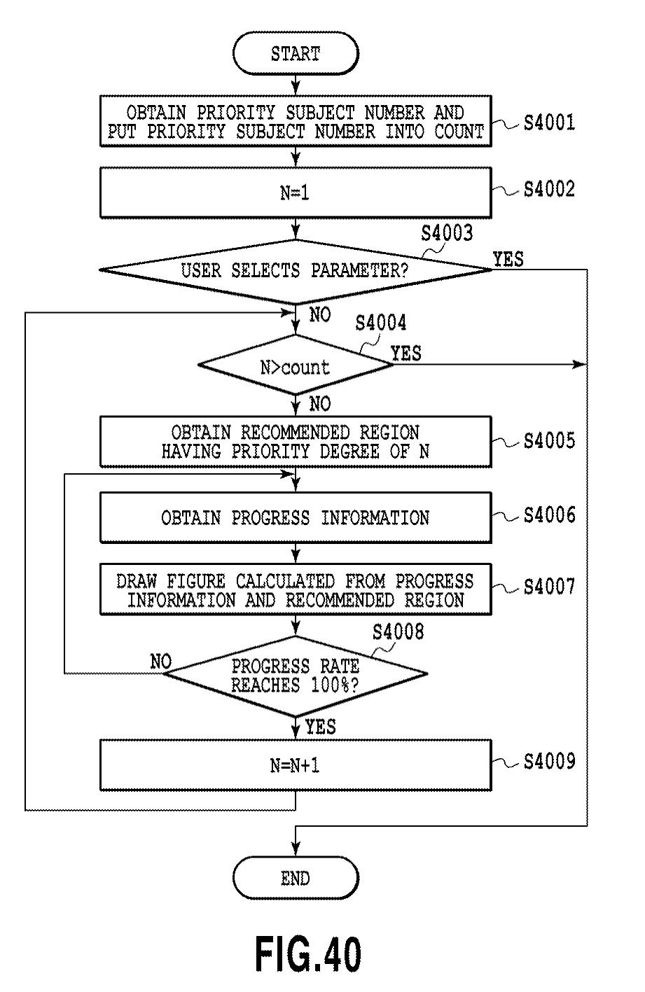

In step S3901, the overall-control unit 108 starts progress display. The progress display is executed in parallel to step S3520. In other words, the progress display and a piece of refocus image data generation process are executed in parallel. A flow of the progress display is described below by using FIG. 40.

FIG. 40 is a flowchart of synchronizing with the progress of image processing and emphatically displaying the recommended region. In step S4001, the overall-control unit 108 obtains the priority object number and puts the priority object number into COUNT. The priority object number is generated in step S3507. Specifically, the priority object number is the number of objects in focus in a case where the refocus image data is generated based on the history information, for example. In the embodiment, description is given under the assumption that the priority object number is three. However, the priority object number is not limited to this.

In step S4002, the overall-control unit 108 initializes a counter N to 1. In step S4003, the overall-control unit 108 determines whether the user selects a parameter. The parameter selection in the embodiment is achieved by the following operation. The user touches the display 105 and two-dimensional coordinates of the touched position in an image coordinate system are thereby obtained. The image coordinate system refers to a two-dimensional coordinate system in which one pixel in the image is treated as a numeric value of 1. In a case where the user selects a parameter, the flow of FIG. 40 is terminated.

In step S4004, the overall-control unit 108 compares the counter N and the COUNT to each other. The process is terminated in a case where N>COUNT is satisfied and the process proceeds to step S4005 to continue a loop process in a case where N≦COUNT is satisfied.

In step S4005, the overall-control unit 108 obtains the recommended region having the predicted object priority degree of N. The recommended region is generated in step S3507. In the embodiment, the recommended region is data indicating a rectangle showing a region of an object which is a candidate to be in focus, and is formed of two sets of coordinate data respectively of a top left point and a bottom right point in a two-dimensional coordinate space of the inputted image. Moreover, in the predicted object priority degree N, a smaller value of N indicates a higher degree of recommendation.

In step S4006, a progress information obtaining process of obtaining a progress rate of the refocus process in percentage is performed. In the embodiment, the progress rate can be expressed as:

R=(C−S)/T×100

where R represents the progress rate, T represents an average time which is required to generate one piece of refocus image data and which has been obtained in advance, S represents a refocus process start time, and C represents a current time. Moreover, in the embodiment, it assumed that the overall-control unit 108 includes a timer and the refocus process start time and the current time are obtained from the timer. However, the timer can be disposed outside the overall-control unit.

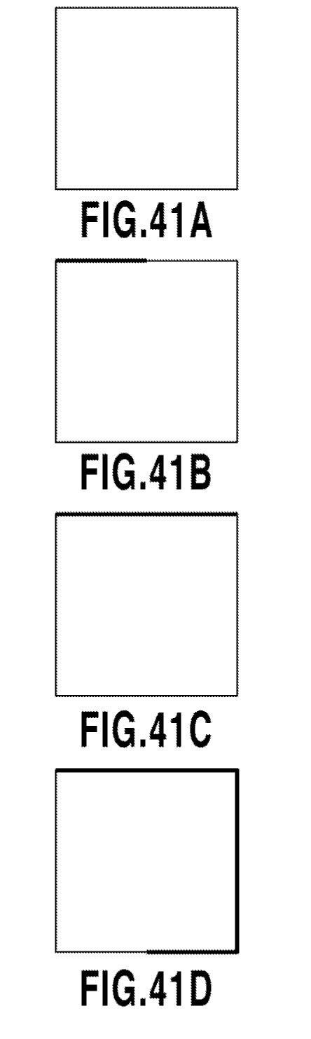

In step S4007, a figure calculated from the progress information and the recommended region is drawn. In the embodiment, the progress is expressed as follows. A red rectangle is displayed and a green line is drawn to overlap the red rectangle in such a way that the green line starts from a top left corner of the rectangle and completes circling the four sides of the rectangle at the point where the progress rate reaches 100%. For example, FIG. 41A shows a state where the progress rate is 0%. Note that, a fine line represents a red line. FIG. 41B shows a state where the progress rate is 12.5%. Here, a bold line represents a green line. FIG. 41C shows a state where the progress rate is 25%. FIG. 41D shows a state where the progress rate is 62.5%. As described above, the green line circles the rectangle indicating the recommended region and the color of the rectangle thereby changes from red to green. The progress state of the refocus process can be thus expressed. The color of the frame completely changing to green means that the generation of the refocus image with the focus on this region is completed.

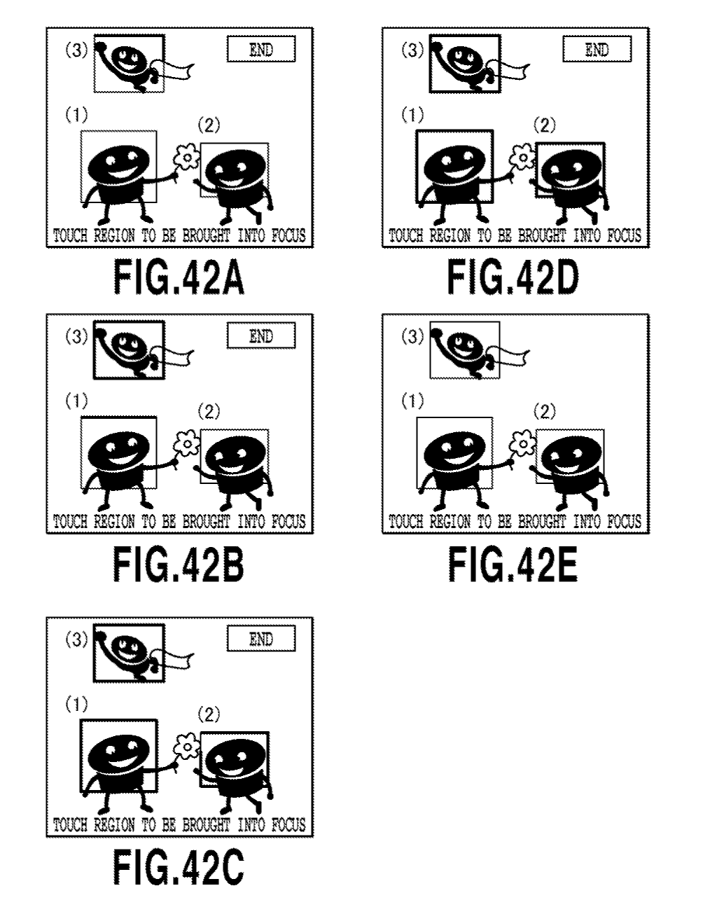

A screen display example is described in FIGS. 42A to 42E. FIGS. 42A to 42E are views for explaining a GUI-screen display example. In the embodiment, since the recommended region is shown as the rectangular region, the recommended region frame is drawn such that the recommended region in a form of rectangle overlaps the image. For example, FIG. 42E shows an initial state of the screen. The rectangle indicating the recommended region displayed at this stage is red. FIG. 42A shows a state where N=1 is satisfied and the progress rate is 40%. A bold line of the rectangle is assumed to be a green line. FIG. 42B shows a state where N=2 is satisfied and the progress rate is 25%. FIG. 42C shows a state where N=3 is satisfied and the progress rate is 90%. FIG. 42D shows that the regions of all of the objects presented by the recommended parameters are surrounded by the green rectangles, and is a state where the flow is terminated. Each of the drawn green rectangles becomes closer to completion along with an increase in the progress rate of the process of generating the refocus image data of the object being the target. The number of green rectangles increases along with an increase in the counter N.

In step S4008, the progress rate is determined. In a case where the progress rate reaches 100%, the process proceeds to step S4009. In a case where the progress rate has not reached 100%, the process returns to step S4006 and the loop process of displaying the progress continues.

In step S4009, the counter N is incremented and the process proceeds to step S4004. The loop process is thus executed the number of times equal to the number of priority objects.

Compared to Embodiment 9, in Embodiment 10, the recommended region frame is displayed in such a way that the color thereof changes in accordance with the progress of the refocus image generation process which is executed in parallel to the display. Thus, the user can pay attention on the change of color (animation) of the frame and this has an effect of reducing the psychological waiting time. Moreover, the display operation of the recommended region frame also serves as the progress display. Accordingly, unlike a general method of displaying a progress bar in an end portion of the screen, the user is not required to move his/her sight from the object at the screen center and a GUI which the user feels comfortable can be provided.

The embodiment has a configuration in which the progress rate is obtained from an elapsed time. However, the configuration is not limited to this. For example, in a case where an algorithm for generating the refocus image in units of pixels is used, the progress rate can be obtained from the number of generated pixels and the number of pixels in the entire image. Moreover, in the embodiment, description is given of an example in which the progress rate is expressed by the change of color. However, other visual changes such as changing the shape of the line and changing the shape of the recommended region frame can be used.

In the embodiment, the overall-control unit 108 of FIG. 1 is described as a unit for controlling the modules in FIG. 1. However, the hardware configuration for executing the processes is not limited. For example, the processes can be executed by a personal computer which is characterized to display the recommended region frame on a screen and which does not have the image capturing unit, the refocus calculation unit, and the image analyzing unit. FIG. 38 is a hardware configuration block diagram of the personal computer. The configuration and operations thereof are the same as those of the hardware shown in FIG. 1, unless specifically stated otherwise. Note that a normal personal computer does not have the refocus calculation unit or the image analyzing unit. Accordingly, the refocus calculation process and the image analyzing process are executed by the overall-control unit 108. Moreover, the image file and the history information are stored in the HDD 3801 instead of the external memory and the history information storage unit.

### Embodiment 11

In a case where image data expressing a refocused combined image is generated, an enormous calculation cost is required. Accordingly, in a case where image data obtained in response to an instruction given by the user to perform the refocus process is not image data suitable for a captured image scene, the refocus process needs to be performed again and an additional calculation cost is required.

In the embodiment, the refocus image suitable for the captured image scene can be displayed by using feedbacks from viewers on the network and the convenience of the user can be thereby improved.

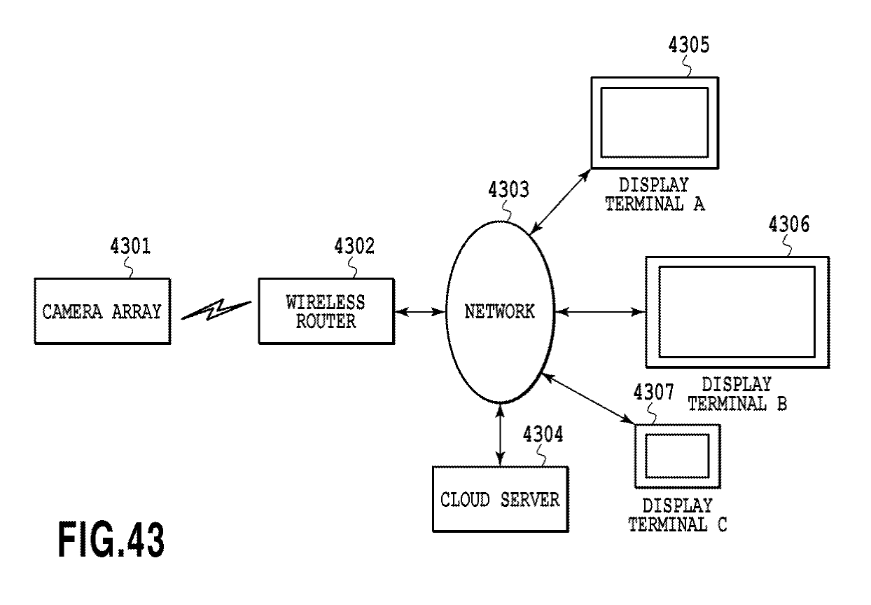

FIG. 43 is a block diagram showing a system connection configuration example of an image reproduction system.

A camera array 4301 is an image capturing apparatus (system) configured to obtain multi-viewpoint image data by capturing pieces of image data based on information obtained from multiple viewpoints.

A wireless router 4302 is an apparatus connected to the camera array 4301 through wireless communication and configured to perform relay communication between the camera array 4301 and the network. Although, description is given of an example using the wireless router, the router may be connected through a wire.

A network 4303 is a network used to achieve communication connection between the wireless router 4302 and other apparatuses such as a cloud server 4304.

The cloud server 4304 is an apparatus which stores the multi-viewpoint image data captured by the camera array 4301 and various parameters corresponding to the multi-viewpoint image data, and which executes image processing in cooperation with various apparatuses connected thereto over the network 4303. The processing operation of the cloud server is described later in detail.

A display terminal A 4305 is a display terminal used to display and browse the image data stored in the cloud server 4304. In the embodiment, the display terminal A 4305 is a personal computer (referred to as PC in the description hereafter). Moreover, it is assumed that a display of the display terminal A 4305 has a display resolution of WXGA (1280×800)

A display terminal B 4306 is a display terminal used to display and browse the image data stored in the cloud server 4304, like the display terminal A 4305. In the embodiment, the display terminal B 4306 refers to a large-screen television or the like which has a high resolution and is a display terminal having a display with a resolution equal to full high definition (1920×800) (this resolution is referred to as FULL_HD in the description below).

A display terminal C 4307 is a display terminal used to display and browse the image data stored in the cloud server 4304, like the display terminal A 4305 and the display terminal B 4306. In the embodiment, the display terminal C 4307 is a mobile display terminal whose resolution is not high. In the description, it is assumed that the resolution of the display terminal C 4307 is WVGA (854×480).

Each of the display terminals are merely an example and may have a display resolution other than the resolution described herein.

An example of the hardware configuration inside the camera array 4301 can be the same as the configuration shown in FIG. 1. Since the configurations are the same as those in Embodiment 1, the description thereof is omitted.

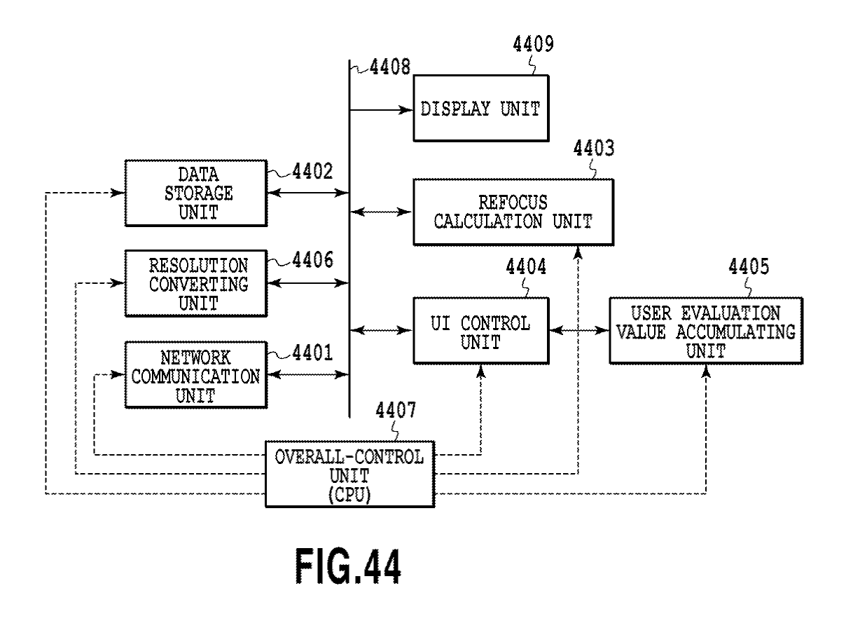

Next, description is given of FIG. 44 which a block diagram showing an example of the configuration inside the cloud server 4304.

FIG. 44 is a block diagram showing an example of the configuration inside the cloud server. In the embodiment, the cloud server can be referred to as an image distributing apparatus.

A network communication unit 4401 establishes communication between the cloud server and the apparatuses connected to the network 4303. Moreover, the network communication unit 4401 releases the image data to the public in such a way that the image data can be browsed via the network. A physical connection mode of the network communication unit 4401 is not limited. Since the network communication unit 4401 may be connected to the network wirelessly or via a wire, the connection mode can be any mode as long as the connection is possible in terms of protocol.

A data storage unit 4402 stores multi-viewpoint image data captured by the camera array 4301, via the network communication unit 4401. Moreover, the data storage unit 4402 stores various types of information and the image data processed in the cloud server. Contents of processes performed in the cloud server and the various types of information are described later.

A refocus calculation unit 4403 performs the refocus calculation process on the multi-viewpoint image data stored in the data storage unit 4402 and generates refocus image data. The refocus calculation unit 4403 performs the same processes as the refocus calculation unit 103.

A UI control unit 4404 performs control so that the user can perform a UI (stands for user interface and is referred to as UI in the description below) operation on the image display terminals connected to the cloud server via the network. Moreover, the UI control unit 4404 controls units inside the cloud server in response to an operation instruction from the user.

A user evaluation value accumulating unit 4405 accumulates the operations of the user as evaluation values in accordance with the result of the UI control unit 4404. The user evaluation value is described later.

A resolution converting unit 4406 performs a process of converting the resolution of each piece of image data stored in the data storage unit 4402 in such a way that the resolution of the image data suits the resolution of the display mounted on each of the image displaying device and the camera array connected to the cloud server via the network.

An overall-control unit (CPU) 4407 controls the entire cloud server apparatus. A bus interface 4408 is a bus interface for exclusively switching the blocks in the cloud server apparatus and causing the blocks to operate. A display unit 4409 is a display unit for operation display performed in a case where the cloud server is directly operated.

In the configuration described above, the multi-viewpoint image data captured by the camera array 4301 is stored in the data storage unit 4402 of the cloud server 4304. Moreover, predetermined ID code information and a thumbnail image of the multi-viewpoint image data which are used to display the multi-viewpoint image on the display terminals for browsing are also stored in the data storage unit 4402. An ID code refers to, for example, a user ID and is used to determine whether the user making the request of image reproduction is a manager or not. The details will be described later. Since a method of uploading the multi-viewpoint image data captured by the camera array 4301 to the cloud server is a publicly known technique, no particular description thereof is made herein.

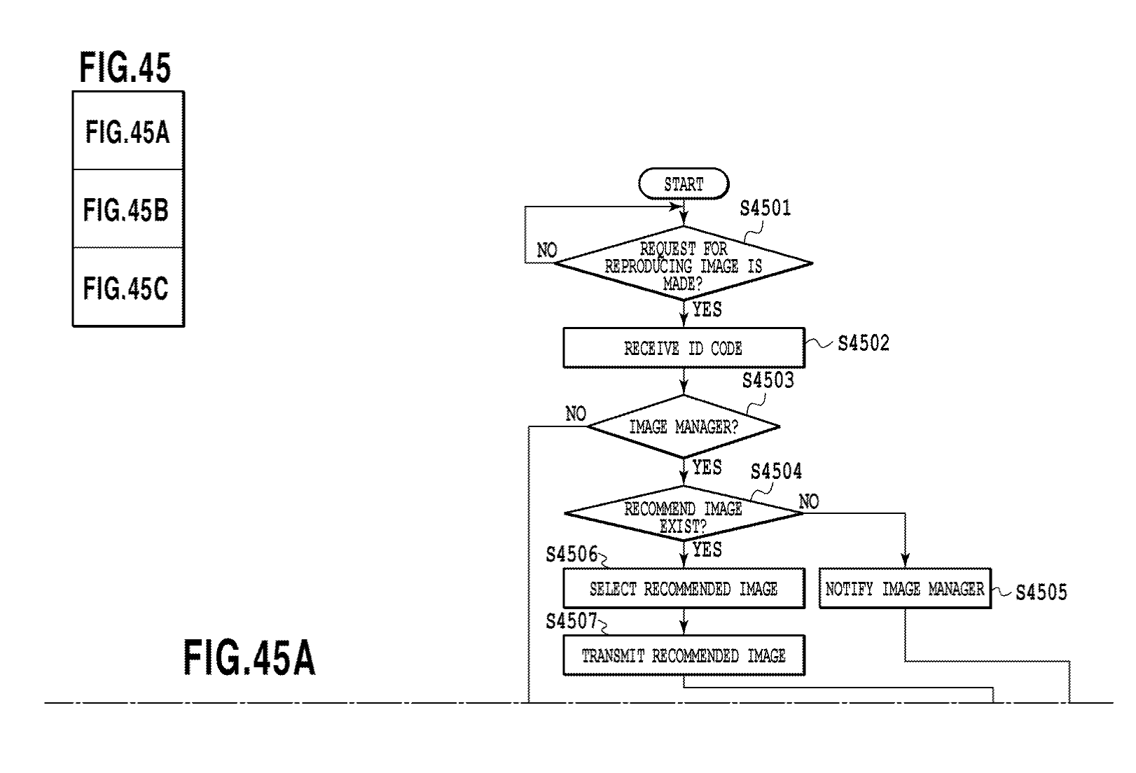

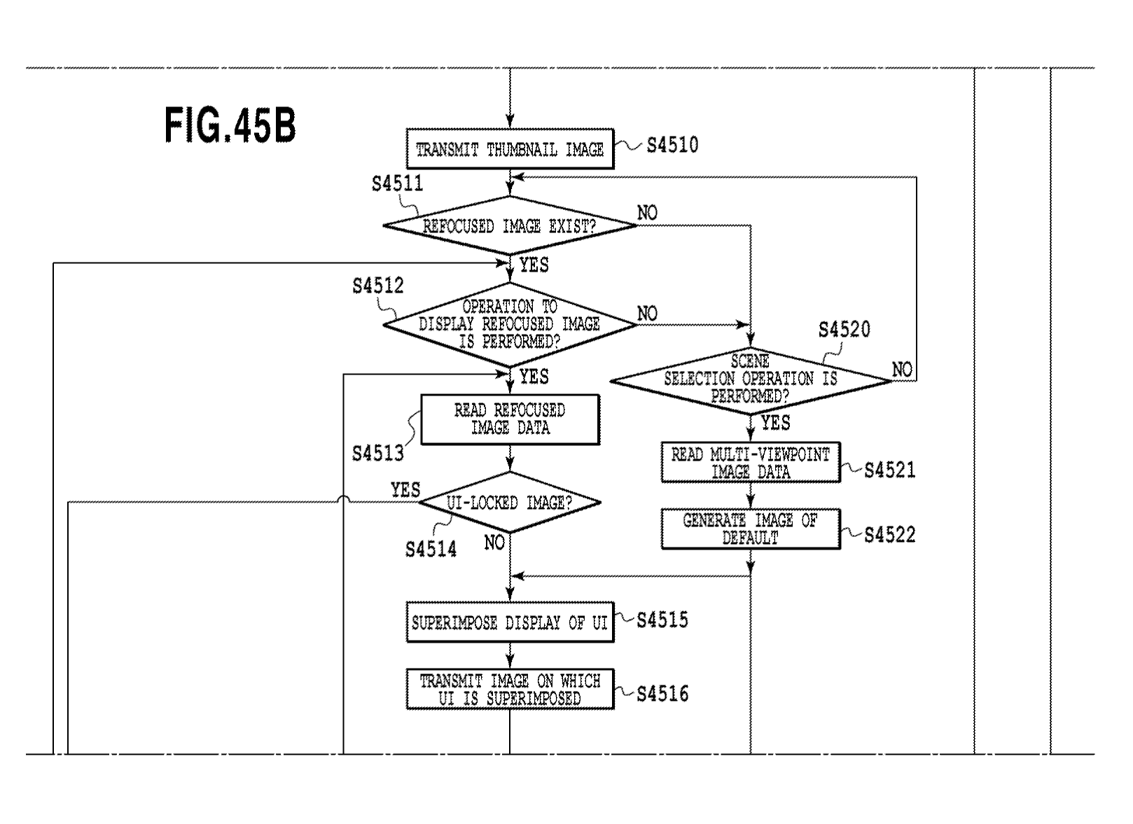

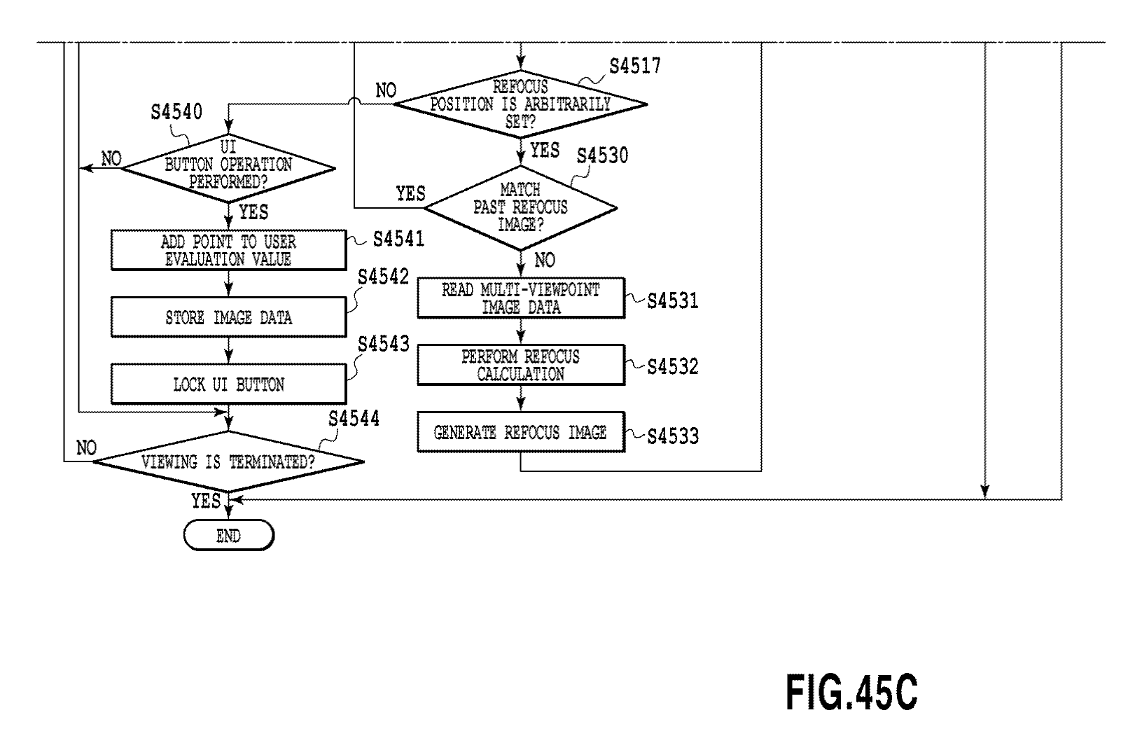

Next, the characteristics of the embodiment are described by using the flowchart of FIGS. 45A to 45C. FIGS. 45A to 45C are the flowchart of the cloud server 4304. The process shown in FIGS. 45A to 45 C are performed by the overall-control unit 4407 executing a program stored in the data storage unit 4402.

After a sequence starts, in step S4501, the overall-control unit 4407 determines whether a request command for reproducing and displaying the multi-viewpoint image data captured by the camera array 4301 is received from any of the display terminals A 4305, B 4306 and C 4307. In a case where no request command for image reproduction is made via the network communication unit 4401, the cloud server 4304 is set to awaiting state in this routine. In a case where the request command for image reproduction is received via the network communication unit 4401, the process proceeds to step S4502.

In step S4502, the cloud server 4304 receives the ID code of the user via the network 4303. In step S4503, the overall-control unit 4407 determines whether the ID code received in step S4502 matches the ID code of the manager who captured the image data for which the reproduction request is made in step S4501. As described above, the ID code of the manager is stored in, for example, the data storage unit 4402 in advance. In a case where the overall-control unit 4407 determines that the person making the request is the manager of the image, the process proceeds to step S4504. In a case where the overall-control unit 4407 determines that the person making a request is not the manager of the image, the process proceeds to step S4510.

In step S4504, the overall-control unit 4407 determines whether there is a desired and refocus-calculated recommended image data for the image manager. The recommended image data refers to a refocus-calculated image data associated with the user evaluation value. The details will be described later. In a case where there is the refocus-calculated recommended image data, the process proceeds to step S4506. In a case where there is no refocus-calculated recommended image data, the process proceeds to step S4505. In step S4505, a notification that there is no recommended image data to be displayed is made and the process is terminated.

In step S4506, the overall-control unit 4407 selects the refocus-calculated recommended image data, and reads the recommended image data stored in the data storage unit 4402. In step S4507, the refocus-calculated recommended image data read in step S4506 is transmitted to the request source via the network communication unit 4401.

Meanwhile, in step S4510, in a case where the overall-control unit 4407 determines that the person making the request is not the manager of the image, a thumbnail image data is read from the data storage unit 4402 and is transmitted to the display terminal of the request source. In step S4510, multiple pieces of thumbnail image data corresponding to multiple scenes can be transmitted.

In step S4511, the overall-control unit 4407 determines whether a different user has already stored image data refocus-calculated for a certain position in the image, for the image displayed in thumbnail. This determination is made by, for example, determining whether a piece of refocus image data associated with the piece of image data displayed in thumbnail exists in the data storage unit 4402. In a case where the refocused image data is already stored, the process proceeds to step S4512. In a case where no refocused image data is stored yet (i.e. an operation for the image data is performed for the first time), the process proceeds to step S4520.

In step S4520, the overall-control unit 4407 determines whether an operation of selecting a captured image scene which the user desires to view is made by the user in a state where the thumbnail images are displayed on the display terminal. The captured image scene refers to a scene of the image expressed by the multi-viewpoint image data captured by the camera array 4301 at a certain time point. For example, the multi-viewpoint image data captured by the camera array 4301 while changing the time point or the viewpoint includes captured image scenes different from each other. In a case where the captured image scene selection operation is made, the process proceeds to step S4521. In a case where no captured image scene selection operation is made, the process returns to step S4511.

In step S4521, the multi-viewpoint image data of the selected captured image scene is read from the data storage unit 4402. Next, in step S4522, the refocus image data with the focus on a default position set in advance is generated by using the multi-viewpoint image data read in step S4521.

Next, description is given of a process performed in a case where the overall-control unit 4407 determines in step S4511 that the refocus-calculated image data is stored. In step S4512, the overall-control unit 4407 determines whether there is an operation from the user which is related to display of a refocused image corresponding to a certain refocus position among the images displayed in thumbnail. For example, the determination is made depending on whether the network communication unit 4401 receives an operation command from the display terminal having made the reproduction request of the image in step S4501. In a case where the thumbnail image is selected by the user in step S4512, the overall-control unit 4407 determines that the operation to display the refocus image data corresponding to the selected thumbnail image is performed. The overall-control unit 4407 determines that the operation by the user is performed in the following case. In a state where the thumbnail image is already selected, the user selects the refocused image data related to the selected thumbnail image. In a case where the operation is performed, the process proceeds to step S4513. In a case where no operation is performed, the process proceeds to step S4520.

In step S4513, the overall-control unit 4407 reads, from the data storage unit 4402, the refocused image data corresponding to the thumbnail image selected through the operation in step S4512. Note that, in a case where the thumbnail image is selected in step S4512, the following process may be performed. Specifically, in a case where there is the multiple pieces of refocused image data corresponding to the selected thumbnail image (captured image scene), the refocused image data with the highest evaluation value can be read to be displayed in a main window, as will be described later.

In step S4514, the overall-control unit 4407 determines whether the refocused image data read in step S4513 is a locked refocused image data. Specifically, the overall-control unit 4407 determines whether the read refocused image data is image data for which evaluation by the viewer identified by the user ID received in step S4502 is completed and which is locked so that an UI operation for the evaluation cannot be performed again. Such determination is performed by, for example referring to a table in which an image ID, the user ID, and presence or absence of the evaluation are associated with each other. In a case where the image is not locked yet to prohibit the UI operation, the process proceeds to step S4515. In a case where the image is already locked to prohibit the UI operation, the process proceeds to step S4544.

In step S4515, the UI control unit 4404 superimposes a display of an operation button as the UI, on the refocused image data generated in the process up to this step. The superimposed operation button is a button for giving the user evaluation value. In step S4516, the overall-control unit 4407 transmits the image data on which the operation button is superimposed in step S4515, to the display terminal requesting the image reproduction in step S4501.

In step S4517, the overall-control unit 4407 determines whether the user has set, as the refocus position, a certain position which is different from the refocus position of the image currently displayed on the display terminal, in a state where the user is browsing the image which is transmitted in step S4516 and on which the UI operation button is superimposed. For example, in a case where the network communication unit 4401 receives a request to change the refocus position from the display terminal requesting the reproduction of the image in step S4501, the overall-control unit 4407 determines that the refocus position is arbitrarily set. In a case where a position other than the refocus position corresponding to the current displayed image is arbitrarily set as the refocus position, the process proceeds to step S4530. In a case where no refocus position is arbitrarily set, the process proceeds to step S4540.

In step S4530, the overall-control unit 4407 determines whether refocused image data for which an operation has been made in the past on the same position as the arbitrarily-set refocus position is stored in the data storage unit 4402, the operation made by an unspecified user who is different from the user currently viewing the image. In a case where the image data for which an operation has been made in the past on the refocus position is stored, the process returns to step S4513. In a case where no such image data is stored, the process proceeds to step S4531.

In step S4531, the overall-control unit 4407 reads the multi-viewpoint image data of the same captured image scene from the data storage unit 4402. In step S4532, the refocus calculation unit 4403 performs the refocus calculation process of the multi-viewpoint image data read in step S4531. In step S4532, a process of bringing the position set in step S4517 in focus is performed. In step S4533, the overall-control unit 4407 generates the image data having the different refocus position on the basis of the refocus calculation process result obtained in steps S4532. Then, the process proceeds to step S4515 described above.

Meanwhile, in a case where the overall-control unit 4407 determines in step S4517 that the refocus position is not arbitrarily set, the overall-control unit 4407 determines in step S4540 whether an action operation is made in the display terminal requesting the image reproduction, for the UI button superimposed in step S4515. For example, the overall-control unit 4407 determines that the action operation is made in a case where the network communication unit 4401 receives an input command to the UI button, from the display terminal requesting the reproduction of the image in step S4501. The action operation refers to, for example, a request to update the user evaluation value from the display terminal requesting the reproduction of the image in step S4501. In a case where the action operation is made, the process proceeds to step S4541. In a case where no action operation is performed, the process proceeds to step S4544.

In step S4541, the overall-control unit 4407 adds one point to the user evaluation value of the refocused image for which operation is made in the S4540. The user evaluation value expresses the degree of recommendation in the currently-browsed captured image scene. In step S4542, the overall-control unit 4407 stores the image data of the currently displayed image in the data storage unit 4402. In a case where there is the same refocused image data for which the refocus has been performed in the past for the same position in the data storage unit 4402, the storing process is not performed. The process can be changed depending on whether the refocused image data is read in step S4513.

In step S4543, the overall-control unit 4407 locks the UI button superimposed on the image data so that no operation can be performed. Moreover, the overall-control unit 4407 updates superimposed image data in such a way that the contrast of the displayed UI button becomes low. Specifically, the overall-control unit 4407 generates lock image data in which the image data having the updated evaluation value is prohibited from being update again, and transmits the lock image data. In step S4544, the overall-control unit 4407 determines whether the user terminates the viewing. In a case where the viewing is terminated, the process is terminated. In a case where the viewing is continued, the process returns to step S4512.

Description is given below of examples of contents of operation and images displayed on the display terminals in a case where the processes are executed in the order of the system control flowchart of FIGS. 45A to 45C.

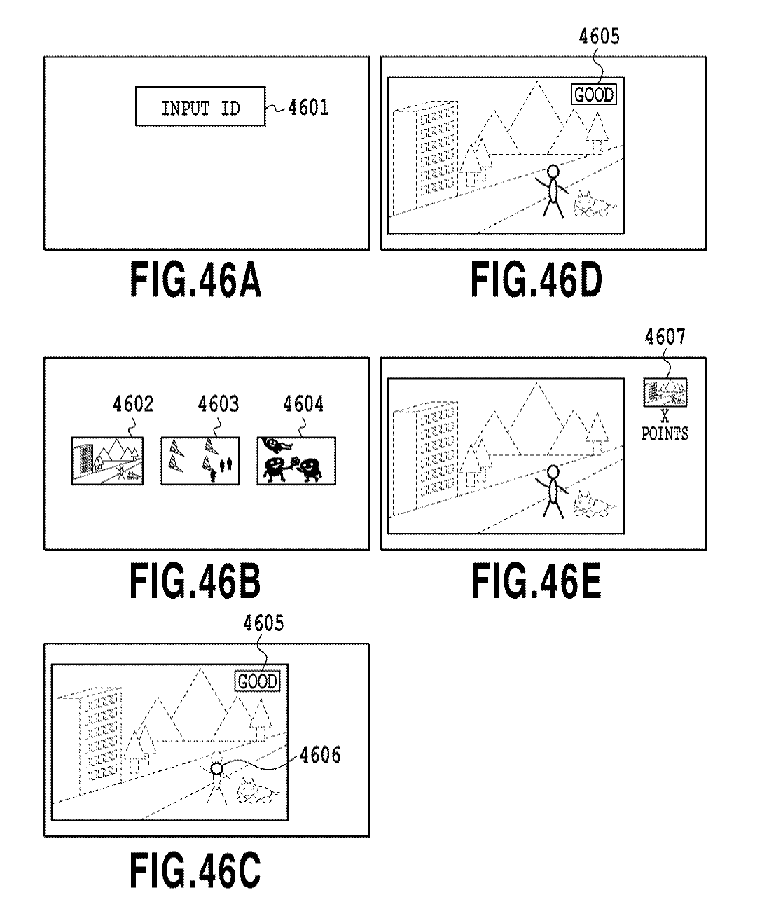

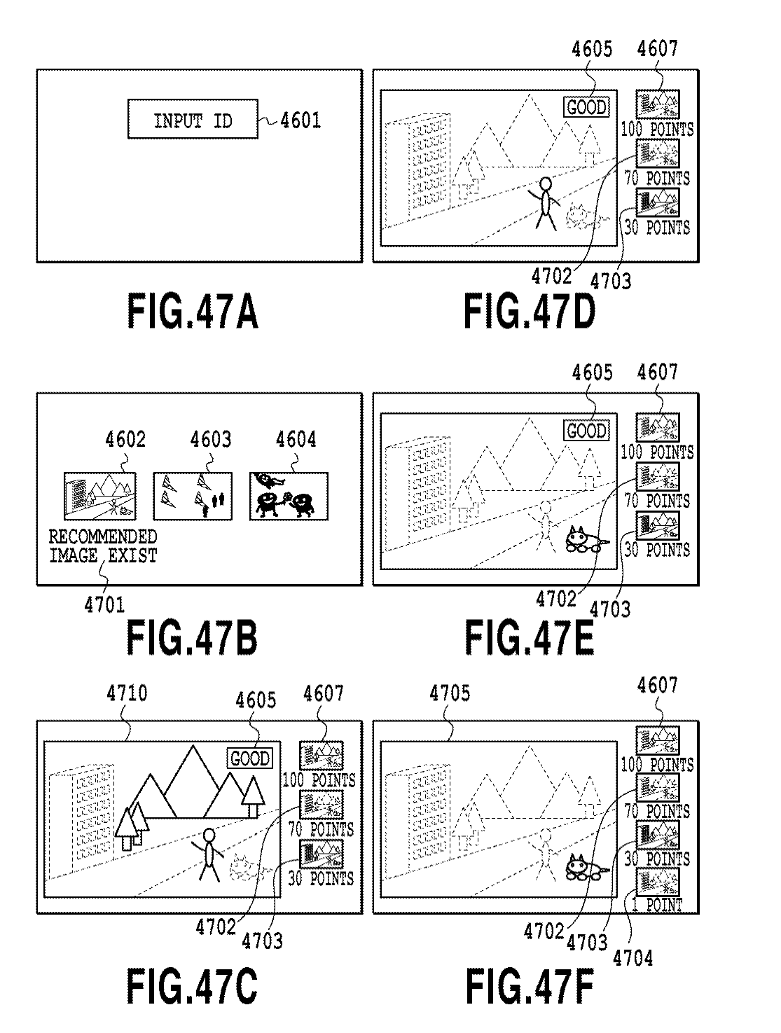

First, the PC which is the display terminal A 4305 of FIG. 43 among the display terminals used by unspecified people desiring to browse the image accesses the cloud server 4304. The contents of screens displayed on the display terminal A 4305 in this case are described by using FIGS. 46A to 46E and FIGS. 47A to 47F.

[Example of Display in Initial State where User Operation by Unspecified People has not been Made Yet]

FIGS. 46A to 46E are examples of display in an initial state where the user operation from unspecified people has not been made yet. First, a screen of FIG. 46A is displayed on the display terminal A 4305 and a user ID input screen appears. After the user ID is inputted from the display terminal A 4305, the next screen is displayed. The flow up to this point corresponds to the flow from step S4501 to NO in step S4503.

Next, as shown in FIG. 46B, the thumbnail images of multiple captured image scenes 4602, 4603, and 4604 are displayed in such a way that the contents thereof can be recognized at a glance. This corresponds to step S4510 of FIG. 45B.

Next, in a case where the user desires to view the image of the captured image scene 4602, the user clicks the thumbnail image of the captured image scene 4602 by using the display terminal A 4305 and the screen of FIG. 46C is thereby displayed. Since the display terminal is described as the PC, the user is described to perform the click operation in this case. However, the operation to the display terminal is not limited to this and the user can perform a tap operation using a touch panel, a selection operation using an infrared remote controller, or the like. This is the same for click operations in the following description.

FIG. 46C shows a screen displayed on the display terminal A 4305 which is obtained by generating the refocused image data with the focus on the refocus position determined from the refocus parameter set in advance and then superimposing an UI operation button 4605 on the generated refocused image data. A first image which is a default image in this case can be displayed by various methods. For example, it is possible to refer to the past operation history of the user specified from the ID received in step S4502 and display the refocus image data suiting the operation history. Specifically, in a case where the user has viewed images with the focus on people many times in the past, the refocused image data with the focus on the region specified as people in the multi-viewpoint image data can be generated and displayed. Moreover, in a case where a reproduction mode such as a person mode or a background mode is set by the user, the refocused image data with the focus on the region corresponding to the set mode can be generated and displayed. Alternatively, the image data for which the focus position is determined by another method can be generated and displayed. The flow up to this point corresponds to the process flow from step S4520 (YES) to step S4516 of FIG. 45B.

Next, in a case where the user desires to arbitrarily designate the refocus position different from that of FIG. 46C and clicks, for example, a point of a circle 4606, the refocus process is performed in a different condition for the first time. The overall-control unit 4407 and the refocus calculation unit 4403 perform the refocus calculation corresponding to the point of the circle 4606 by using the multi-viewpoint image data corresponding to this scene to generate the refocus image data again. In the case of FIG. 46C, the refocused image data expressing an image with the focus on a person like the image shown in FIG. 46D is generated. The flow up to this point corresponds to the process flow from step S4530 (NO) to step S4516 of FIGS. 45B and 45C via step S4533.

In a case where the user viewing the image thinks that the generated image is good, the user clicks the UI operation button 4605 on the image of FIG. 46D. The overall-control unit 4407 detects the click of the UI operation button and increments, by one point, the user evaluation value of this captured image scene which is accumulated in the user evaluation value accumulating unit 4405. Then, the image data is stored. Thereafter, the screen of FIG. 46E is displayed and the UI button is hidden. In the example, a person who has logged in by using a certain user ID for a certain captured image scene cannot perform the following UI operations again for the same captured image scene with the same user ID. Specifically, the person with the same user ID cannot perform an UI operation for storing the same refocused image and other refocus images with the focus on the different positions or an UI operation for adding the evaluation point for these images. The flow up to this point corresponds to the process flow from step S4540 (YES) to step S4543.

[Example of Display in Case where Image Data Refocused Through Operations by Unspecified Users Already Exist]

FIGS. 47A to 47F show examples of display in a case where a plurality pieces of image data generated refocused through operations by unspecified users already exist. First, the contents of the screen display of FIG. 47A are the same as that described in FIG. 46A.

Next, the thumbnail images of the multiple captured image scenes 4602, 4603, and 4604 are displayed in such a way that the contents thereof can be recognized at a glance. In this case, since the pieces of refocused image data which are the recommended images already exist for the captured image scene 4602, “recommended image present” denoted by reference numeral 4701 is displayed below the thumbnail image of the captured image scene 4602. Next, in a case where the user desires to view the image of the captured image scene 4602, the user clicks the thumbnail image of the captured image scene 4602 and the screen of FIG. 47C is thereby displayed.

In this example, a refocus generation operation is performed in the past and ranks of the recommend images are determined based on the accumulation results of the user evaluation value points. In FIG. 47C, the refocused image data with the most user evaluation value points among the recommended images is read and displayed with the UI operation button 4605 superimposed thereon. This corresponds to a screen 4710 of FIG. 47C. Moreover, the thumbnail images displayed on the right side of the screen 4710 are displayed in the descending order of points. A thumbnail image 4607 is a thumbnail image of the refocused image which is the same as a TOP image of the screen 4710 and which has received 100 points. A thumbnail image 4702 is a thumbnail image having received the second most points of 70. A thumbnail image 4703 is a thumbnail image having received the third most points of 30. The flow herein corresponds to the process flow from steps S4511 (YES) to step S4512 (YES), to step S4514 (NO), and then to step S4516.

FIG. 47D shows a case where the viewing user selects the thumbnail image 4702 with the second most points. Moreover, FIG. 47E shows an example in which a new refocused image having not yet received the evaluation value point is displayed in response to touch of the screen of FIG. 47C by the viewing user. In a case where the user thinks that this image is a good image and clicks the UI operation button 4605, a new user evaluation value of the captured image scene which is incremented by one point and an image 4705 shown in FIG. 47F are stored. Then, the screen of FIG. 47F is displayed. A thumbnail image 4704 of the stored image 4705 is additionally displayed and the UI button is hidden at the same time. This flow corresponds to step S4517 (YES) to step S4530 (YES), to step S4517 (YES), and then to step S4543.

Note that the image for which the UI operation button 4605 has been clicked once by a certain viewer is set such that the same viewer cannot click the UI operation button. However, it is possible to display another refocused image for which the UI operation button has not been clicked and display the UI operation button in a superimposed manner for the image if the viewer feels that the image is a good image. Then, the user evaluation value point can be incremented by one for the other refocused image in a case where the UI operation button is clicked.

### [Example of Case Where Image Manager Displays Recommended Image]

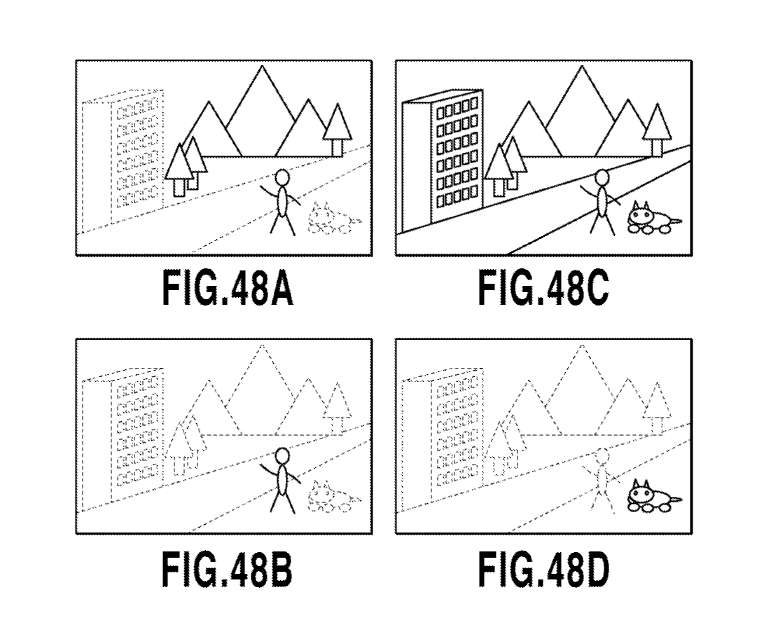

In a case where the image manager views the images from a display terminal with a resolution not so high, like the display terminal C 4307 of FIG. 43, the image data corresponding to a target captured image scene is displayed in full screen right after the reception of the ID code for browsing. Specifically, the overall-control unit 4407 transmits the image data in such a way that the image with the most user evaluation value points, which is considered to be a good image by many unspecified viewers, is displayed as the recommended image. This corresponds to the process flow from step S4503 (YES) to step S4504 (YES) and then to step S4507 of FIG. 45A. For example, the image of FIG. 48A is transmitted as the image data for full-screen display. Moreover, the image with the second most evaluation points which is shown in FIG. 48B, the image with the third most evaluation points which is shown in FIG. 48C, and the image with the fourth most evaluation points which is shown in FIG. 48D are sequentially transmitted to the display terminal in this order. In the display terminal, the images are displayed in the order of reception.

In a case where the image is displayed and browsed in high resolution in apparatuses such as the PC 4305 and the FULL_HD display terminal 4306 of FIG. 43, the recommended image and the thumbnail images which are described by using FIGS. 46A to 46E and FIGS. 47A to 47F can be simultaneously displayed in the order of the user evaluation value. The method of displaying the recommended image in accordance with the order of the user evaluation value is not limited to this.

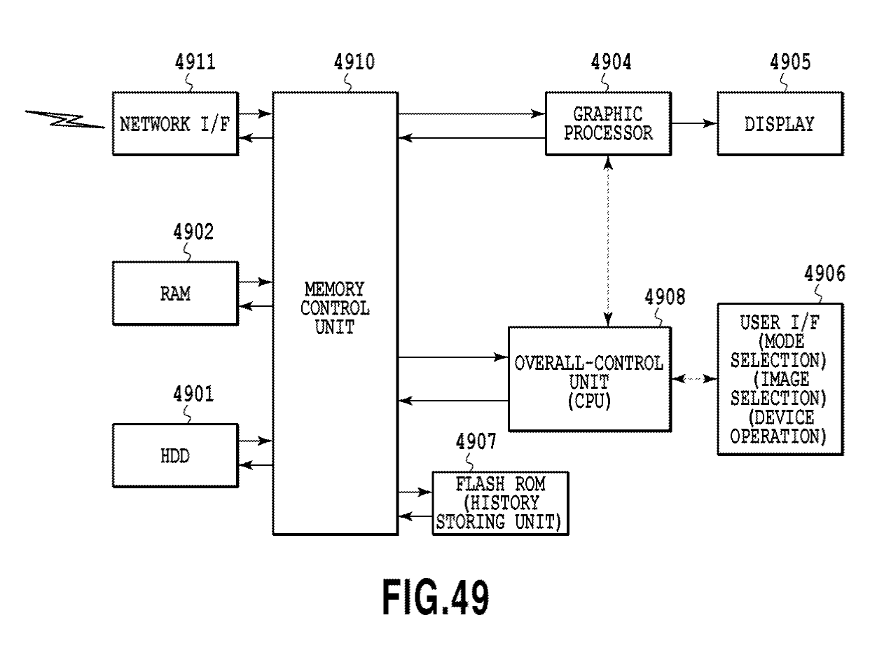

Next, processes performed in the display terminal are described. FIG. 49 is a view showing an example of blocks in the display terminal. An overall-control unit 4908 controls the display terminal. The overall-control unit 4908 receives an operation instruction from a user I/F 4906 and then transmits information to the cloud server via a network I/F 4911. Moreover, the overall-control unit 4908 receives the image data from the cloud server via the network I/F 4911. The overall-control unit 4908 displays the received image data on a display 4905 via a graphic processor 4904.

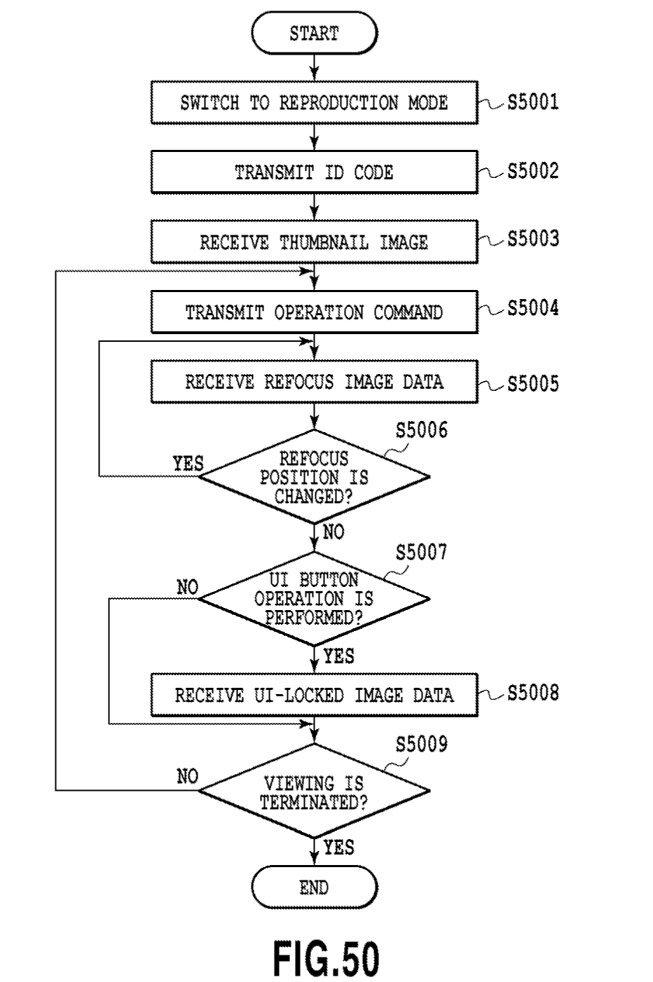

FIG. 50 is a view showing an example of the flowchart of the display terminal. The process shown in FIG. 50 is implemented by the overall-control unit 4908 executing a program stored in, for example, a RAM 4902.

In step S5001, the overall-control unit 4908 switches to a reproduction mode. Next, in step S5002, the overall-control unit 4908 transmits the ID code of the user to the cloud server, together with a reproduction request of the image (first transmission process). Next, the overall-control unit 4908 receives the image data expressing the thumbnail image from the cloud server.

In step S5004, the overall-control unit 4908 transmits an operation command to the cloud server. The operation command includes a command of selecting the captured image scene, a command of selecting an arbitrary refocused image data, and the like.

In step S5005, the overall-control unit 4908 receives the refocused image data and displays the refocused image data n the display. In step S5006, the overall-control unit 4908 determines whether the user has inputted an instruction to change the refocus position through the user I/F 4906. In a case where the overall-control unit 4908 determines that the instruction to change the refocus position is inputted, the change instruction is transmitted to the cloud server and the process returns to step S5005. In a case where the overall-control unit 4908 determines that no instruction to change the refocus position is inputted, the process proceeds to step S5007.

In step S5008, the overall-control unit 4908 determines whether the UI button operation through the user I/F 4906 is made by the user. Specifically, the overall-control unit 4908 determines whether there is an input of an operation by the user which is related to evaluation of the refocused image data received in step S5005. In a case where the UI button operation is made, the instruction of this operation is transmitted to the cloud server (second transmission process). Then, in step S5008, the overall-control unit 4908 receives the UI-locked image data. In a case where no UI button operation is made, the step S5008 is skipped.

In step S5009, the overall-control unit 4908 determines whether the viewing in the reproduction mode is terminated. In a case where the viewing is not terminated, the process returns to step S5004 and is continued.

The configuration described above enables generation of the refocused image data suitable for the image capturing scene and incorporating opinions of photo enthusiasts around the world, without any special function provided in the display apparatus in the embodiment. Accordingly, the embodiment has such effects that unnecessary refocus calculations can be omitted and the convenience of the user is improved.

Moreover, the image incorporating opinions of other people can be viewed. Accordingly, the unexpected image data which is different from the intention of a photographer can be obtained.

Although the embodiment has been described by using the reproduction process as an example, the image processing is not limited to refocus. For example, the embodiment may be used for a region selection process for subjecting a selected region to a high-pass filter.

Moreover, in the embodiment, description is given only of an example in which the evaluation value is incremented. However, the configuration may be such that the user can decrement the evaluation value in a case where the user thinks that the refocused image data is a bad image. Specifically, the configuration may be as follows. In FIG. 46D, a figure of “BAD” is drawn beside the figure marked “GOOD”, and the evaluation value is decremented in a case where “BAD” is selected. A process of updating the evaluation value in such a way may be employed.

Furthermore, in the embodiment, the cloud server is considered to be a single apparatus. However, the processes performed in the cloud server may be distributed to and processed in multiple servers.

### Embodiment 12

In Embodiment 11, the evaluation values given to the image in a case where unspecified viewers think that the image is a good image are all the same value. In Embodiment 12, description is given of an example in which the evaluation values of favorite viewers are set to be higher by changing the weighting of the evaluation value of specific viewers. On the other hand, the evaluation values of disfavored viewers can be set to be lower.

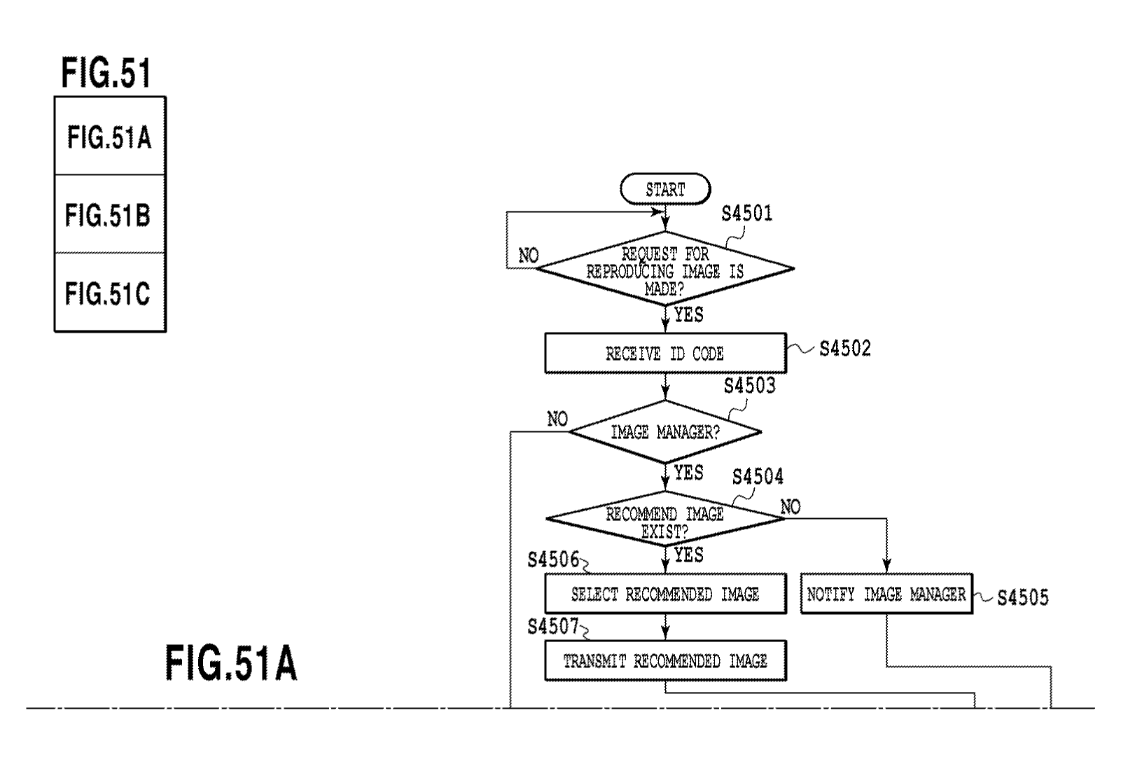

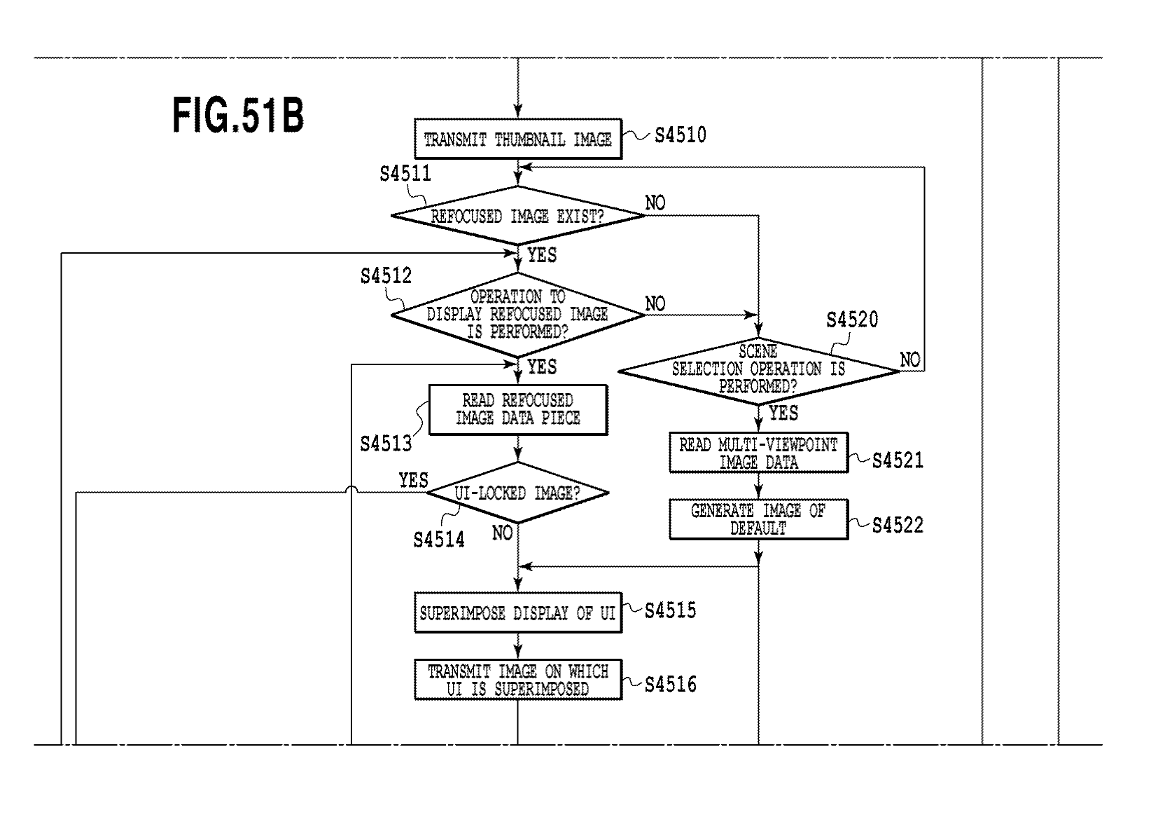

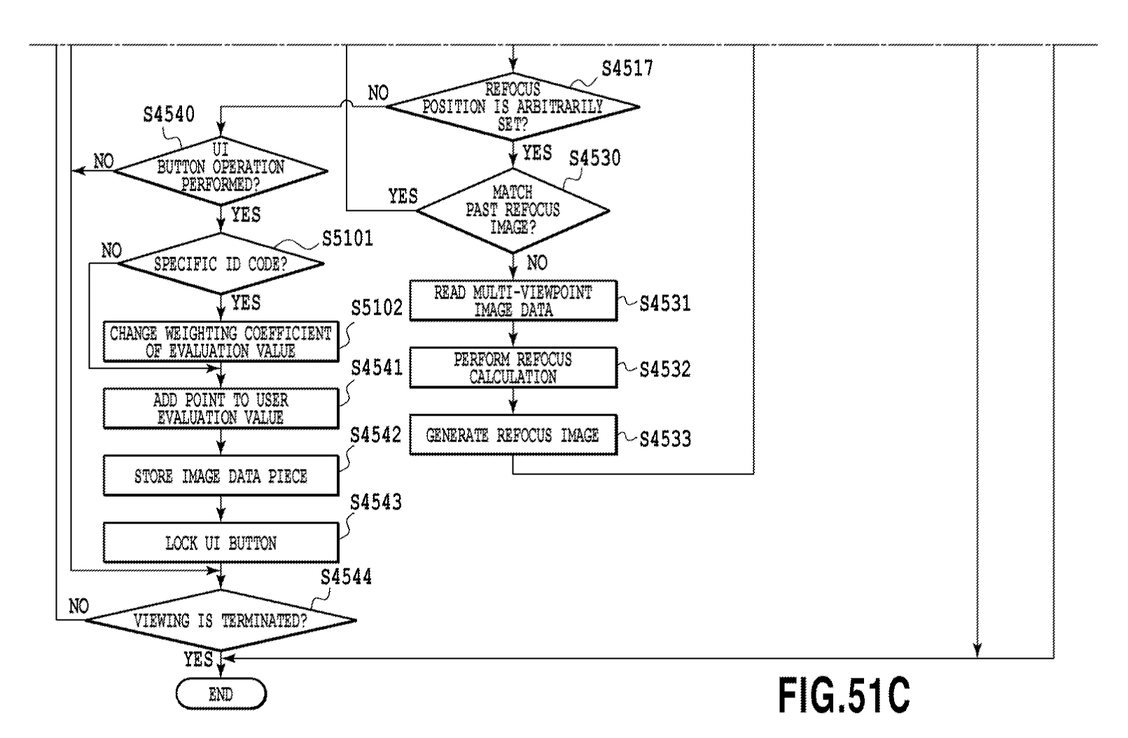

A process of the embodiment is described below by using the flowchart of FIGS. 51A to 51C. FIGS. 51A to 51C are different from the flowchart of FIGS. 45A to 45C only in that the steps S5101 and S5102 are added. Contents of processes in other steps are the same as the contents described in Embodiment 11.

In step S5101, the overall-control unit 4407 determines whether the user requesting for reproduction of the image in step S4501 is a specific user, from the ID code inputted in step S4502. In a case where the overall-control unit 4407 determines that log-in is performed by using a specific ID code in step S4502, the process proceeds to step S5102. In a case where the overall-control unit 4407 determines that the ID code is not the specific ID code, the process proceeds to step S4541.

In step S5102, the overall-control unit 4407 of FIG. 44 controls the user evaluation value accumulating unit 4405 to change the weighting of the evaluation value corresponding to the ID code inputted in step S4502 and thereby determine the evaluation value. For example, points per click may be set as follows:

User A: 200 points
User B: 100 points
User C: 0.5 points
Unspecified general users: 1 point.
[Example of Display in a Case where Image Refocused Through Operation by Unspecified User Exists]

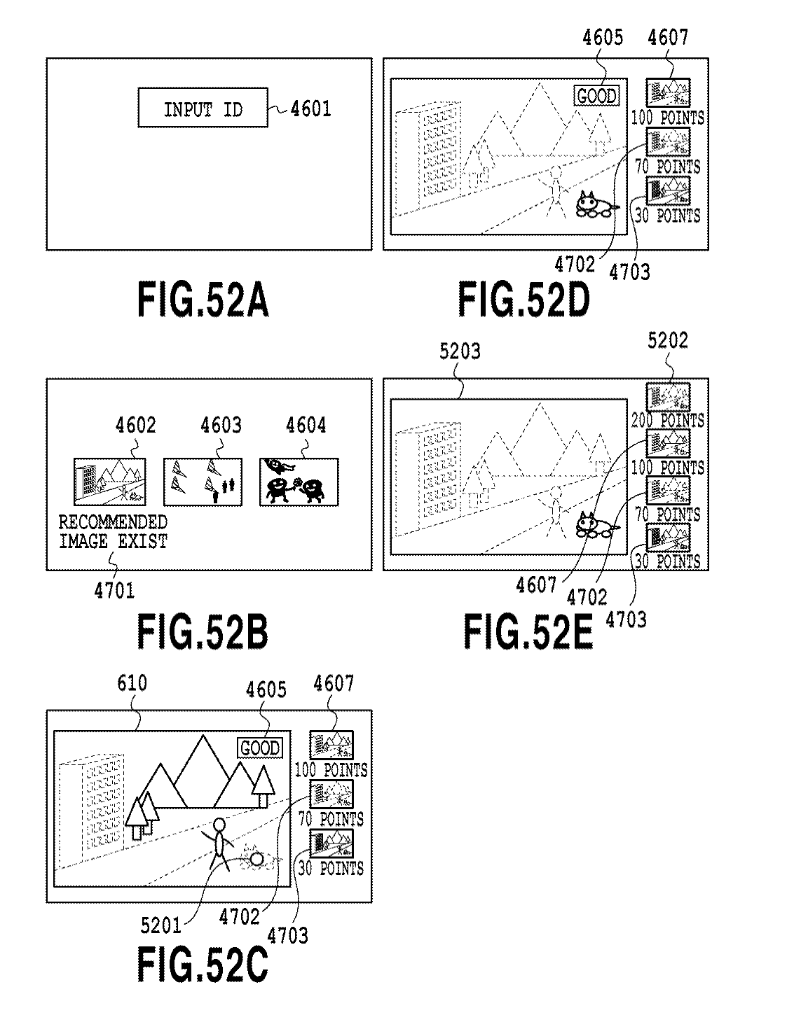

Next, description is given of an example of display in a case where the weighting of the evaluation value is changed for the specific user, by using FIGS. 52A to 52E. First, contents of description related to screen display of FIG. 52A are the same that described in FIG. 46A. Next, as shown in FIG. 52B, thumbnail images of multiple captured image scenes 4602, 4603, and 4604 are displayed in such a way that the contents thereof can be recognized at a glance. In this case, since refocused generated images which are the recommended images already exist, “recommended image present” denoted by reference numeral 4701 is displayed below the thumbnail image 4602. Next, in a case where the user desires to view the image of 4602, the user clicks the thumbnail image 4602 and the screen of FIG. 52C is thereby displayed.

In the screen of FIG. 52C, the refocus generation operation is performed in the past and ranks of the recommend images are determined based on the accumulation results of the user evaluation value points. The images are displayed in accordance with the determined ranks. Specifically, the refocused image with the most user evaluation value points is read and displayed with the UI operation button 4605 superimposed thereon. Moreover, the thumbnail images displayed on the right side of the refocused image are arranged and displayed in the descending order of points. A thumbnail image 4607 is a thumbnail image of a TOP image which has received 100 points. A thumbnail image 4702 is a thumbnail image having received the second most points of 70. A thumbnail image 4703 is a thumbnail image having received the third most points of 30. The flow herein corresponds to the process flow from steps S4511 (YES) to step S4512 (YES), and then to step S4516.

FIG. 52D shows an example in which a new refocused image having not yet received the evaluation value point is displayed at a point where the user A, who is a specific viewer and who is viewing the image, touches a portion of the screen displaying a circle in a region 5201 of FIG. 52C. In a case where the user A thinks that this image is a good image and clicks the UI operation button 4605, a new user evaluation value of the captured image scene is incremented by 200 points and an image 5203 shown in FIG. 52E is stored.

Next, the screen of FIG. 52E is displayed. A thumbnail image 5202 is additionally displayed at the first position and the UI button is hidden at the same time.

Similarly, in a case where the operation is performed by the user B, the user evaluation value is incremented by 100 points. Moreover, in a case where the operation is performed by the user C, the user evaluation value is incremented by 0.5 points. The thumbnail images are arranged and displayed in the descending order of points of the evaluation values which have been incremented by points.

### [Example of Case Where Image Manager Displays Recommended Image]

In a case where the image manager views the image, the image corresponding to a target captured image scene is displayed in full screen right after the reception of the ID code for browsing. As described above, the displayed image is selected as follows. The image data is transmitted in such a way that the image with the most user evaluation value points, which is considered to be a good image by many unspecified viewers, is displayed immediately as the recommended image.

In the embodiment, FIG. 48D is the first recommended image and data thereof is transmitted to be displayed in full screen. Moreover, the image with the second most evaluation points which corresponds to FIG. 48B, the image with the third most evaluation points which corresponds to FIG. 48B, and the image with the fourth most evaluation points which corresponds to FIG. 48C are transmitted to the display terminal in this order.

The configuration described above requires no special function in the display apparatus and enables generation of an image suitable for the scene and incorporating opinions of a specific viewer (for example, a professional photographer) as the most important opinion. Accordingly, the embodiment has such an effect that the convenience of the user is improved in a simple configuration.

### Embodiment 13

In Embodiment 13, description is given of an example of obtaining resolution information of a terminal which is a transmission destination and performing resolution conversion in conformity with a resolution of the transmission destination, in a case where an image manager requests image reproduction.

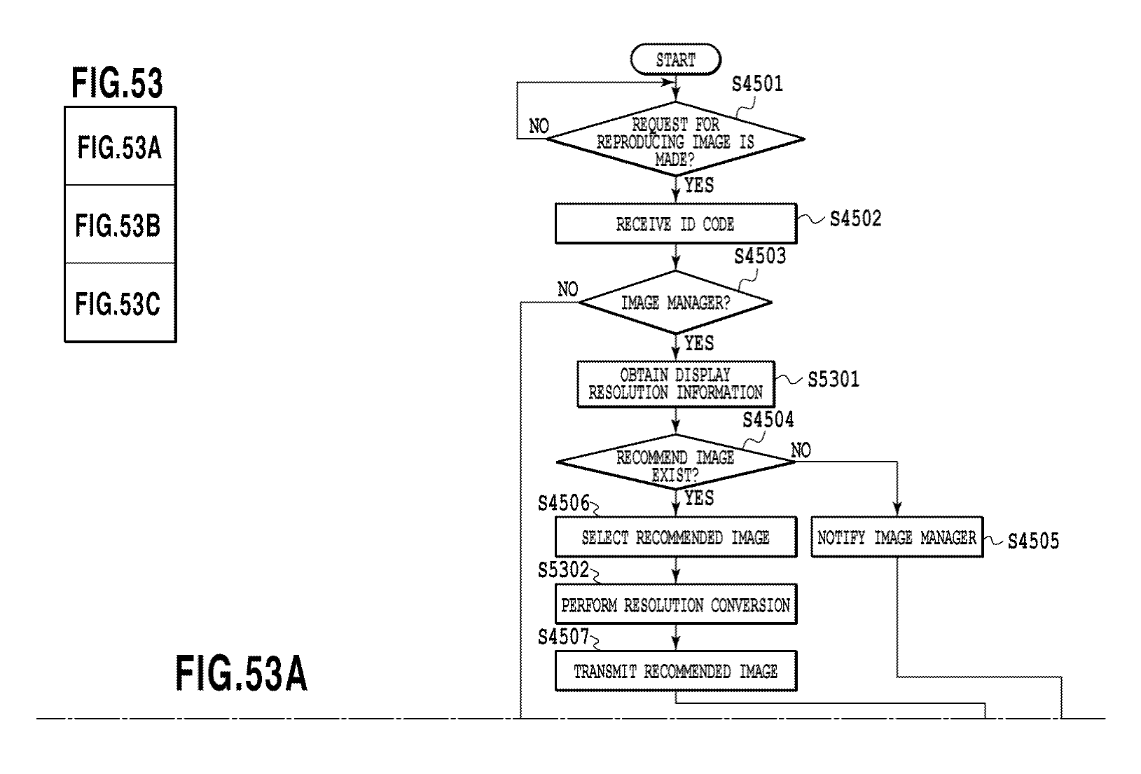

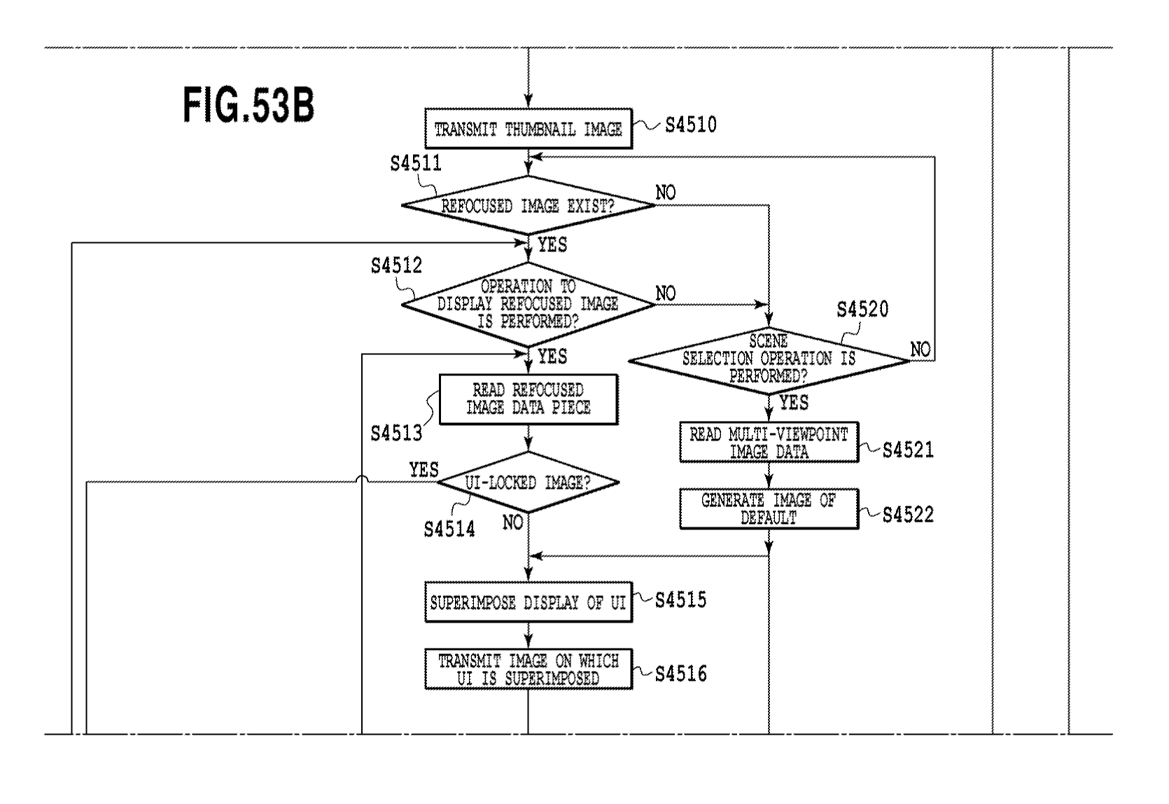

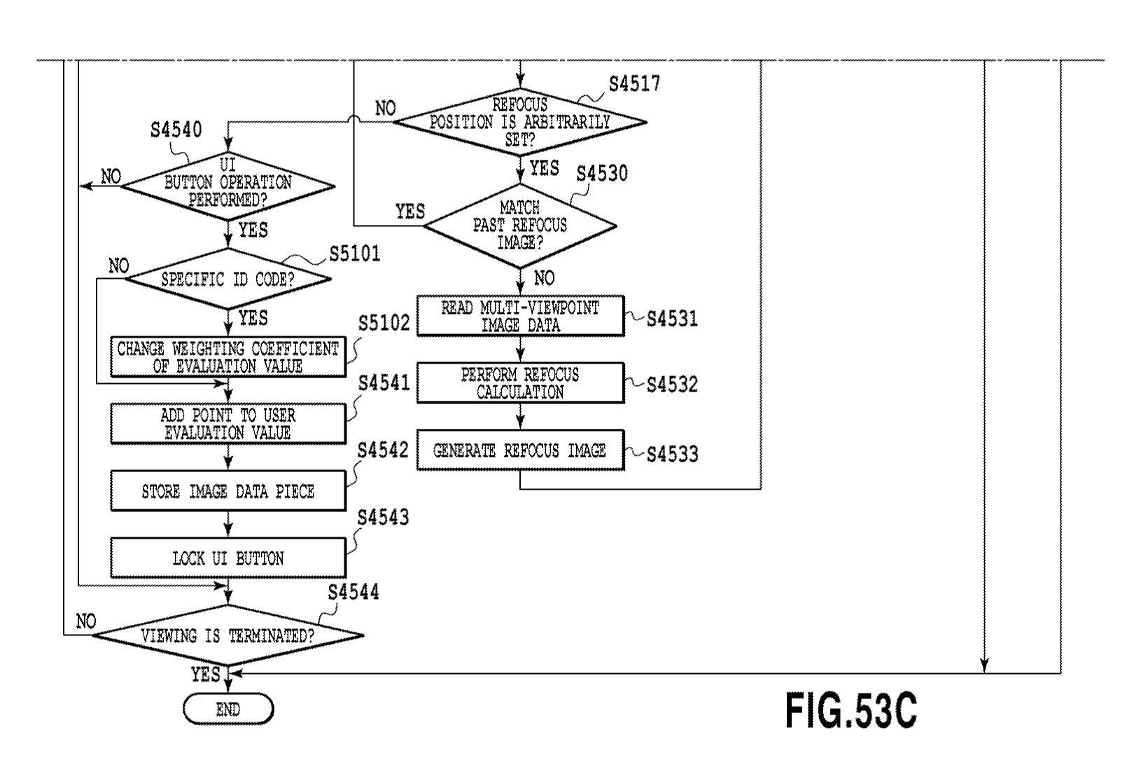

FIGS. 53A to 53C are a system flowchart of a cloud server of Embodiment 13. FIGS. 53A to 53C differs from the system flowchart of FIGS. 51A to 51C described in Embodiment 12 only in that steps S5301 and S5302 are added. Contents of processes in other steps can be the same as the contents described in Embodiments 11 and 12, unless specially stated otherwise.

In step S5301, in response to an access made by each of the display terminals 4305, 4306, and 4307 of FIG. 43, the cloud server obtains the requested resolution information from the display terminal. In a case of an access from the display terminal A 4305, the resolution information is WXGA (1200×800). In a case of an access from the display terminal B 4306, the resolution information is FULL_HD (1920×1080). In a case of an access from the display terminal C 4307, the resolution information is WVGA (854×480). These pieces of resolution information are assumed to be stored in the data storage unit 4402 of the cloud server in advance.

In step S5302, the resolution of the recommended image data is converted by the resolution converting unit 4406 of FIG. 44 in accordance with the resolution information obtained in step S5301. In step S4507 of FIG. 53A, the recommended image data subjected to the resolution conversion in step S5302 is transmitted.

The configuration described above has the following effect. The image manager can use any display terminal to display and browse the recommended image suitable for the scene, without any special function provided in the display apparatus. Accordingly, the embodiment has such an effect that the convenience of the user is improved in a simple configuration.

### Embodiment 14

In embodiment 14, description is given of an example of generating the refocus image data in advance by utilizing distribution of distance in an image. This has an effect of improving the convenience of a user in a simple configuration.

In Embodiment 14, description is given of a method of using a depth map generated after image capturing for the generation of the refocus image data. The depth map is data expressing distance information in which the distance from an image capturing surface to an object is obtained for every pixel and the distances are compiled into map information. Calculation of the depth map can be achieved by, for example, obtaining information on arrangement of multiple image capturing units in an image capturing camera array unit and multiple images obtained from the multiple image capturing units. For example, the distance to each object can be calculated by performing triangulation using positions of a characteristics point in two images, positions of corresponding cameras, and the angles of view of the corresponding cameras. The arrangement information of the image capturing units can be obtained from, for example, the multi-viewpoint image header information 810 which is information stored in a data format shown in FIG. 8. The calculation of the depth map is executed by control of the overall-control unit 108. The depth map can be calculated by various methods other than that described above.

In the embodiment, description is given of an example in which generation ranks of the pieces of refocus image data are determined by using the depth map. The main operation flow of the embodiment is different from that of Embodiment 1 in Step S207 of FIG. 2 and step S303 of FIG. 3. Other steps in the main operation flow are the same as those of FIGS. 2 and 3. Moreover, a hardware configuration block diagram of the embodiment is the same as that of FIG. 1. In the embodiment, since the generation ranks of the pieces of refocus image data are determined based on the depth map, the process based on the history information which is described in Embodiment 1 can be omitted.

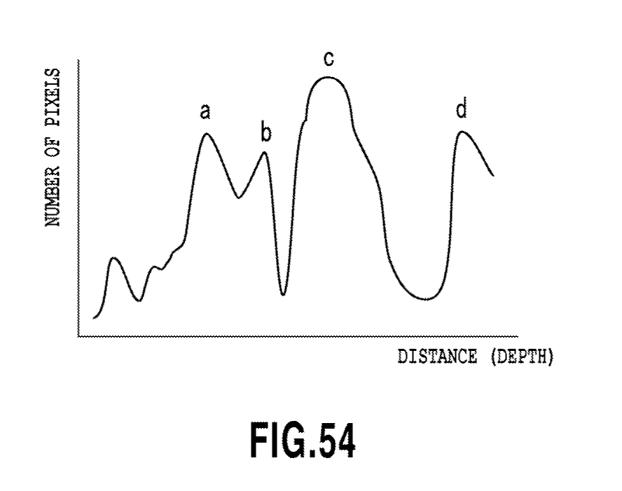

First, the overall-control unit 108 creates the depth map after multi-viewpoint image data is captured or an image file is read, and then converts the depth map into a format in which the number of pixels for each distance is shown. The format after the conversion is shown in FIG. 54. FIG. 54 shows a distribution (histogram) of the number of pixels with respect to distance in a screen. A distance having a large number of pixels indicates a portion of a picture largely occupied by an object existing at the distance. In the example of FIG. 54, the four largest peaks are a, b, c, and d and the number of pixels is large in the order of c, a, d, and b.

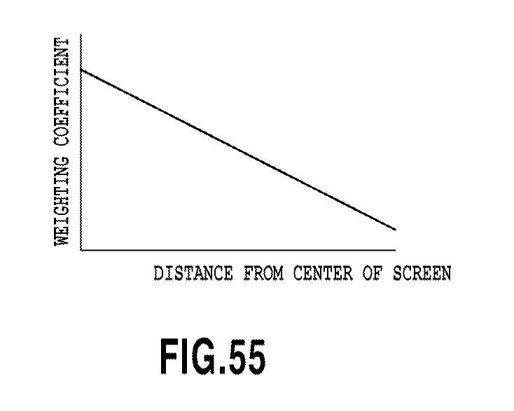

Next, in the data in the format shown in FIG. 54, the overall-control unit 108 multiplies each of the pixels by a coefficient corresponding to its distance from a screen center (weighting process). The coefficient is highest at the screen center and becomes lower as the distance from the center increases. FIG. 55 is a graph showing the characteristic of the coefficient.

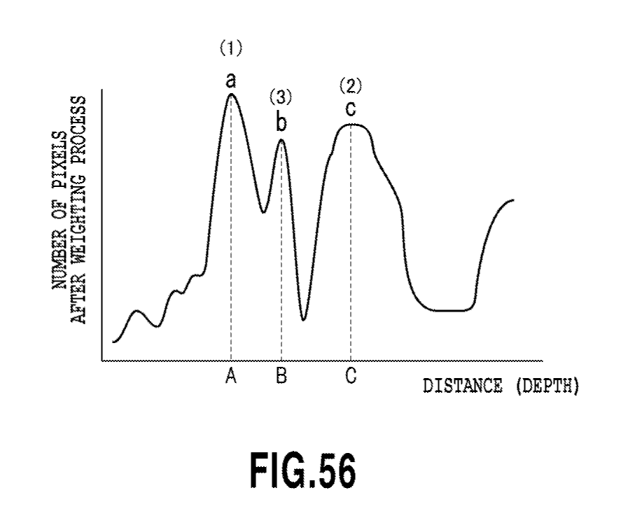

FIG. 56 shows a result obtained by weighting the data (histogram) on the distribution of the number of pixels with respect to distance shown in FIG. 54 in such a way that each pixel is multiplied by the coefficient shown in FIG. 55. This multiplication has the following effect. In a case where, for example, a wall located away from the image capturing apparatus by a constant distance is included in the background, a portion corresponding to the background region in the distribution is prevented from becoming high and the generation rank of the pieces of refocus image data with the background in focus is thereby prevented from becoming high.

In the example of FIG. 56, the three highest peaks are ranked in the descending order of a, c, and b. The generation ranks of the pieces of refocus image data are determined by using the result of multiplication. Note that the process described above and the process of generating the depth map are performed by the overall-control unit 108 in FIG. 1 reading and executing a program stored in the RAM 102, the Flash ROM 107, the external memory 109, or the like.

A method of determining the generation ranks of the pieces of refocus image data in the embodiment is described below in detail.

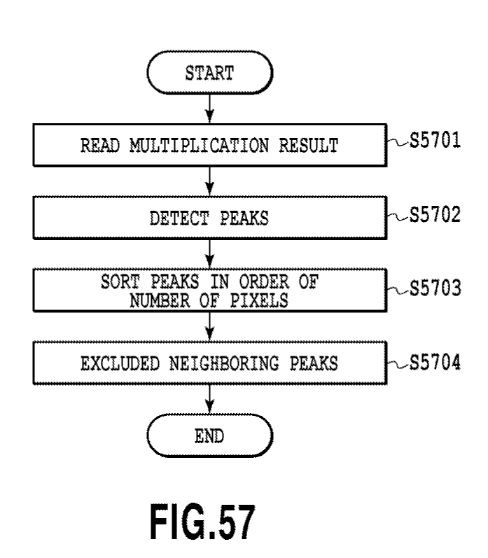

FIG. 57 shows a determining operation flow. This operation is also performed by the overall-control unit 108 in FIG. 1 reading and executing a program stored in the RAM 102, the Flash ROM 107, the external memory 109, or the like.

In step S5701, the overall-control unit 108 reads the multiplication result data. In step S5702, the overall-control unit 108 detects peaks from the data read in step S5701. For example, the distance with the number of pixel larger than a certain threshold can be detected as a peak. Various methods other than that described above can be used as the method of detecting peaks in the histogram. In step S5703, the overall-control unit 108 sorts the detected peaks in the order of the number of pixels. In step S5704, the overall-control unit 108 searches the peaks in the sorted order and performs the following process for a peak of a certain rank. The overall-control unit 108 excludes a peak which has a lower rank than the peak of the certain rank and which exists within a predetermined neighboring range thereof. This prevents the peaks used for the determination of generation ranks from being concentrated in a close area.

As described above, in the example of FIG. 56, the three highest peaks are ranked in the descending order of a, c, and b. Accordingly, the generation ranks of the pieces of refocus image data with the focus distances of A, C, and B which are distances corresponding to these peaks are first to third, respectively. In accordance with the generation ranks of the pieces of refocus image data determined as described above, the refocus image data whose generation rank is first is generated in steps S207 of FIG. 2. The pieces of refocus image data are generated in the descending order of the generation ranks in step S303 of FIG. 3.

The configuration described above enables generation of the refocus images from the distribution of the number of pixels with respect to distance in the screen, without depending on past operation history or the like and without a need for a recognition function in the screen. Accordingly, the embodiment has such an effect that the convenience of the user is improved in a simple configuration.

The method of determining the generation ranks of the pieces of refocus image data used in the embodiment can be performed in combination with the method using the operation history described in Embodiment 1 which is another determining method. Moreover, the method of the embodiment can be performed in combination with a method in which a person mode, a landscape mode, or the like mode is set at as a mode in refocus and generation ranks of objects corresponding to the set mode are set higher. Moreover, in the embodiment, description is given by using a configuration in which the image capturing camera array unit for obtaining multiple images and the display for displaying the generated image are provided in the single apparatus. However, the image capturing camera array unit and the display may be provided in external apparatuses. In other words, as shown in FIG. 43, the embodiment can be applied to a system configuration in which the hardware configuration shown in FIG. 1 is included in the network shown in FIG. 43. Specifically, the image processing of the multi-viewpoint image data captured by the camera array 4301 can be implemented by components such as the cloud server 4304 and the display terminals 4305 to 4307. FIG. 49 shows the block diagram of the display terminals 4305 to 4307. In the block diagram shown in FIG. 49, the same process same as the process described in FIG. 1 can be performed, except for the point that the multi-viewpoint image data is obtained via the network I/F. FIG. 44 shows the example of the detailed hardware configuration block diagram of the cloud server 4304. In the cloud server 4304, the function corresponding to the image analyzing unit 112 of FIG. 1 can be performed by the overall-control unit 4407. Alternatively, the cloud server 4304 can receive the analysis result from the camera array 4301 or the display terminals 4305 to 4307 via the network communication unit 4401.

### Embodiment 15

In Embodiment 14, description is given of an example in which calculation performed by using only the depth map is used as the method for determining the generation ranks of the pieces of refocus image data. In Embodiment 15, description is given of an example in which the generation ranks of refocus images are determined by applying region information of each object to depth map information, the region information outputted as the analysis result of the image analyzing unit 112.

In the embodiment, it is assumed that the analysis result of the image analyzing unit 112 has been already outputted and the identification code and coordinate information of each region are stored in one of the RAM 102, the Flash ROM 107, and the external memory 109. Moreover, it is assumed that the depth map is also stored in one of the memories described above.

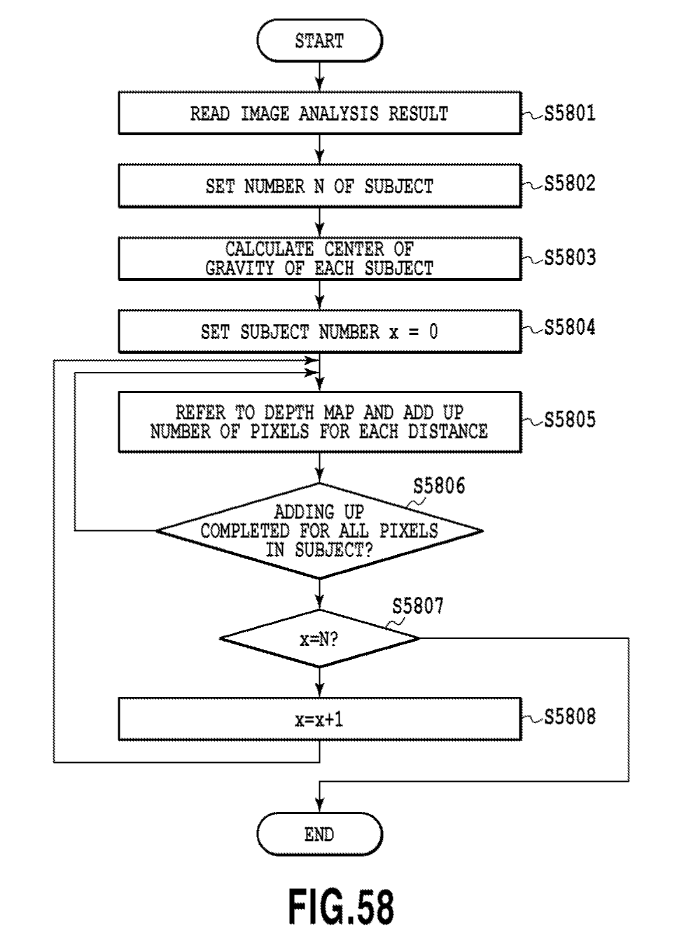

Description is given below of generation of data for determining image generation ranks in the embodiment, which is different from that of Embodiment 14, in accordance with the operation flow shown in FIG. 58. The operation is performed by the overall-control unit 108 in FIG. 1 reading and executing a program stored in the RAM 102, the Flash ROM 107, the external memory 109, or the like.

First, in step S5801, the overall-control unit 108 reads the image analysis result from the RAM 102. In step S5802, the overall-control unit 108 determines the number of extracted objects from the read result and sets the number of objects. In step S5803, the overall-control unit 108 calculates the center of gravity of each object from the region information thereof. In step S5804, the overall-control unit 108 sets an object number x to an initial value of zero.

In step S5805, the overall-control unit 108 reads the coordinate information of object number x=0, refers to the depth map for the coordinates at which the object with the object number x=0 exists, and adds up the number of pixels for each distance. At this time, the overall-control unit 108 refers to the center of gravity of each object calculated in step S5803 and performs adding-up with the number of pixels multiplied by a coefficient corresponding to the distance from the screen center to the center of gravity. The coefficient can be highest at the screen center and become lower as the distance from the center increases as in FIG. 55 of Embodiment 14.

In step S5806, the overall-control unit 108 determines whether the adding-up of all of the pixels is completed for a certain object. In a case where the adding-up is not completed, the process returns to step S5805 to continue the adding-up. In a case where the adding-up is completed, the process proceeds to step S5807. In step S5807, the overall-control unit 108 determines whether the adding-up is completed for all of the objects. In a case where the adding-up is completed, the process is terminated. In a case where the adding-up is not completed, the process proceeds to step S5808. In step S5808, the object number x is incremented by one and the process returns to 5805 to continue the adding-up. The adding-up in this case is not performed for each object. Instead, all of the pixels related to all of the objects are added up.

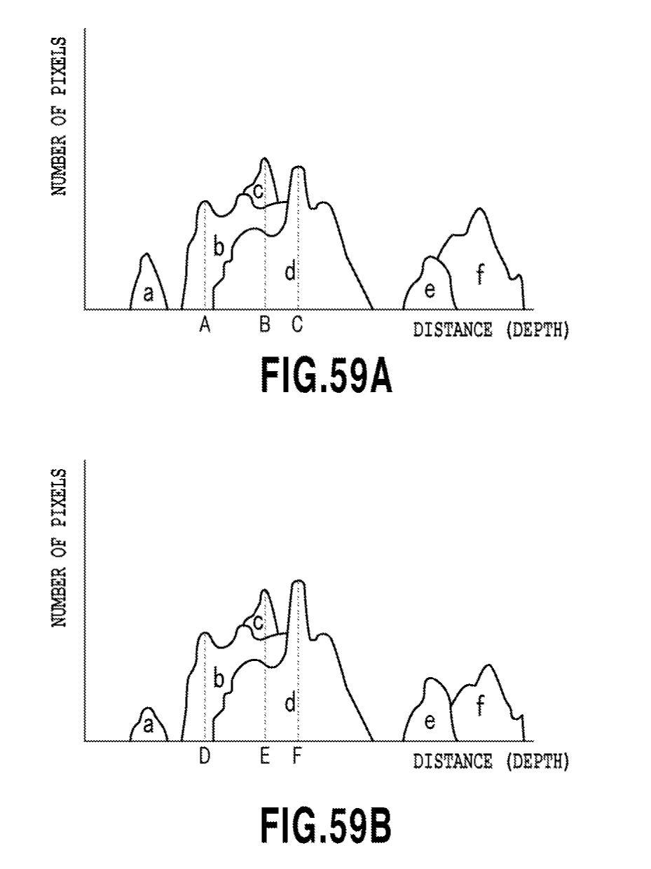

FIGS. 59A and 59B each show an example of the distribution (histogram) of the number of pixels with respect to distance in the operation described above. FIGS. 59A and 59B are examples in which six objects of a to f are extracted. Closed surface regions denoted by a to f each express the number of pixels in a corresponding one of the objects, and the envelope of the whole is the histogram obtained by adding up the number of pixels of all of the objects. The determination of generation ranks to be described later is performed by utilizing the envelope.

FIG. 59A is a histogram before the multiplication of the coefficient corresponding to the distance from the screen center to the center of gravity. FIG. 59B is a histogram after the multiplication of the coefficient. The three highest peaks in FIG. 59A are distances B, C, and A in the descending order while the three highest peaks in FIG. 59B are distances F, E, D in the descending order.

The method of determining the generation ranks of the pieces of refocus image data and the generation of images in accordance with the ranks can be the same as those described in Embodiment 14. In the configuration described above, the following effect can be obtained in addition to the effect described in Embodiment 14. Objects such as landscape which are not recognized as objects are removed for the determination of the generation ranks of the refocus images, on the basis of the object recognition result.

The method of determining the generation ranks of the pieces of refocus image data which is used in this embodiment can be performed in combination with other determination methods. For example, in a case where the person mode is selected, the method of the embodiment is applied only to people among the objects. Moreover, the coefficient is not limited to the distance from the screen center and can be changed depending on the mode. Furthermore, application of the method of the embodiment can be limited to objects whose operation frequencies are higher than a predetermined threshold, by using the history information described in Embodiment 1.

Description of Embodiment 15 is given based on the hardware configuration shown in FIG. 1. However, the embodiment can be applied to a system configuration including a network and the like, as described in Embodiment 14.

### Embodiment 16

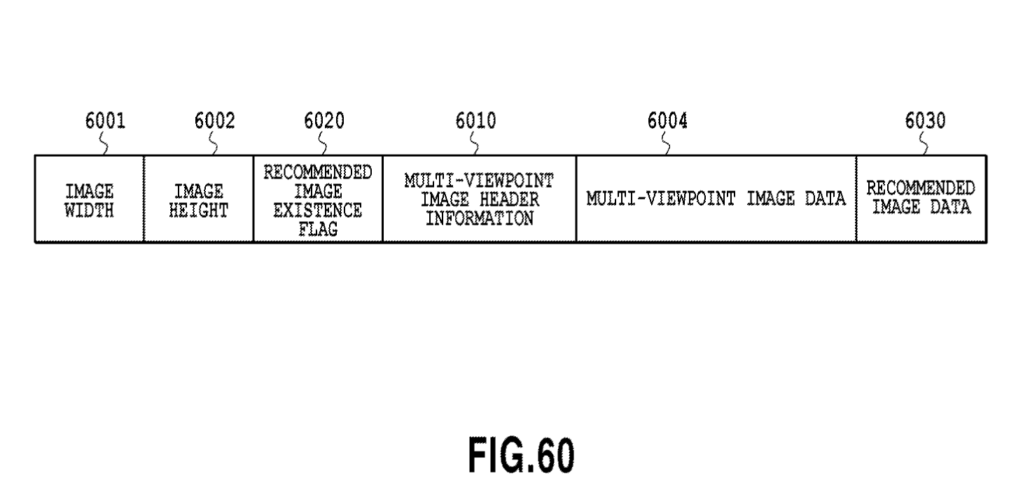

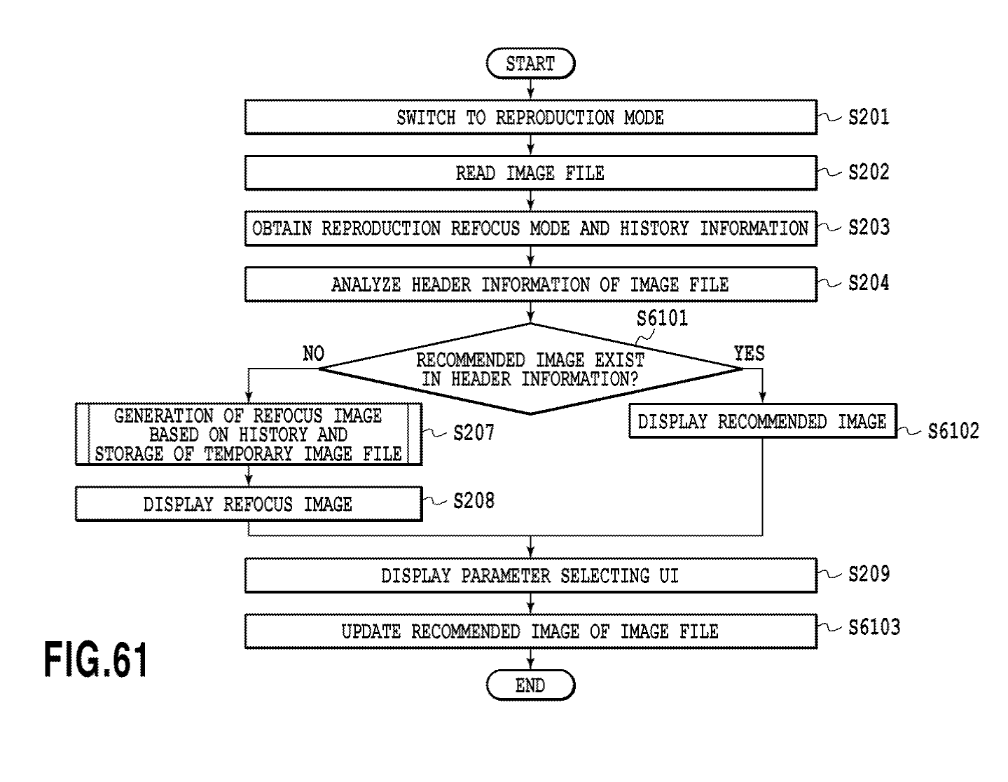

In Embodiment 16, by using FIGS. 60 and 61, description is given of a mode in which recommended refocused image data is stored in association with multi-viewpoint image data as an image file. In Embodiment 1, description is given of an example in which the recommended parameter is included in the image file as the recommended information. In the embodiment, description is given of an example in which the recommended image data is included in the image file as the recommended information. The description is given under the assumption that a flowchart shown in the embodiment is executed by the overall-control unit 108 of FIG. 1 and the overall-control unit 108 implements processes in the flowchart by controlling modules shown in FIG. 1.

FIG. 60 is a view for explaining an image format of the image file capable of storing the refocus image data as the recommended image data. FIG. 60 is described in detail below. Note that the description of FIG. 60 is the same as that of FIG. 8 unless specifically stated otherwise. A recommended image existence flag 6020 is a flag indicating whether the refocused image data is attached to the image file as the recommended image data. Recommended image data 6030 is a piece of refocus image data with the focus on a predetermined target, the refocus image data generated from multi-viewpoint image data 6004 associated with the recommended image data 6030. The recommended image data 6030 may be a piece of refocus image data expressing an image displayed first based on the history information described in Embodiment 1 or a piece of refocus image data for which refocus is performed by using a parameter selected by the user. The recommended image data 6030 is a piece of image data attached only in a case where the recommended image existence flag 6020 is true. In the embodiment, the recommended image data is assumed to be non-compressed RGB data which can be directly outputted to a display without being converted by a graphic processor into an appropriate format. However, the image format is not limited and a compressed format such as JPEG may be used. Moreover, although no refocus position information 803 in the image format of FIG. 8 is included in the example of the image format shown in FIG. 60, the refocus position information 803 may be included in the image format of FIG. 60.

FIG. 61 is different from FIG. 2 in that steps S205, S206, and S210 are replaced by steps S6101, S6102, and S6103, respectively. Other processes can be the same as the processes of FIG. 2 and description thereof is thereby omitted. Part of the flow of FIG. 61 which is different from FIG. 2 is described below in detail.

In step S6101, the overall-control unit 108 refers to the recommended image existence flag 6020 of the image file read in step S202 and determines whether the recommended image data 6030 is attached to the image file. In a case where the recommended image data 6030 is attached to the image file, step S6102 is executed. In a case where no recommended image data 6030 is attached, step S207 is executed.

In step S6102, the overall-control unit 108 extracts the recommended image data 6030 from the image file read in step S202 and displays the recommended image data 6030 on the display 105 via the graphic processor 104. In the embodiment, description is given under the assumption that the operation of transferring the recommended image data from the external memory 109 to the RAM 102 is performed in step S202 and the data in the RAM 102 is displayed in step S6102.

In step S6103, the overall-control unit 108 attaches the image data of the lastly-displayed image to the image file in the external memory with the lastly-displayed image used as the recommended image, and sets the recommended image existence flag 6020 of the image file to true. In a case where the recommended image data 6030 is already attached, the recommended image data 6030 is updated.

In the embodiment, the image data for which the user has lastly selected the parameter and which is lastly displayed is stored as the recommended image data, by being attached to the image file including the multi-viewpoint image data. Accordingly, in a case where the image file is displayed next time, the image data lastly displayed by the user can be displayed without performing resetting of the parameter and recalculation for the refocus process. As described above, in a case where the recommended image data is included in the image file, the refocus image expressed by the recommended image data can be generated by using the recommended image data.

In the embodiment, the recommended image data is attached to the image file. However, the embodiment is not limited to this mode and the image file and the recommended image data may be stored separately. In other words, it is only necessary that the multi-viewpoint image data and the recommended image data are associated with each other. For example the recommended image data may be stored in a separate apparatus such as a cloud server.

In the embodiment, description is given under the assumption the recommended image data is read in step S202. However, the embodiment is not limited to this and the following configuration is possible. The process is started from step S6102 and the recommended image data is partially read from the image file in the external memory 109.

Moreover, an example is given in which the refocus calculation process is performed based on the history information in step S207. However, in the embodiment, it is not necessary to perform the refocus calculation process based on the history information. Specifically, the following configuration is possible. Step S207 is not executed and, for example, an image with the focus on all of the regions is displayed in step S208.

The embodiment is described under the assumption that the overall-control unit 108 of FIG. 1 controls the modules shown in FIG. 1. However, there is no limit in the configuration of hardware for executing the processes. For example, as shown in FIG. 49, the processes can be executed by a personal computer which has no image capturing unit, refocus calculation unit, or image analyzing unit. The configuration and operations of the personal computer are assumed to be the same as those of the hardware shown in FIG. 1 unless specifically stated otherwise. Note that a normal personal computer does not have the refocus calculation unit or the image analyzing unit. Accordingly, the refocus calculation process and the image analyzing process are executed by the overall-control unit 108. Moreover, the image file and the history information are stored in the HDD 4901 instead of the external memory and the history information storage unit.

### EXAMPLES

Preferred examples of the invention are specified in the followings.

1. An image processing apparatus comprising:

a determining unit configured to determine ranks of targets to be in focus on the basis of history information indicating operation history; and

a generating unit configured to sequentially generate a plurality pieces of combined image data, from multi-viewpoint image data obtained by capturing images from a plurality of viewpoints, by focusing on the targets in accordance with the ranks determined by the determining unit.

2. The image processing apparatus according to EXAMPLE 1, further comprising a control unit configured to cause the generated combined image data to be displayed, wherein

in a case where the control unit receives an input of a parameter from a user for the displayed combined image data, the control unit determines whether combined image data with the focus on the target corresponding to the inputted parameter is generated by the generating unit,

in a case where the control unit determines that combined image data is generated by the generating unit, the control unit causes the generated combined image data to be displayed, and

in a case where the control unit determines that combined image data is not generated by the generating unit, the control unit causes the generating unit to generate combined image data with the focus on the target corresponding to the inputted parameter.

3. The image processing apparatus according to EXAMPLE 1, further comprising a control unit configured to cause the generated combined image data to be displayed, wherein

the generating unit sequentially generates the combined image data in accordance with the ranks during a period when no parameter is inputted by a user for the displayed combined image data.

4. The image processing apparatus according to EXAMPLE 1, further comprising a recognition unit configured to recognize an object included in the image expressed by the multi-viewpoint image data, wherein

the determining unit extracts the object recognized by the recognition unit as the target.

5. The image processing apparatus according to EXAMPLE 2, further comprising a history information storage unit configured to store, as the history information, the number of times of selecting a target including a region corresponding to the parameter inputted by the user for the displayed combined image data.
6. The image processing apparatus according to EXAMPLE 1, further comprising a determination unit configured to determine whether priority is given to a mode of indicating a target to be in focus, wherein

in a case where the determination unit determines that the mode is given priority, the determining unit changes the ranks of the targets to ranks matching the mode.

7. The image processing apparatus according to EXAMPLE 6, wherein the determining unit changes the ranks by using second history information indicating operation history in the mode.
8. An image processing apparatus comprising a display unit configured to display combined image data with the focus on a target corresponding to history information indicating operation history, without receiving an input of a parameter from a user, the combined image data being displayed by using multi-viewpoint image data obtained by capturing images from a plurality of viewpoints.
9. An image processing apparatus comprising:

a designating unit configured to designate a non-focus region which is not desired to be in focus in an image, in response to an instruction from a user;

a determining unit configured to determine a focus surface corresponding to the designated non-focus region; and

a combining unit configured to combine a plurality pieces of image data by using the determined focus surface.

10. The image processing apparatus according to EXAMPLE 9, wherein the combining unit combines the plurality pieces of image data captured at least two or more different viewpoints.
11. The image processing apparatus according to EXAMPLE 9, wherein the combining unit combines the plurality pieces of image data captured at least two or more continuous time points.
12. The image processing apparatus according to EXAMPLE 9, wherein the designating unit designates a focus region which is desired to be in focus in an image, in response to an instruction from the user.
13. The image processing apparatus according to EXAMPLE 12, further comprising an attaching unit configured to attach position information to image data combined by the combining unit, the position information indicating a position of the focus region or the non-focus region designated by the designating unit.
14. The image processing apparatus according to EXAMPLE 13, wherein the attaching unit further attaches, to the combined image data, attribute information on whether the position information indicates the focus region or the non-focus region, while associating the attribute information with the position information.
15. The image processing apparatus according to EXAMPLE 14, wherein, in a case where the designating unit designates the non-focus region in the image expressed by the image data to which the position information is attached by the attaching unit,

on the basis of an instruction from the user for the image expressed by the image data to which the position information is attached by the attaching unit, the attaching unit updates the attribute information attached to the image data to information indicating the non-focus region.

16. The image processing apparatus according to EXAMPLE 9, wherein, in a case where the user gives an instruction for a region in the image for a certain time or more, the designating unit designates the region for which the instruction is given as the non-focus region.
17. The image processing apparatus according to EXAMPLE 12, wherein, in a case where the user consecutively gives instructions for a region in the image within a certain time, the designating unit designates the region for which the instructions are given as the focus region.
18. The image processing apparatus according to EXAMPLE 9, wherein the determining unit determines the focus surface corresponding to the non-focus region by shifting a position of the focus surface on the basis of an instruction from the user.
19. The image processing apparatus according to EXAMPLE 9, wherein the determining unit determines the focus surface corresponding to the non-focus region by adjusting a depth of field on the basis of an instruction from the user.
20. The image processing apparatus according to EXAMPLE 9, wherein the determining unit determines the focus surface corresponding to the non-focus region by adjusting a shape of a curve used as a base for formation of the focus surface on the basis of an instruction from the user.
21. The image processing apparatus according to EXAMPLE 9, wherein the determining unit determines the focus surface corresponding to the non-focus region on the basis of position information which is attached to image data and which indicates a position of a focus region.
22. The image processing apparatus according to EXAMPLE 9, wherein the determining unit determines the focus surface corresponding to the non-focus region on the basis of position information which is attached to image data pieces and which indicates a position of the non-focus region.
23. An image processing apparatus comprising:

an obtaining unit configured to obtain identification data which is used to identify a target object and focus state data which is associated with the identification data and which indicates a focus state of the target object;

a determination unit configured to determine whether the target object matching the identification data exists in an image; and

a determining unit configured to determine a focus surface to be used to combine a plurality pieces of image data on the basis of the focus state data associated with the identification data, in a case where the determination unit determines that the target object matching the identification data exists in the image.

24. The image processing apparatus according to EXAMPLE 23, wherein the focus state data indicates whether the target object is a focus target or a non-focus target.
25. The image processing apparatus according to EXAMPLE 23, wherein

the obtaining unit obtains an identification code as the identification data, and

in a case where the identification code is included in the image data expressing the image, the determination unit determines that the target object exists.

26. The image processing apparatus according to EXAMPLE 23, wherein

the obtaining unit obtains recognition information indicating characteristics of the target object as the identification data, and

the determination unit performs the determination by comparing the recognition information and an object in the image.

27. The image processing apparatus according to EXAMPLE 23, wherein

the obtaining unit obtains an identification code and recognition information indicating characteristics of the target object as the identification data, and

in a case where the identification code is not included in the image data expressing the image, the determination unit performs the determination by comparing the recognition information and an object in the image.

28. The image processing apparatus according to EXAMPLE 26, wherein the determination unit performs the comparison by using a plurality of objects detected in accordance with ranks based on a size of area occupied by each object in the image, a position of each object in the image, or a combination thereof.
29. The image processing apparatus according to EXAMPLE 23, further comprising an attaching unit configured to attach information indicating the focus surface determined by the determining unit to the image data expressing the image.
30. The image processing apparatus according to EXAMPLE 29, wherein the information indicating the focus surface determined by the determining unit is information in which the identification data, the focus state data, and position information indicating a position of the target object in the image are associated with each other.
31. The image processing apparatus according to EXAMPLE 30, further comprising an updating unit configured to, in a case where the position information on the target object corresponding to the identification data obtained by the obtaining unit is attached to the image data, update the focus state data which is attached to the image data and which is associated with the identification data, to the focus state data obtained by the obtaining unit.
32. The image processing apparatus according to EXAMPLE 30, further comprising a deleting unit configured to, in a case where the identification data not matching the identification data obtained by the obtaining unit is attached to the image data, delete the non-matching identification data, the focus state data and the position information which are associated with the non-matching identification data from the image data.
33. The image processing apparatus according to EXAMPLE 23, further comprising a storage unit configured to store, in each of groups layered in a hierarchy, a set of the plurality pieces of image data, the identification data which is used to identify the target object, and the focus state data which is associated with the identification data and which indicates the focus state of the target object, wherein

the determination unit performs the determination on the image data belonging to: a group to which the identification data and the focus state data obtained by the obtaining unit belong; and a group included in the group to which the identification data and the focus state data belong.

34. The image processing apparatus according to EXAMPLE 23, further comprising:

a display unit configured to display target object data generated by extracting, from the image, a region including the target object determined to match the identification data; and

an updating unit configured to update the identification data in accordance with an instruction from the user for the target object data displayed by the display unit.

35. The image processing apparatus according to EXAMPLE 23, further comprising:

a display unit configured to display target object data generated by extracting, from the image, a region including the target object determined to match the identification data; and

a deleting unit configured to delete position information in the image data from which the target object data is extracted, in accordance with an instruction from the user for the target object data displayed by the display unit, the position information indicating a position where the target object exists in the image.

36. A data structure of an image file including image data captured from a plurality of viewpoints, comprising:

the image data; and

data indicating position information on a target object in focus in an image expressed by the image data.

37. The data structure according to EXAMPLE 36, further comprising data indicating the presence or absence of the data indicating the position information of the target object in focus in the image expressed by the image data.
38. A data structure of an image file including image data captured from a plurality of viewpoints, comprising:

the image data; and

data indicating position information on a target object out of focus in an image expressed by the image data.

39. The data structure according to EXAMPLE 38, further comprising data indicating the presence or absence of the data indicating the position information of the target object out of focus in the image expressed by the image data.
40. A data structure of an image file including image data captured from a plurality of viewpoints, comprising:

the image data;

data indicating position information of a target object in an image expressed by the image data pieces; and

data indicating whether the target object is a target object in focus or a target object out of focus.

41. The data structure according to EXAMPLE 36, wherein the data except for the image data is provided for each target object.
42. An image processing apparatus comprising:

a display control unit configured to cause an image and one or more regions in the image to be displayed, the image being expressed by image data obtained by image capturing;

a selecting unit configured to select one of the regions on the basis of an instruction from an user; and

a first image processing unit configured to execute image processing on the image data in accordance with the region selected by the selecting unit.

43. The image processing apparatus according to EXAMPLE 42, wherein the image data is multi-viewpoint image data obtained by capturing images from a plurality of viewpoints.
44. The image processing apparatus according to EXAMPLE 42, wherein the first image processing unit executes the image processing on the image data by focusing on the selected region.
45. The image processing apparatus according to EXAMPLE 42, further comprising an analyzing unit configured to analyze a characteristic of the image data, wherein

the display control unit causes the one or more regions to be displayed on the basis of an analysis result of the analyzing unit.

46. The image processing apparatus according to EXAMPLE 45, wherein the analysis result is information indicating a category to which each object in the image belongs.
47. The image processing apparatus according to EXAMPLE 45, wherein the analyzing unit categorizes a plurality of regions in the image in accordance with the characteristic of the image and outputs degrees of priority corresponding to the categorized regions by including the degrees of priority in the analysis result.
48. The image processing apparatus according to EXAMPLE 47, further comprising a second image processing unit configured to execute image processing on the image data in accordance with each of the categorized regions in the order of the degrees of priority outputted by the analyzing unit, wherein

in a case where the region selected by the selecting unit corresponds to a region subjected to the image processing by the second image processing unit, the display control unit makes a display of an image obtained by the image processing by the second image processing unit, and

in a case where the region selected by the selecting unit does not correspond to the region subjected to the image processing by the second image processing unit, the display control unit makes a display of an image obtained by the image processing by the first image processing unit.

49. The image processing apparatus according to EXAMPLE 48, wherein the display control unit causes a figure specifying each object categorized by the analyzing unit to be displayed as the region.
50. The image processing apparatus according to EXAMPLE 49, further comprising a progress information obtaining unit configured to obtain progress information on a degree by which the second image processing unit completes the image processing in accordance with each of the regions, wherein

the display control unit causes the figure to be displayed based on the obtained progress information.

51. An image processing apparatus comprising:

a display unit configured to display at least one figure on an image expressed by multi-viewpoint image data, the figure indicating a region where refocus is recommended in the image; and

a control unit configured to, in response to selection of the at least one figure, cause the display unit to display combined image data generated by focusing on the region represented by the selected figure.

52. An image distributing apparatus comprising:

an obtaining unit configured to obtain combined image data with the focus on a predetermined region, the combined image data being given a user evaluation value and generated from multi-viewpoint image data captured from a plurality of viewpoints; and

a transmitting unit configured to transmit the obtained combined image data.

53. The image distributing apparatus according to EXAMPLE 52, further comprising:

a receiving unit configured to receive an update request of the user evaluation value for the transmitted combined image data; and

an updating unit configured to update the user evaluation value stored in association with the transmitted combined image data, in response to the update request.

54. The image distributing apparatus according to EXAMPLE 53, wherein the updating unit changes an update value of the user evaluation value depending on a user who makes the update request.
55. The image distributing apparatus according to EXAMPLE 53, wherein, after the update is performed by the updating unit, the transmitting unit transmits locked image data in which the combined image data is prohibited from being updated again, to a request source of the update request.
56. The image distributing apparatus according to EXAMPLE 52, further comprising:

a determination unit configured to, in a case where a certain region of the transmitted combined image data is designated, determine whether a piece of combined image data with the focus on the designated region is stored; and

a control unit configured to cause the transmitting unit to transmit the stored piece of combined image data in a case where the determination unit determines that the piece of combined image data is stored, or to cause a piece of combined image data with the focus on the designated region to be generated and cause the transmitting unit to transmit the piece of combined image data in a case where the determination unit determines that no piece of combined image data is stored.

57. The image distributing apparatus according to EXAMPLE 52, wherein, in a case where the obtaining unit obtains a plurality pieces of combined image data associated with the same captured image scene, the transmitting unit transmits the plurality pieces of combined image data sequentially in descending order of a user evaluation value.
58. The image distributing apparatus according to EXAMPLE 52, further comprising a converting unit configured to convert the piece of combined image data to a piece of combined image data in conformity with a resolution of a transmission destination, wherein

the transmitting unit transmits the converted piece of combined image data.

59. An image displaying apparatus comprising:

a first transmitting unit configured to transmit a reproduction request of image data;

a receiving unit configured to receive combined image data with the focus on a predetermined region, the combined image data being generated from multi-viewpoint image data captured from a plurality of viewpoints in response to the reproduction request; and

a second transmitting unit configured to transmit a request of giving a user evaluation value to the received combined image data.

60. An image processing apparatus comprising:

a determining unit configured to determine ranks of targets to be in focus on the basis of distance information indicating depth in an image expressed by multi-viewpoint image data obtained by capturing images from a plurality of viewpoints;

a generating unit configured to sequentially generate a plurality pieces of combined image data from the multi-viewpoint image data by focusing on the targets in accordance with the ranks determined by the determining unit.

61. The image processing apparatus according to EXAMPLE 60, wherein the determining unit calculates the number of pixels for each distance from a depth map of pixels forming the multi-viewpoint image data, and determines the ranks on the basis of a result of the calculation.
62. The image processing apparatus according to EXAMPLE 61, wherein the determining unit determines the ranks on the basis of a result obtained by multiplying the calculated number of pixels for each distance with respective coefficients corresponding to their distances from a screen center.
63. The image processing apparatus according to EXAMPLE 60, further comprising a recognition unit configured to recognize an object included in the image expressed by the multi-viewpoint image data, wherein

the determining unit determines the rank for each of the objects recognized by the recognition unit.

64. The image processing apparatus according to EXAMPLE 63, wherein the determining unit calculates a center of gravity of each of the objects recognized by the recognition unit and determines the rank of each of the objects on the basis of a result obtained by multiplying the number of pixels for each distance by a coefficient corresponding to a distance from the center of gravity of the object to a screen center.
65. An image processing apparatus comprising a display unit configured to, without receiving an input of a parameter from a user, display combined image data with the focus on a target corresponding to depth information by using multi-viewpoint image data obtained by capturing images from a plurality of viewpoints, the depth information indicating particular depth in a multi-viewpoint image expressed by the multi-viewpoint image data.
66. An image processing apparatus comprising a control unit configured to cause a display unit to display a combined image with the focus on a specific target, on a basis of recommendation information which is for displaying the combined image and which is associated with multi-viewpoint image data obtained by capturing images from a plurality of viewpoints.
67. An image processing apparatus comprising:

a determination unit configured to determine whether multi-viewpoint image data obtained by capturing images from a plurality of viewpoints is associated with recommendation information for displaying a combined image with the focus on a specific target; and

a control unit configured to cause a display unit to display the combined image on the basis of the recommendation information in a case where the determination unit determines that the multi-viewpoint image data is associated with the recommendation information.

68. An image processing apparatus comprising:

an obtaining unit configured to obtain multi-viewpoint image data obtained by capturing images from a plurality of viewpoints;

a determination unit configured to determine whether the multi-viewpoint image data obtained by the obtaining unit is associated with recommendation information for displaying a combined image with the focus on a specific target; and

a control unit configured to cause a display unit to display the combined image on the basis of the recommendation information in a case where the determination unit determines that the multi-viewpoint image data is associated with the recommendation information.

69. The image processing apparatus according to EXAMPLE 66, wherein the recommendation information is region information indicating a region including the target in focus in the combined image lastly displayed by the display unit.
70. The image processing apparatus according to EXAMPLE 66, wherein the recommendation information is region information indicating a region including the target in focus in the combined image lastly selected by a user.
71. The image processing apparatus according to EXAMPLE 69, further comprising a generating unit configured to generate combined image data expressing the combined image from the multi-viewpoint image data by using the region information, wherein

the control unit causes the display unit to display the combined image expressed by the combined image data generated by the generating unit.

72. The image processing apparatus according to EXAMPLE 66, wherein

the recommendation information is combined image data expressing the combined image lastly displayed by the display unit, and

the control unit causes the display unit to display the combined image expressed by the combined image data.

73. The image processing apparatus according to EXAMPLE 66, wherein

the recommendation information is combined image data expressing the combined image lastly selected by a user, and

the control unit causes the display unit to display the combined image expressed by the combined image data piece.

74. The image processing apparatus according to EXAMPLE 66, further comprising a storage unit configured to store the recommendation information in association with the multi-viewpoint image data corresponding to the combined image.
75. The image processing apparatus according to EXAMPLE 74, further comprising an updating unit configured to update the recommendation information stored in the storage unit to second recommendation information for displaying the combined image lastly displayed by the display unit.
76. An image processing apparatus comprising a storage unit configured to store recommendation information for displaying a combined image with the focus on a specific target, in association with multi-viewpoint image data which is obtained by capturing images from a plurality of viewpoints and which enables generation of the combined image.
77. An image processing apparatus comprising a display unit configured to, in a case where the image processing apparatus obtains an image file including multi-viewpoint image data obtained by capturing images from a plurality of viewpoints and recommendation information for displaying a combined image with the focus on a specific target, display the combined image without an instruction from a user on the basis of recommendation information.

### Other Embodiments

Each of the embodiments described above can be carried out in combination with one or more other embodiments.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2012-130863, filed Jun. 8, 2012, 2012-130866, filed Jun. 8, 2012, 2012-130865, filed Jun. 8, 2012, 2012-130867, filed Jun. 8, 2012, 2012-130868, filed Jun. 8, 2012 and 2013-076141, filed Apr. 1, 2013 which are hereby incorporated by reference herein in their entirety.

What is claimed is:

1. An image processing apparatus comprising:
a determining unit configured to determine ranks of targets to be in focus on the basis of history information indicating operation history; and
a generating unit configured to sequentially generate a plurality pieces of combined image data, from multi-viewpoint image data obtained by capturing images from a plurality of viewpoints, by focusing on the targets in accordance with the ranks determined by the determining unit.

2. The image processing apparatus according to claim 1, further comprising a control unit configured to cause the generated combined image data to be displayed, wherein
in a case where the control unit receives an input of a parameter from a user for the displayed combined image data, the control unit determines whether combined image data with the focus on the target corresponding to the inputted parameter is generated by the generating unit,
in a case where the control unit determines that combined image data is generated by the generating unit, the control unit causes the generated combined image data to be displayed, and
in a case where the control unit determines that combined image data is not generated by the generating unit, the control unit causes the generating unit to generate combined image data with the focus on the target corresponding to the inputted parameter.

3. The image processing apparatus according to claim 1, further comprising a control unit configured to cause the generated combined image data to be displayed, wherein
the generating unit sequentially generates the combined image data in accordance with the ranks during a period when no parameter is inputted by a user for the displayed combined image data.

4. The image processing apparatus according to claim 1, further comprising a recognition unit configured to recognize an object included in the image expressed by the multi-viewpoint image data, wherein
the determining unit extracts the object recognized by the recognition unit as the target.

5. The image processing apparatus according to claim 2, further comprising a history information storage unit configured to store, as the history information, the number of times of selecting a target including a region corresponding to the parameter inputted by the user for the displayed combined image data.

6. The image processing apparatus according to claim 1, further comprising a determination unit configured to determine whether priority is given to a mode of indicating a target to be in focus, wherein
in a case where the determination unit determines that the mode is given priority, the determining unit changes the ranks of the targets to ranks matching the mode.

7. The image processing apparatus according to claim 6, wherein the determining unit changes the ranks by using second history information indicating operation history in the mode.

8. An image processing apparatus comprising a display unit configured to display combined image data with the focus on a target corresponding to history information indicating operation history, without receiving an input of a parameter from a user, the combined image data being displayed by using multi-viewpoint image data obtained by capturing images from a plurality of viewpoints.

9. An image processing apparatus comprising:
a designating unit configured to designate a non-focus region which is not desired to be in focus in an image, in response to an instruction from a user;
a determining unit configured to determine a focus surface corresponding to the designated non-focus region; and
a combining unit configured to combine a plurality pieces of image data by using the determined focus surface.

10. The image processing apparatus according to claim 9, wherein the combining unit combines the plurality pieces of image data captured at least two or more different viewpoints.

11. The image processing apparatus according to claim 9, wherein the combining unit combines the plurality pieces of image data captured at least two or more continuous time points.

12. The image processing apparatus according to claim 9, wherein the designating unit designates a focus region which is desired to be in focus in an image, in response to an instruction from the user.

13. The image processing apparatus according to claim 12, further comprising an attaching unit configured to attach position information to image data combined by the combining unit, the position information indicating a position of the focus region or the non-focus region designated by the designating unit.

14. The image processing apparatus according to claim 13, wherein the attaching unit further attaches, to the combined image data, attribute information on whether the position information indicates the focus region or the non-focus region, while associating the attribute information with the position information.

15. The image processing apparatus according to claim 14, wherein, in a case where the designating unit designates the non-focus region in the image expressed by the image data to which the position information is attached by the attaching unit,
on the basis of an instruction from the user for the image expressed by the image data to which the position information is attached by the attaching unit, the attaching unit updates the attribute information attached to the image data to information indicating the non-focus region.

16. The image processing apparatus according to claim 9, wherein, in a case where the user gives an instruction for a region in the image for a certain time or more, the designating unit designates the region for which the instruction is given as the non-focus region.

17. The image processing apparatus according to claim 12, wherein, in a case where the user consecutively gives instructions for a region in the image within a certain time, the designating unit designates the region for which the instructions are given as the focus region.

18. The image processing apparatus according to claim 9, wherein the determining unit determines the focus surface corresponding to the non-focus region by shifting a position of the focus surface on the basis of an instruction from the user.

19. The image processing apparatus according to claim 9, wherein the determining unit determines the focus surface corresponding to the non-focus region by adjusting a depth of field on the basis of an instruction from the user.

20. The image processing apparatus according to claim 9, wherein the determining unit determines the focus surface corresponding to the non-focus region by adjusting a shape of a curve used as a base for formation of the focus surface on the basis of an instruction from the user.

21. The image processing apparatus according to claim 9, wherein the determining unit determines the focus surface corresponding to the non-focus region on the basis of position information which is attached to image data and which indicates a position of a focus region.

22. The image processing apparatus according to claim 9, wherein the determining unit determines the focus surface corresponding to the non-focus region on the basis of position information which is attached to image data pieces and which indicates a position of the non-focus region.

23. An image processing method comprising:
a determining step of determining ranks of targets to be in focus on the basis of history information indicating operation history; and
a generating step of sequentially generating combined image data, from multi-viewpoint image data obtained by capturing images from a plurality of viewpoints, by focusing on the targets in accordance with the ranks determined in the determining step.

24. An image processing method comprising:
a designating step of designating a non-focus region which is not desired to be in focus in an image, in response to an instruction from a user;
a determining step of determining a focus surface corresponding to the designated non-focus region; and
a combining step of combining a plurality pieces of image data by using the determined focus surface.

25. Anon-transitory computer readable storage medium storing a program, the program causing a computer to execute the image processing method according to claim 23.

26. Anon-transitory computer readable storage medium storing a program, the program causing a computer to execute the image processing method according to claim 24.
